(19) United States
(12) Patent Application Publication
(10) Pub. No.: US 2025/0106869 A1
(43) Pub. Date: Mar. 27, 2025

(54) TECHNIQUES FOR CONFIGURING COMMUNICATIONS BASED ON UNIFIED TRANSMISSION CONFIGURATION INDICATOR STATES

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/729,468

(22) PCT Filed: Mar. 15, 2022
(86) PCT No.: PCT/CN2022/080923

§ 371 Date: Jul. 16, 2024

(51) Int. Cl. H04W 72/232; H04L 5/00; H04W 72/1273

(52) U.S. Cl. CPC H04W 72/232; H04L 5/0091; H04W 72/1273

(57) ABSTRACT

Methods, systems, and devices for wireless communication are described. A user equipment (UE) may receive a control message (e.g., downlink control information (DCI), radio resource control) indicating a configuration for a signal, where the configuration may indicates whether the signal is associated with one or more unified transmission configuration indicator (TCI) states of a selected unified TCI codepoint. The UE may receive a first DCI message indicating a set of one or more activated TCI codepoints that are each associated with one or more TCI states, and receive a second DCI message indicating the selected unified TCI codepoint from the set of one or more activated TCI codepoints. The UE may apply a TCI state for communication of the signal in accordance with the configuration.

### CROSS REFERENCE

The present application is a 371 national stage filing of International PCT Application No. PCT/CN2022/080923 by YUAN et al. entitled “TECHNIQUES FOR CONFIGURING COMMUNICATIONS BASED ON UNIFIED TRANSMISSION CONFIGURATION INDICATOR STATES,” filed Mar. 15, 2022, which is assigned to the assignee hereof, and which is expressly incorporated by reference in its entirety herein.

### FIELD OF TECHNOLOGY

The following relates to wireless communication, including techniques for configuring communications based on unified transmission configuration indicator (TCI) states.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a UE may be in communication with one or more network entities in accordance with multiple transmission and reception point (mTRP) operation. In addition, the UE may communicate with one or more network entities based on a transmission configuration indicator (TCI) state associated with each network entity. Techniques for configuring or selecting a specific TCI state to be used for mTRP operations are currently ambiguous. In particular, rules for configuring or selecting from among unified TCI states for mTRP operations are not currently defined.

### SUMMARY

The described techniques relate to improved methods, systems, devices, and apparatuses that support techniques for configuring communications based on unified transmission configuration indicator (TCI) states. For example, the described techniques provide for improved methods of configuring a user equipment (UE) with a TCI state, such as a unified TCI state, while communicating in a multiple transmission reception point (mTRP) environment. A UE may receive a control message (e.g., downlink control information (DCI), radio resource control (RRC), medium access control (MAC) control element (MAC-CE)) indicating a configuration for a signal, where the configuration may indicate whether the signal is associated with one or more unified TCI states of a selected unified TCI codepoint. The UE may receive a first DCI message indicating a set of one or more activated TCI codepoints that are each associated with one or more unified TCI states, and receive a second DCI message indicating the selected unified TCI codepoint from the set of one or more activated TCI codepoints. The UE may apply a TCI state for communication of the signal in accordance with the configuration.

A method for wireless communications at a UE is described. The method may include receiving a control message indicating a configuration for a signal, where the configuration indicates whether the signal is associated with one or more unified TCI states of a selected unified TCI codepoint, receiving a first DCI message indicating a set of one or more activated TCI codepoints that are each associated with one or more TCI states, receiving a second DCI message indicating the selected unified TCI codepoint from the set of one or more activated TCI codepoints, and applying a TCI state for communication of the signal in accordance with the configuration.

An apparatus for wireless communications at a UE is described. The apparatus may include a processor, memory coupled with the processor, and instructions stored in the memory. The instructions may be executable by the processor to cause the apparatus to receive a control message indicating a configuration for a signal, where the configuration indicates whether the signal is associated with one or more unified TCI states of a selected unified TCI codepoint, receive a first DCI message indicating a set of one or more activated TCI codepoints that are each associated with one or more TCI states, receive a second DCI message indicating the selected unified TCI codepoint from the set of one or more activated TCI codepoints, and apply a TCI state for communication of the signal in accordance with the configuration.

Another apparatus for wireless communications at a UE is described. The apparatus may include means for receiving a control message indicating a configuration for a signal, where the configuration indicates whether the signal is associated with one or more unified TCI states of a selected unified TCI codepoint, means for receiving a first DCI message indicating a set of one or more activated TCI codepoints that are each associated with one or more TCI states, means for receiving a second DCI message indicating the selected unified TCI codepoint from the set of one or more activated TCI codepoints, and means for applying a TCI state for communication of the signal in accordance with the configuration.

A non-transitory computer-readable medium storing code for wireless communications at a UE is described. The code may include instructions executable by a processor to receive a control message indicating a configuration for a signal, where the configuration indicates whether the signal is associated with one or more unified TCI states of a selected unified TCI codepoint, receive a first DCI message indicating a set of one or more activated TCI codepoints that are each associated with one or more TCI states, receive a second DCI message indicating the selected unified TCI codepoint from the set of one or more activated TCI codepoints, and apply a TCI state for communication of the signal in accordance with the configuration.

In some examples of the method, apparatuses, and non-transitory computer-readable medium described herein, receiving the control message may include operations, features, means, or instructions for identifying that an association between the signal and the one or more unified TCI states may be per a control resource set or per a search space of the control resource set.

Some examples of the method, apparatuses, and non-transitory computer-readable medium described herein may further include operations, features, means, or instructions for identifying that the control resource set or the search space may be common to multiple UEs, where the configuration includes an indication that indicates one of a first option, a second option, a third option, or a fourth option based on the control resource set or the search space being common to multiple UEs, where the first option may be that the signal may be associated with none of the one or more unified TCI states, the second option may be that the signal may be associated with a first one of the one or more unified TCI states used for communications with a first transmission and reception point of a network entity, the third option may be that the signal may be associated with a second one of the one or more unified TCI states used for communications with a second transmission and reception point of the network entity, and the fourth option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the control resource set or the search space may be specific to the UE, where the configuration includes an indication that indicates one of a first option, a second option, or a third option based on the control resource set or the search space being specific to the UE, where the first option may be that the signal may be associated with a first one of the one or more unified TCI states used for communications with a first transmission and reception point of a network entity, the second option may be that the signal may be associated with a second one of the one or more unified TCI states used for communications with a second transmission and reception point of the network entity, and the third option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the configuration indicates that the signal may be associated with both a first one of the one or more unified TCI states used for communications with a first transmission and reception point of a network entity and a second one of the one or more unified TCI states used for communications with a second transmission and reception point of the network entity, where the configuration may be based on a single frequency network based control resource set being enabled to include multiple TCIs.

In some examples of the method, apparatuses, and non-transitory computer-readable medium described herein, an order of the first one and the second one of the one or more unified TCI states indicated in the configuration may be indicative of a corresponding order of transmission and reception point identifiers to be applied to the one or more unified TCI states.

In some examples of the method, apparatuses, and non-transitory computer-readable medium described herein, receiving the control message may include operations, features, means, or instructions for identifying that an association between the signal and the one or more unified TCI states may be per a physical uplink control channel resource, a physical uplink control channel resource set, a physical uplink control channel resource group, or a combination thereof, and that the signal may be associated with a physical uplink control channel.

Some examples of the method, apparatuses, and non-transitory computer-readable medium described herein may further include operations, features, means, or instructions for identifying that the configuration includes an indication that indicates one of a first option, a second option, or a third option based on the signal being associated with the physical uplink control channel, where the first option may be that the signal may be associated with a first one of the one or more unified TCI states used for communications with a first transmission and reception point of a network entity, the second option may be that the signal may be associated with a second one of the one or more unified TCI states used for communications with a second transmission and reception point of the network entity, and the third option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the association between the signal and the one or more unified TCI states may be per the physical uplink control channel resource set or per the physical uplink control channel resource group, where the configuration may be applicable to each physical uplink channel resource in the physical uplink control channel resource set or the physical uplink control channel resource group.

Some examples of the method, apparatuses, and non-transitory computer-readable medium described herein may further include operations, features, means, or instructions for identifying that the configuration indicates that the signal may be associated with both a first one of the one or more unified TCI states used for communications with a first transmission and reception point of a network entity and a second one of the one or more unified TCI states used for communications with a second transmission and reception point of the network entity, where individual repetitions of the physical uplink control channel may be mapped to either the first transmission and reception point or the second transmission and reception point based on a configured pattern.

In some examples of the method, apparatuses, and non-transitory computer-readable medium described herein, receiving the control message may include operations, features, means, or instructions for identifying that an association between the signal and the one or more unified TCI states may be per a reference signal resource, a reference signal resource set, or a combination thereof, and that the signal may be a reference signal.

Some examples of the method, apparatuses, and non-transitory computer-readable medium described herein may further include operations, features, means, or instructions for identifying that the configuration includes an indication that indicates one of a first option, a second option, or a third option based on the signal being the reference signal, where the first option may be that the signal may be associated with none of the one or more unified TCI states, the second option may be that the signal may be associated with a first one of the one or more unified TCI states used for communications with a first transmission and reception point of a network entity, and the third option may be that the signal may be associated with a second one of the one or more unified TCI states used for communications with a second transmission and reception point of the network entity.

Some examples of the method, apparatuses, and non-transitory computer-readable medium described herein may further include operations, features, means, or instructions for identifying that the configuration indicates that the signal may be associated with none of the one or more unified TCI states and receiving a dedicated control message for the signal, the dedicated control message including a dedicated TCI state assigned to the signal based on the configuration indicating that the signal may be associated with none of the one or more unified TCI states.

Some examples of the method, apparatuses, and non-transitory computer-readable medium described herein may further include operations, features, means, or instructions for identifying that the configuration indicates that the signal may be associated with either a first one of the one or more unified TCI states used for communications with a first transmission and reception point of a network entity or a second one of the one or more unified TCI states used for communications with a second transmission and reception point of the network entity, where a single selected unified TCI state may be applied to the reference signal in accordance with the configuration.

In some examples of the method, apparatuses, and non-transitory computer-readable medium described herein, the reference signal may be one of a periodic, semi-persistent, or aperiodic channel state information reference signal or a sounding reference signal.

In some examples of the method, apparatuses, and non-transitory computer-readable medium described herein, receiving the control message may include operations, features, means, or instructions for identifying that an association between the signal and the one or more unified TCI states may be per configured grant, where the configured grant may be a type 1 configured grant or a type 2 configured grant.

Some examples of the method, apparatuses, and non-transitory computer-readable medium described herein may further include operations, features, means, or instructions for identifying that the configuration includes an indication that indicates one of a first option or a second option based on only a single sounding reference signal resource set being associated with the configured grant, where the first option may be that the signal may be associated with a first one of the one or more unified TCI states used for communications with a first transmission and reception point of a network entity, and the second option may be that the signal may be associated with a second one of the one or more unified TCI states used for communications with a second transmission and reception point of the network entity.

Some examples of the method, apparatuses, and non-transitory computer-readable medium described herein may further include operations, features, means, or instructions for identifying that the configuration includes an indication that indicates one of a first option or a second option based on at least two sounding reference signal resource sets being associated with the configured grant, the indication indicating either the first option or the second option on a per sounding reference signal resource set basis for a physical uplink shared channel transmission associated with the configured grant, where the first option may be that the signal may be associated with a first one of the one or more unified TCI states used for communications with a first transmission and reception point of a network entity, and the second option may be that the signal may be associated with a second one of the one or more unified TCI states used for communications with a second transmission and reception point of the network entity.

In some examples of the method, apparatuses, and non-transitory computer-readable medium described herein, one or more parameters of the physical uplink shared channel transmission may be determined by a sounding reference signal resource indicator corresponding to sounding reference signal resources in a respective sounding reference signal resource set.

In some examples of the method, apparatuses, and non-transitory computer-readable medium described herein, the one or more parameters of the physical uplink shared channel transmission include one or more beam parameters, a transmitted precoding matrix indicator, a rank indicator, one or more power control parameters, or a combination thereof.

In some examples of the method, apparatuses, and non-transitory computer-readable medium described herein, the physical uplink shared channel transmission may be configured for a subset of repetitions in time division multiplexing or frequency division multiplexing repetitions, or for a subset of spatial layers or antenna ports in spatial division multiplexing.

In some examples of the method, apparatuses, and non-transitory computer-readable medium described herein, the physical uplink shared channel transmission may be indicated by a scheduling request indicator corresponding to sounding reference signal resources in a sounding reference signal resource set and may be applied with a single selected unified TCI state in accordance with the single TCI order index provided by the configuration associated with the sounding reference signal resource set.

In some examples of the method, apparatuses, and non-transitory computer-readable medium described herein, receiving the control message may include operations, features, means, or instructions for receiving a RRC message, a MAC-CE message, a DCI message, or a combination thereof indicating the configuration for the signal.

Some examples of the method, apparatuses, and non-transitory computer-readable medium described herein may further include operations, features, means, or instructions for receiving a second control message including an updated configuration for the signal, where the second control message may be a MAC-CE message, a DCI message, or both.

A method for wireless communications at a network entity is described. The method may include transmitting a control message indicating a configuration for a signal, where the configuration indicates whether the signal is associated with one or more unified TCI states of a selected unified TCI codepoint, transmitting a first DCI message indicating a set of one or more activated TCI codepoints that are each associated with one or more TCI states, and transmitting a second DCI message indicating the selected unified TCI codepoint from the set of one or more activated TCI codepoints.

An apparatus for wireless communications at a network entity is described. The apparatus may include a processor, memory coupled with the processor, and instructions stored in the memory. The instructions may be executable by the processor to cause the apparatus to transmit a control message indicating a configuration for a signal, where the configuration indicates whether the signal is associated with one or more unified TCI states of a selected unified TCI codepoint, transmit a first DCI message indicating a set of one or more activated TCI codepoints that are each associated with one or more TCI states, and transmit a second DCI message indicating the selected unified TCI codepoint from the set of one or more activated TCI codepoints.

Another apparatus for wireless communications at a network entity is described. The apparatus may include means for transmitting a control message indicating a configuration for a signal, where the configuration indicates whether the signal is associated with one or more unified TCI states of a selected unified TCI codepoint, means for transmitting a first DCI message indicating a set of one or more activated TCI codepoints that are each associated with one or more TCI states, and means for transmitting a second DCI message indicating the selected unified TCI codepoint from the set of one or more activated TCI codepoints.

A non-transitory computer-readable medium storing code for wireless communications at a network entity is described. The code may include instructions executable by a processor to transmit a control message indicating a configuration for a signal, where the configuration indicates whether the signal is associated with one or more unified TCI states of a selected unified TCI codepoint, transmit a first DCI message indicating a set of one or more activated TCI codepoints that are each associated with one or more TCI states, and transmit a second DCI message indicating the selected unified TCI codepoint from the set of one or more activated TCI codepoints.

In some examples of the method, apparatuses, and non-transitory computer-readable medium described herein, transmitting the control message may include operations, features, means, or instructions for identifying that an association between the signal and the one or more unified TCI states may be per a control resource set or per a search space of the control resource set.

Some examples of the method, apparatuses, and non-transitory computer-readable medium described herein may further include operations, features, means, or instructions for identifying that the control resource set or the search space may be common to multiple UEs, where the configuration includes an indication that indicates one of a first option, a second option, a third option, or a fourth option based on the control resource set or the search space being common to multiple UEs, where the first option may be that the signal may be associated with none of the one or more unified TCI states, the second option may be that the signal may be associated with a first one of the one or more unified TCI states used for communications with a first transmission and reception point of a network entity, the third option may be that the signal may be associated with a second one of the one or more unified TCI states used for communications with a second transmission and reception point of the network entity, and the fourth option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the control resource set or the search space may be specific to the UE, where the configuration includes an indication that indicates one of a first option, a second option, or a third option based on the control resource set or the search space being specific to the UE, where the first option may be that the signal may be associated with a first one of the one or more unified TCI states used for communications with a first transmission and reception point of a network entity, the second option may be that the signal may be associated with a second one of the one or more unified TCI states used for communications with a second transmission and reception point of the network entity, and the third option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the configuration indicates that the signal may be associated with both a first one of the one or more unified TCI states used for communications with a first transmission and reception point of a network entity and a second one of the one or more unified TCI states used for communications with a second transmission and reception point of the network entity, where the configuration may be based on a single frequency network based control resource set being enabled to include multiple TCIs.

In some examples of the method, apparatuses, and non-transitory computer-readable medium described herein, an order of the first one and the second one of the one or more unified TCI states indicated in the configuration may be indicative of a corresponding order of transmission and reception point identifiers to be applied to the one or more unified TCI states.

In some examples of the method, apparatuses, and non-transitory computer-readable medium described herein, transmitting the control message may include operations, features, means, or instructions for identifying that an association between the signal and the one or more unified TCI states may be per a physical uplink control channel resource, a physical uplink control channel resource set, a physical uplink control channel resource group, or a combination thereof, and that the signal may be associated with a physical uplink control channel.

Some examples of the method, apparatuses, and non-transitory computer-readable medium described herein may further include operations, features, means, or instructions for identifying that the configuration includes an indication that indicates one of a first option, a second option, or a third option based on the signal being associated with the physical uplink control channel, where the first option may be that the signal may be associated with a first one of the one or more unified TCI states used for communications with a first transmission and reception point of a network entity, the second option may be that the signal may be associated with a second one of the one or more unified TCI states used for communications with a second transmission and reception point of the network entity, and the third option may be that the signal may be associated with both the first one and the second one of the one or more unified TCI states used for communications with both the first transmission and reception point and the second transmission reception point of the network entity.

Some examples of the method, apparatuses, and non-transitory computer-readable medium described herein may further include operations, features, means, or instructions for identifying that the association between the signal and the one or more unified TCI states may be per the physical uplink control channel resource set or per the physical uplink control channel resource group, where the configuration may be applicable to each physical uplink channel resource in the physical uplink control channel resource set or the physical uplink control channel resource group.

Some examples of the method, apparatuses, and non-transitory computer-readable medium described herein may further include operations, features, means, or instructions for identifying that the configuration indicates that the signal may be associated with both a first one of the one or more unified TCI states used for communications with a first transmission and reception point of a network entity and a second one of the one or more unified TCI states used for communications with a second transmission and reception point of the network entity, where individual repetitions of the physical uplink control channel may be mapped to either the first transmission and reception point or the second transmission and reception point based on a configured pattern.

In some examples of the method, apparatuses, and non-transitory computer-readable medium described herein, transmitting the control message may include operations, features, means, or instructions for identifying that an association between the signal and the one or more unified TCI states may be per a reference signal resource, a reference signal resource set, or a combination thereof, and that the signal may be a reference signal.

Some examples of the method, apparatuses, and non-transitory computer-readable medium described herein may further include operations, features, means, or instructions for identifying that the configuration includes an indication that indicates one of a first option, a second option, or a third option based on the signal being the reference signal, where the first option may be that the signal may be associated with none of the one or more unified TCI states, the second option may be that the signal may be associated with a first one of the one or more unified TCI states used for communications with a first transmission and reception point of a network entity, and the third option may be that the signal may be associated with a second one of the one or more unified TCI states used for communications with a second transmission and reception point of the network entity.

Some examples of the method, apparatuses, and non-transitory computer-readable medium described herein may further include operations, features, means, or instructions for identifying that the configuration indicates that the signal may be associated with none of the one or more unified TCI states and transmitting a dedicated control message for the signal, the dedicated control message including a dedicated TCI state assigned to the signal based on the configuration indicating that the signal may be associated with none of the one or more unified TCI states.

Some examples of the method, apparatuses, and non-transitory computer-readable medium described herein may further include operations, features, means, or instructions for identifying that the configuration indicates that the signal may be associated with either a first one of the one or more unified TCI states used for communications with a first transmission and reception point of a network entity or a second one of the one or more unified TCI states used for communications with a second transmission and reception point of the network entity, where a single selected unified TCI state may be applied to the reference signal in accordance with the configuration.

In some examples of the method, apparatuses, and non-transitory computer-readable medium described herein, the reference signal may be one of a periodic, semi-persistent, or aperiodic channel state information reference signal or a sounding reference signal.

In some examples of the method, apparatuses, and non-transitory computer-readable medium described herein, transmitting the control message may include operations, features, means, or instructions for identifying that an association between the signal and the one or more unified TCI states may be per configured grant, where the configured grant may be a type 1 configured grant or a type 2 configured grant.

Some examples of the method, apparatuses, and non-transitory computer-readable medium described herein may further include operations, features, means, or instructions for identifying that the configuration includes an indication that indicates one of a first option or a second option based on only a single sounding reference signal resource set being associated with the configured grant, where the first option may be that the signal may be associated with a first one of the one or more unified TCI states used for communications with a first transmission and reception point of a network entity, and the second option may be that the signal may be associated with a second one of the one or more unified TCI states used for communications with a second transmission and reception point of the network entity.

Some examples of the method, apparatuses, and non-transitory computer-readable medium described herein may further include operations, features, means, or instructions for identifying that the configuration includes an indication that indicates one of a first option or a second option based on at least two sounding reference signal resource sets being associated with the configured grant, the indication indicating either the first option or the second option on a per sounding reference signal resource set basis for a physical uplink shared channel transmission associated with the configured grant, where the first option may be that the signal may be associated with a first one of the one or more unified TCI states used for communications with a first transmission and reception point of a network entity, and the second option may be that the signal may be associated with a second one of the one or more unified TCI states used for communications with a second transmission and reception point of the network entity.

In some examples of the method, apparatuses, and non-transitory computer-readable medium described herein, one or more parameters of the physical uplink shared channel transmission may be determined by a sounding reference signal resource indicator corresponding to sounding reference signal resources in a respective sounding reference signal resource set.

In some examples of the method, apparatuses, and non-transitory computer-readable medium described herein, the one or more parameters of the physical uplink shared channel transmission include one or more beam parameters, a transmitted precoding matrix indicator, a rank indicator, one or more power control parameters, or a combination thereof.

In some examples of the method, apparatuses, and non-transitory computer-readable medium described herein, the physical uplink shared channel transmission may be configured for a subset of repetitions in time division multiplexing or frequency division multiplexing repetitions, or for a subset of spatial layers or antenna ports in spatial division multiplexing.

In some examples of the method, apparatuses, and non-transitory computer-readable medium described herein, the physical uplink shared channel transmission may be indicated by a scheduling request indicator corresponding to sounding reference signal resources in a sounding reference signal resource set and may be applied with a single selected unified TCI state in accordance with the single TCI order index provided by the configuration associated with the sounding reference signal resource set.

In some examples of the method, apparatuses, and non-transitory computer-readable medium described herein, transmitting the control message may include operations, features, means, or instructions for transmitting a RRC message, a MAC-CE message, a DCI message, or a combination thereof indicating the configuration for the signal.

Some examples of the method, apparatuses, and non-transitory computer-readable medium described herein may further include operations, features, means, or instructions for transmitting a second control message including an updated configuration for the signal, where the second control message may be a MAC-CE message, a DCI message, or both.

A method for wireless communications at a UE is described. The method may include receiving a first DCI message indicating a selected unified TCI codepoint from a set of one or more activated TCI codepoints that are each associated with one or more TCI states, receiving a second DCI message scheduling a signal and indicating a TCI state of the selected unified TCI codepoint is associated with the signal, and applying the TCI state for communication of the signal in accordance with the second DCI message.

An apparatus for wireless communications at a UE is described. The apparatus may include a processor, memory coupled with the processor, and instructions stored in the memory. The instructions may be executable by the processor to cause the apparatus to receive a first DCI message indicating a selected unified TCI codepoint from a set of one or more activated TCI codepoints that are each associated with one or more TCI states, receive a second DCI message scheduling a signal and indicating a TCI state of the selected unified TCI codepoint is associated with the signal, and apply the TCI state for communication of the signal in accordance with the second DCI message.

Another apparatus for wireless communications at a UE is described. The apparatus may include means for receiving a first DCI message indicating a selected unified TCI codepoint from a set of one or more activated TCI codepoints that are each associated with one or more TCI states, means for receiving a second DCI message scheduling a signal and indicating a TCI state of the selected unified TCI codepoint is associated with the signal, and means for applying the TCI state for communication of the signal in accordance with the second DCI message.

A non-transitory computer-readable medium storing code for wireless communications at a UE is described. The code may include instructions executable by a processor to receive a first DCI message indicating a selected unified TCI codepoint from a set of one or more activated TCI codepoints that are each associated with one or more TCI states, receive a second DCI message scheduling a signal and indicating a TCI state of the selected unified TCI codepoint is associated with the signal, and apply the TCI state for communication of the signal in accordance with the second DCI message.

In some examples of the method, apparatuses, and non-transitory computer-readable medium described herein, receiving the second DCI message may include operations, features, means, or instructions for receiving the second DCI message including a transmission configuration indication codepoint from a set of transmission configuration indication codepoints, the transmission configuration indication codepoint indicative of the TCI state associated with a first network entity.

In some examples of the method, apparatuses, and non-transitory computer-readable medium described herein, the set of transmission configuration indication codepoints may be reserved for indicating the TCI state of the signal via RRC signaling.

In some examples of the method, apparatuses, and non-transitory computer-readable medium described herein, receiving the second DCI message may include operations, features, means, or instructions for receiving the second DCI message including an indication of whether one or multiple transmission configuration indication states may be applied to the signal and identifying the TCI state in accordance with a rule based on the indication.

In some examples of the method, apparatuses, and non-transitory computer-readable medium described herein, the indication may be included in a 1-bit DCI field.

In some examples of the method, apparatuses, and non-transitory computer-readable medium described herein, the rule may be configured via RRC signaling.

In some examples of the method, apparatuses, and non-transitory computer-readable medium described herein, the second DCI message implicitly indicates the TCI state, the UE identifies the TCI state based on the second DCI message refraining to include a TCI state field.

In some examples of the method, apparatuses, and non-transitory computer-readable medium described herein, receiving the second DCI message may include operations, features, means, or instructions for receiving the second DCI message including a sounding reference signal resource set indicator field indicative of at least one sounding reference signal resource set, the TCI state indicated by the at least one sounding reference signal resource set.

In some examples of the method, apparatuses, and non-transitory computer-readable medium described herein, the second DCI message indicates two sounding reference signal resource sets and the method, apparatuses, and non-transitory computer-readable medium may include further operations, features, means, or instructions for identifying a first TCI state from the selected unified TCI codepoint associated with a first network entity, and a second TCI state from the selected unified TCI codepoint associated with a second network entity and applying the first TCI state and the second TCI state to uplink shared channel repetitions or demodulation reference signal port groups based on a network entity associated with each repetition or each port group.

In some examples of the method, apparatuses, and non-transitory computer-readable medium described herein, the second DCI message indicates one sounding reference signal resource set and the method, apparatuses, and non-transitory computer-readable medium may include further operations, features, means, or instructions for identifying the TCI state from the selected unified TCI codepoint that may be associated with the network entity.

In some examples of the method, apparatuses, and non-transitory computer-readable medium described herein, the signal may be associated with an uplink shared channel.

A method for wireless communications at a network entity is described. The method may include transmitting a first DCI message indicating a selected unified TCI codepoint from a set of one or more activated TCI codepoints that are each associated with one or more TCI states and transmitting a second DCI message scheduling a signal and indicating a TCI state of the selected unified TCI codepoint is associated with the signal.

An apparatus for wireless communications at a network entity is described. The apparatus may include a processor, memory coupled with the processor, and instructions stored in the memory. The instructions may be executable by the processor to cause the apparatus to transmit a first DCI message indicating a selected unified TCI codepoint from a set of one or more activated TCI codepoints that are each associated with one or more TCI states and transmit a second DCI message scheduling a signal and indicating a TCI state of the selected unified TCI codepoint is associated with the signal.

Another apparatus for wireless communications at a network entity is described. The apparatus may include means for transmitting a first DCI message indicating a selected unified TCI codepoint from a set of one or more activated TCI codepoints that are each associated with one or more TCI states and means for transmitting a second DCI message scheduling a signal and indicating a TCI state of the selected unified TCI codepoint is associated with the signal.

A non-transitory computer-readable medium storing code for wireless communications at a network entity is described. The code may include instructions executable by a processor to transmit a first DCI message indicating a selected unified TCI codepoint from a set of one or more activated TCI codepoints that are each associated with one or more TCI states and transmit a second DCI message scheduling a signal and indicating a TCI state of the selected unified TCI codepoint is associated with the signal.

In some examples of the method, apparatuses, and non-transitory computer-readable medium described herein, transmitting the second DCI message may include operations, features, means, or instructions for transmitting the second DCI message including a transmission configuration indication codepoint from a set of transmission configuration indication codepoints, the transmission configuration indication codepoint indicative of the TCI state associated with a first network entity.

In some examples of the method, apparatuses, and non-transitory computer-readable medium described herein, the set of transmission configuration indication codepoints may be reserved for indicating the TCI state of the signal via RRC signaling.

In some examples of the method, apparatuses, and non-transitory computer-readable medium described herein, transmitting the second DCI message may include operations, features, means, or instructions for transmitting the second DCI message including an indication of whether one or multiple transmission configuration indication states may be applied to the signal, a rule indicative of the TCI state.

In some examples of the method, apparatuses, and non-transitory computer-readable medium described herein, the indication may be included in a 1-bit DCI field.

In some examples of the method, apparatuses, and non-transitory computer-readable medium described herein, the rule may be configured via RRC signaling.

In some examples of the method, apparatuses, and non-transitory computer-readable medium described herein, the second DCI message implicitly indicates the TCI state based on the network entity refraining to include a TCI state field in the second DCI message.

In some examples of the method, apparatuses, and non-transitory computer-readable medium described herein, transmitting the second DCI message may include operations, features, means, or instructions for transmitting the second DCI message including a sounding reference signal resource set indicator field indicative of at least one sounding reference signal resource set, the TCI state indicated by the at least one sounding reference signal resource set.

In some examples of the method, apparatuses, and non-transitory computer-readable medium described herein, the signal may be associated with an uplink shared channel.

A method for wireless communications at a UE is described. The method may include receiving a first DCI message indicating a selected unified TCI codepoint from a set of one or more activated TCI codepoints that are each associated with one or more TCI states, receiving a second DCI message scheduling a signal and indicating multiple TCI states of the selected unified TCI codepoint are associated with the signal, and applying the multiple TCI states across repetitions of the signal in accordance with a configuration.

An apparatus for wireless communications at a UE is described. The apparatus may include a processor, memory coupled with the processor, and instructions stored in the memory. The instructions may be executable by the processor to cause the apparatus to receive a first DCI message indicating a selected unified TCI codepoint from a set of one or more activated TCI codepoints that are each associated with one or more TCI states, receive a second DCI message scheduling a signal and indicating multiple TCI states of the selected unified TCI codepoint are associated with the signal, and apply the multiple TCI states across repetitions of the signal in accordance with a configuration.

Another apparatus for wireless communications at a UE is described. The apparatus may include means for receiving a first DCI message indicating a selected unified TCI codepoint from a set of one or more activated TCI codepoints that are each associated with one or more TCI states, means for receiving a second DCI message scheduling a signal and indicating multiple TCI states of the selected unified TCI codepoint are associated with the signal, and means for applying the multiple TCI states across repetitions of the signal in accordance with a configuration.

A non-transitory computer-readable medium storing code for wireless communications at a UE is described. The code may include instructions executable by a processor to receive a first DCI message indicating a selected unified TCI codepoint from a set of one or more activated TCI codepoints that are each associated with one or more TCI states, receive a second DCI message scheduling a signal and indicating multiple TCI states of the selected unified TCI codepoint are associated with the signal, and apply the multiple TCI states across repetitions of the signal in accordance with a configuration.

In some examples of the method, apparatuses, and non-transitory computer-readable medium described herein, an order of TCI states applied to the repetitions corresponds to an order of the TCI states in the selected unified TCI codepoint in accordance with the configuration.

In some examples of the method, apparatuses, and non-transitory computer-readable medium described herein, an order of TCI states applied to the repetitions corresponds to an order of network entities associated with each of the multiple TCI states of the selected unified TCI codepoint in accordance with the configuration.

In some examples of the method, apparatuses, and non-transitory computer-readable medium described herein, the multiple TCI states may be applied across the repetitions based on a communication type associated with the repetitions in accordance with the configuration, the communication type including one of frequency division multiplexing, time division multiplexing, or spatial division multiplexing.

In some examples of the method, apparatuses, and non-transitory computer-readable medium described herein, the multiple TCI states may be applied across the repetitions in accordance with the configuration based on a number of code division-multiplexing groups indicated in the second DCI message.

In some examples of the method, apparatuses, and non-transitory computer-readable medium described herein, the multiple TCI states may be applied across the repetitions in accordance with the configuration based on a physical resource block bundling size associated with the repetitions.

In some examples of the method, apparatuses, and non-transitory computer-readable medium described herein, the multiple TCI states may be applied across the repetitions in accordance with the configuration based on cyclic mapping being enabled or sequential mapping being enabled for the repetitions.

In some examples of the method, apparatuses, and non-transitory computer-readable medium described herein, the signal may be associated with an uplink shared channel.

A method for wireless communications at a network entity is described. The method may include transmitting a first DCI message indicating a selected unified TCI codepoint from a set of one or more activated TCI codepoints that are each associated with one or more TCI states and transmitting a second DCI message scheduling a signal and indicating multiple TCI states of the selected unified TCI codepoint are associated with the signal, the multiple TCI states to be applied across repetitions of the signal in accordance with a configuration.

An apparatus for wireless communications at a network entity is described. The apparatus may include a processor, memory coupled with the processor, and instructions stored in the memory. The instructions may be executable by the processor to cause the apparatus to transmit a first DCI message indicating a selected unified TCI codepoint from a set of one or more activated TCI codepoints that are each associated with one or more TCI states and transmit a second DCI message scheduling a signal and indicating multiple TCI states of the selected unified TCI codepoint are associated with the signal, the multiple TCI states to be applied across repetitions of the signal in accordance with a configuration.

Another apparatus for wireless communications at a network entity is described. The apparatus may include means for transmitting a first DCI message indicating a selected unified TCI codepoint from a set of one or more activated TCI codepoints that are each associated with one or more TCI states and means for transmitting a second DCI message scheduling a signal and indicating multiple TCI states of the selected unified TCI codepoint are associated with the signal, the multiple TCI states to be applied across repetitions of the signal in accordance with a configuration.

A non-transitory computer-readable medium storing code for wireless communications at a network entity is described. The code may include instructions executable by a processor to transmit a first DCI message indicating a selected unified TCI codepoint from a set of one or more activated TCI codepoints that are each associated with one or more TCI states and transmit a second DCI message scheduling a signal and indicating multiple TCI states of the selected unified TCI codepoint are associated with the signal, the multiple TCI states to be applied across repetitions of the signal in accordance with a configuration.

In some examples of the method, apparatuses, and non-transitory computer-readable medium described herein, an order of TCI states to be applied to the repetitions corresponds to an order of the TCI states in the selected unified TCI codepoint in accordance with the configuration.

In some examples of the method, apparatuses, and non-transitory computer-readable medium described herein, an order of TCI states to be applied to the repetitions corresponds to an order of network entities associated with each of the multiple TCI states of the selected unified TCI codepoint in accordance with the configuration.

In some examples of the method, apparatuses, and non-transitory computer-readable medium described herein, the multiple TCI states may be applied across the repetitions in accordance with the configuration based on a communication type associated with the repetitions, the communication type including one of frequency division multiplexing, time division multiplexing, or spatial division multiplexing.

In some examples of the method, apparatuses, and non-transitory computer-readable medium described herein, the multiple TCI states may be applied across the repetitions in accordance with the configuration based on a number of code division-multiplexing groups indicated in the second DCI message.

In some examples of the method, apparatuses, and non-transitory computer-readable medium described herein, the multiple TCI states may be applied across the repetitions in accordance with the configuration based on a physical resource block bundling size associated with the repetitions.

In some examples of the method, apparatuses, and non-transitory computer-readable medium described herein, the multiple TCI states may be applied across the repetitions in accordance with the configuration based on cyclic mapping being enabled or sequential mapping being enabled for the repetitions.

In some examples of the method, apparatuses, and non-transitory computer-readable medium described herein, the signal may be associated with an uplink shared channel.

A method for wireless communication at a UE is described. The method may include receiving a first DCI message indicating a selected unified TCI codepoint from a set of one or more activated TCI codepoints that are each associated with one or more TCI states, receiving a second DCI message indicating a first TCI state to use for a signal, the signal being a periodic or semi-persistent signal, receiving a third DCI message indicating multiple TCI states of the selected unified TCI codepoint, and determining to apply the first TCI state or the multiple TCI states to the signal in accordance with a configuration.

An apparatus for wireless communication at a UE is described. The apparatus may include a processor, memory coupled with the processor, and instructions stored in the memory. The instructions may be executable by the processor to cause the apparatus to receive a first DCI message indicating a selected unified TCI codepoint from a set of one or more activated TCI codepoints that are each associated with one or more TCI states, receive a second DCI message indicating a first TCI state to use for a signal, the signal being a periodic or semi-persistent signal, receive a third DCI message indicating multiple TCI states of the selected unified TCI codepoint, and determine to apply the first TCI state or the multiple TCI states to the signal in accordance with a configuration.

Another apparatus for wireless communication at a UE is described. The apparatus may include means for receiving a first DCI message indicating a selected unified TCI codepoint from a set of one or more activated TCI codepoints that are each associated with one or more TCI states, means for receiving a second DCI message indicating a first TCI state to use for a signal, the signal being a periodic or semi-persistent signal, means for receiving a third DCI message indicating multiple TCI states of the selected unified TCI codepoint, and means for determining to apply the first TCI state or the multiple TCI states to the signal in accordance with a configuration.

A non-transitory computer-readable medium storing code for wireless communication at a UE is described. The code may include instructions executable by a processor to receive a first DCI message indicating a selected unified TCI codepoint from a set of one or more activated TCI codepoints that are each associated with one or more TCI states, receive a second DCI message indicating a first TCI state to use for a signal, the signal being a periodic or semi-persistent signal, receive a third DCI message indicating multiple TCI states of the selected unified TCI codepoint, and determine to apply the first TCI state or the multiple TCI states to the signal in accordance with a configuration.

In some examples of the method, apparatuses, and non-transitory computer-readable medium described herein, determining to apply the first TCI state or the multiple TCI states may include operations, features, means, or instructions for determining to apply one of the multiple TCI states to the signal in accordance with the configuration.

Some examples of the method, apparatuses, and non-transitory computer-readable medium described herein may further include operations, features, means, or instructions for selecting a second TCI state from the multiple TCI states based on the second TCI state being associated with a same network entity as the first TCI state.

Some examples of the method, apparatuses, and non-transitory computer-readable medium described herein may further include operations, features, means, or instructions for selecting the second TCI state may be based on the signal being a semi-persistent scheduling signal, a configured grant, or an uplink shared channel signal.

Some examples of the method, apparatuses, and non-transitory computer-readable medium described herein may further include operations, features, means, or instructions for selecting the second TCI state may be based on a control resource set, a sounding reference signal resource set corresponding to a scheduling request indicator, or an uplink control channel resource associated with the signal.

Some examples of the method, apparatuses, and non-transitory computer-readable medium described herein may further include operations, features, means, or instructions for determining to apply the first TCI state or the multiple TCI states based on a rule.

In some examples of the method, apparatuses, and non-transitory computer-readable medium described herein, determining to apply the first TCI state or the multiple TCI states may include operations, features, means, or instructions for configuring the signal to be associated with the multiple TCI states rather than the first TCI state based on the third DCI message indicating the multiple TCI states.

In some examples of the method, apparatuses, and non-transitory computer-readable medium described herein, determining to apply the first TCI state or the multiple TCI states may include operations, features, means, or instructions for determining that the signal may be deactivated based on receiving the third DCI message indicating the multiple TCI states.

### BRIEF DESCRIPTION OF THE DRAWINGS

FIG. 1 illustrates an example of a wireless communications system that supports techniques for configuring communications based on unified transmission configuration indicator (TCI) states in accordance with one or more aspects of the present disclosure.

FIG. 2 illustrates an example of a wireless communications system that supports techniques for configuring communications based on unified TCI states in accordance with one or more aspects of the present disclosure.

FIGS. 3 through 5 illustrate examples of process flows that support techniques for configuring communications based on unified TCI states in accordance with one or more aspects of the present disclosure.

FIGS. 6 and 7 show block diagrams of devices that support techniques for configuring communications based on unified TCI states in accordance with one or more aspects of the present disclosure.

FIG. 8 shows a block diagram of a communications manager that supports techniques for configuring communications based on unified TCI states in accordance with one or more aspects of the present disclosure.

FIG. 9 shows a diagram of a system including a device that supports techniques for configuring communications based on unified TCI states in accordance with one or more aspects of the present disclosure.

FIGS. 10 and 11 show block diagrams of devices that support techniques for configuring communications based on unified TCI states in accordance with one or more aspects of the present disclosure.

FIG. 12 shows a block diagram of a communications manager that supports techniques for configuring communications based on unified TCI states in accordance with one or more aspects of the present disclosure.

FIG. 13 shows a diagram of a system including a device that supports techniques for configuring communications based on unified TCI states in accordance with one or more aspects of the present disclosure.

FIGS. 14 through 22 show flowcharts illustrating methods that support techniques for configuring communications based on unified TCI states in accordance with one or more aspects of the present disclosure.

### DETAILED DESCRIPTION

In a wireless communication system, a communication device (e.g., a user device such as a user equipment (UE)) may simultaneously communicate with multiple network entities (e.g., base stations, network nodes, transmission receptions points (TRPs)), in accordance with multiple TRP (mTRP) operations. For instance, the UE may perform simultaneous communications with a first network entity and a second network entity, which may each be TRPs. Communication with the different TRPs may be facilitated through communication during using core resource sets (CORESETs) associated with the different TRPs via a CORESET pool index (e.g., CORESETPoolIndex). In other words, the UE may use CORESET pool associated with a first CORESET pool index to communicate with a first TRP and may use a CORESET pool associated with a second CORESET pool index to communicate with a second TRP. Thus, the first TRP may be referred to as a first CORESET pool index and the second TRP may be referred to as a second CORESET pool index.

In some examples, a wireless communications system may support a unified transmission configuration indicator (TCI) framework in which the UE may utilize one or more unified TCI states to participate in communications with one or more network entities, such as for mTRP operation. To support unified TCI usage, the UE may receive an activation message (e.g., in a medium access control (MAC) control element (MAC-CE), or some other control message) that activates a set of unified TCI codepoints, where each unified TCI codepoint may map to one or more unified TCI states. Each unified TCI state may be associated with a TCI state type (e.g., uplink TCI, downlink TCI, joint uplink and downlink TCI) and a TCI identifier. Additionally, the UE may receive a TCI codepoint selection message (e.g., a unified TCI indication downlink control information (DCI)) that selects one TCI codepoint from the set of activated TCI codepoints for use in scheduled communications with the one or more network entities. For example, in the case of single DCI (sDCI), a TCI codepoint may include TCI states for both TRPs. In the case of multiple DCI (mDCI), the UE may receive two separate TCI codepoint indications, each indicative of a TCI state for one TRP. In accordance with the unified TCI, two unified TCI states may be selected for two TRPs, respectively, and each selected unified TCI state should be mapped to an intended TRP identifier (ID).

Accordingly, upon being configured with a selected unified codepoint, the UE may be configured (e.g., scheduled) to communicate with the one or more network entities in accordance with the unified TCI codepoint. For example, the UE may use multiple beam configurations indicated by respective TCI states associated with each network entity. For example, the UE may transmit and/or receive one or more signals to/from one or more network entities and in some cases, the UE may apply different TCI states based on the scheduled signal (e.g., a first TCI state applied to an uplink channel and a second TCI state applied to a downlink channel). In other cases, the UE may apply the same TCI state to more than one signal (e.g., joint TCI state applied to both uplink channels and downlink channels).

In some cases, a UE may be scheduled to communicate (e.g., transmit and/or receive) one or more signals (e.g., channels, reference signals, or both) with the one or more network entities. However, some wireless communication systems may not provide for an association between the one or more signals with an intended network entity identifier and/or the intended unified TCI state. Therefore, the UE may be unable to determine the unified TCI state to apply for the scheduled signal which may lead to increased latency, or reduced reliability as the UE may be unable to communicate with a network entity using a preferred TCI state.

To improve mTRP communications using unified TCI states, a scheduled signal may be associated with an intended network entity identifier. Accordingly, as each unified TCI state is associated with a network entity identifier, the UE may determine a corresponding unified TCI state to apply to the scheduled signal. In some implementations, the signal may be configured (e.g., scheduled) via RRC signaling. In such cases, an indicator may be included in the RRC signal to inform the UE whether the configured signal is to share a selected unified TCI state and, if so, which one or more of the network entities associated with the unified TCI state should be used for the signal. For example, a selected unified TCI codepoint may include unified TCI states associated with two network entities. The indicator may indicate whether the UE is to use the unified TCI states of one or both network entities for the signal. Alternatively, the indicator may indicate that neither selected unified TCI state of either network entity should be shared. The indicator may be configured per signal, per a set of resources, per configured grant, etc. Whether the UE is configured to use one, both, or none of the selected unified TCI states for the scheduled signal may be based on a set of resources, a signal type of the signal, etc.

In other implementations, the signal may be configured (e.g., scheduled) through a DCI scheduling message that includes an implicit or explicit indication of a unified TCI state associated with the scheduled signal. For example, the DCI message may indicate which one or more of the selected unified TCI states are to be applied to the signal. Additionally, or alternatively, the DCI message may indicate which one or more of the network entities are associated with the signal. As each unified TCI is associated with a particular network entity, the UE may identify the one or more TCI states to apply to the signal based on the one or more corresponding network entities. For example, a selected TCI codepoint may include one or more downlink applicable unified TCI states, one or more uplink applicable unified TCI states, a joint unified TCI state, or a combination thereof, where each TCI state may be associated with a particular network entity. As such, the UE may receive a scheduling DCI indicative of a scheduled uplink signal, for example, and the DCI message may indicate that the UE is to use the unified uplink TCI state associated with a first network entity, the second network entity, or both to perform the scheduled uplink signal.

In some implementations, the DCI signal may not include an explicit indication of a unified TCI codepoint and/or network entity associated with the scheduled signal. Instead the UE may implicitly determine the network entity and/or the unified TCI state associated with the scheduled signal, where the implicit determination may be based on a defined rule. In some cases, the unified TCI state and/or network entity associated with a scheduled signal may be implicitly determined based on a set of resources associated with the scheduled signal, such as a sounding reference signal resource set. In some cases, the DCI message may indicate how the UE is to apply TCI states across repetitions and/or DMRS port groups of a scheduled signal. In some implementations, the signal may be a periodic or semi-persistent signal. In some cases, the unified TCI codepoint may be updated over time, where the updated TCI codepoint may include multiple applicable TCI states. Accordingly, the UE may be configured with methods for determining which one or more of the multiple applicable unified TCI states to use for the periodic or semi-persistent signal, if any.

Particular aspects of the subject matter described herein may be implemented to realize one or more potential advantages. The described techniques may provide for the association of a configured signal (e.g., channel or reference signal) with an intended network entity identifier for a UE to determine which selected unified TCI states to apply to the signal. As such, the UE may associate unified TCI states with a configured signal which may provide for increased reliability and efficiency in mTRP communications, among other advantages. As such, supported techniques may include improved network operations and, in some examples, may promote network efficiencies, among other benefits.

Aspects of the disclosure are initially described in the context of wireless communications systems. Aspects are then described with reference to process flows. Aspects of the disclosure are further illustrated by and described with reference to apparatus diagrams, system diagrams, and flowcharts that relate to techniques for configuring communications based on unified TCI states.

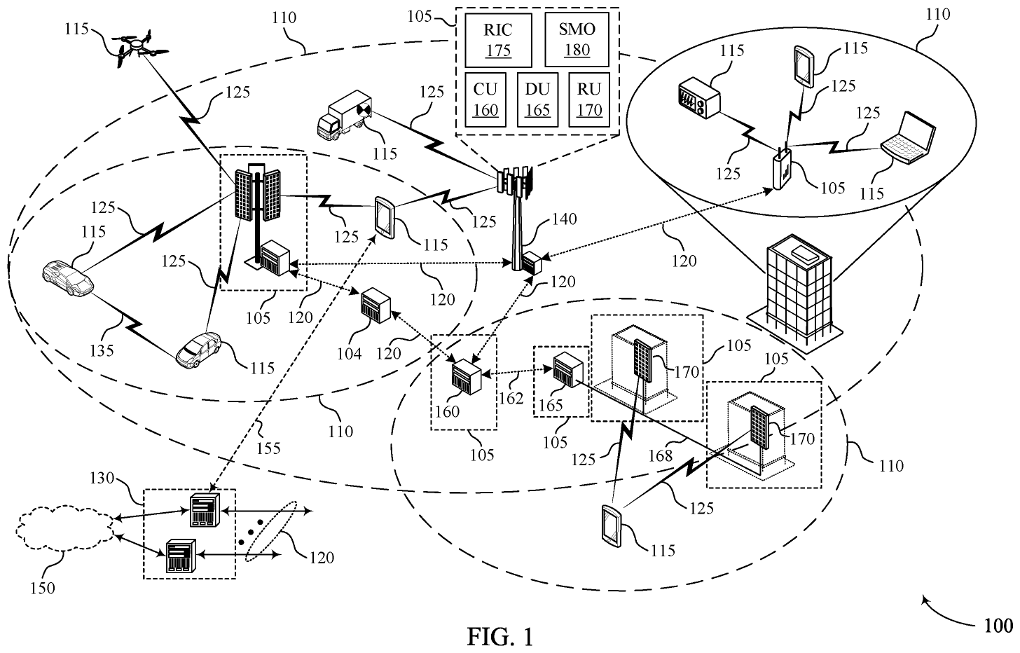

FIG. 1 illustrates an example of a wireless communications system 100 that supports techniques for configuring communications based on unified TCI states in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for configuring communications based on unified TCI states as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless communication system 100 may support communications between the UE 115 and multiple network entities 105 (e.g., base station, network node, transmission reception point (TRP)). The UE 115 may communicate with each network entity 105 using a different TCI state. A TCI state may refer to a beam configuration jointly determined by the UE 115 and network entity 105 using a reference signal. A TCI state may be associated with a TCI type that indicates whether the TCI state may be applied to uplink channels, downlink channels, or both (e.g., joint TCI state). A unified TCI state may be of any TCI state type and define a beam that may be applied to more than one channel, signal, etc. For example, a first TCI type may be a separate downlink common TCI type that indicates a common beam for one or more downlink channels and/or RSs, a second TCI type may be a separate uplink common TCI type that indicates a common beam for multiple uplink channels and/or RSs, a third TCI type may be a joint TCI type that indicates a common beam for both downlink and uplink channels and/or RSs, a fourth TCI type may be a separate downlink single TCI type that indicates a beam for a single downlink signal, a fifth TCI type may be a separate uplink single TCI type that indicates a beam for a single uplink signal, and a sixth TCI type may include spatial relation information (SRI) that indicates a beam for a single uplink signal. In some examples, these various TCI types may be respective examples of one or more unified TCI types (e.g., TCI types associated with a unified TCI framework).

In some cases, the UE 115 may be configured through higher level signaling (e.g., RRC, DCI, MAC-CE) with a TCI codepoint that maps to multiple unified TCI states. Each unified TCI state of the codepoint may be associated with an identifier (e.g., TRP identifier, CORESETPoolIndex, TCI identifier, beam group identifier, channel group identifier, resource group identifier, RS identifier, or TCI order index) corresponding to a network entity 105. In one example, a CORESET pool index may represent a TRP associated with that CORESET pool index. A codepoint may map to a downlink-only applicable TCI state, uplink-only applicable TCI state, and a joint TCI state. The first selected downlink applicable TCI state (e.g., downlink-only applicable TCI state) may map to a first network identifier while the second selected downlink applicable TCI state (e.g., joint TCI state) may map to a second network identifier. In some cases, an intended network identifier may correspond to two downlink applicable unified TCI states and, additionally, or alternatively, two uplink applicable unified TCI states of a codepoint.

The TCI codepoint may be selected from a set of activated codepoints through control signaling (e.g., a MAC-CE). The unified TCI states of a selected codepoint may be referred to as selected unified TCI states. In some cases, the UE 115 may communicate configured signals, such as channels and/or reference signals, with the network entities 105 and the UE may be configured to apply a selected unified TCI state to a configured signal (e.g., a scheduled signal). However, some wireless communication systems may lack a method for associating a configured signal with an intended network identifier, and as such, the UE may be unable to identify a selected unified TCI state to apply to the configured signal.

In some implementations, the UE 115 may associate an RRC configured signal (e.g., a signal scheduled via RRC) with an intended network identifier to determine which selected unified TCI state or states to apply to the signal. In some cases, a selected unified TCI state may be mapped to an associated network identifier in a single DCI (sDCI) message. The UE 115 may receive a sDCI corresponding to each network entity 105. In other cases, the UE 115 may receive a multiple DCI (mDCI) message that maps each selected unified TCI state to a corresponding network identifier. A control message (e.g., sDCI, mDCI, RRC, MAC-CE) may include an indicator that informs the UE 115 of whether the RRC configured signal may share a selected unified TCI state (indicated by the mDCI, sDCI, or both) and, if so, which network identifier of the selected unified TCI state should be applied. In some cases, the indicator may be configured according to a CORESET or search space. In other cases, the indicator may be configured according to resources associated with the configured signal (e.g., a physical uplink control channel (PUSCH), sounding reference signal (SRS) resources, or channel state information (CSI) reference signals (CSI-RSs) scheduled periodically, semi-persistently, or aperiodically). In some other cases, the indicator may be configured according to type 1 and type 2 configured grants (e.g., PUSCH resource) or physical downlink shared channel (PDSCH) resources associated with the configured signal.

In the case that the UE 115 is configured to share a selected unified TCI state, the UE 115 may be configured to share the selected unified TCI state associated with a first network entity. Alternatively, the UE 115 may be configured to share the selected unified TCI state associated with a second network entity. In some other cases, the UE 115 may be configured to share the selected unified TCI states associated with both network entities 105. In some other cases, the UE 115 may be configured not to share any of the selected unified TCI states. In such cases, the UE 115 may receive an indication of a TCI state (e.g., a dedicated TCI state) the UE 115 is to use for the configured signal.

In other implementations, the UE 115 may receive a DCI scheduling/activation message that is associated with an intended network identifier and indicates a configured signal (e.g., a scheduled signal). The UE 115 may use the DCI message to determine which selected unified TCI state may be applied to the configured signal. The DCI message may schedule or activate at least one selected unified TCI state for the configured channel and/or resources. In some cases, the scheduling physical downlink control channel (PDCCH) may be classified as a UE-specific search space (USS) or a common search space (CSS) resource but may be RRC configured to share at least one selected unified TCI state.

In some cases, the DCI scheduling/activation message may explicitly indicate one or more TCIs state of a selected unified TCI codepoint to be applied to the scheduled transmission with reserved bit fields. In other cases, the DCI scheduling/activation message may not explicitly indicate a TCI state, and the UE may alternatively be configured through other means to apply one or more selected unified TCI states to the scheduled signal. In some other cases, the network identifier corresponding to a selected unified TCI state for a sounding reference signal (SRS) may be configured in the PUSCH DCI scheduling message. If the DCI scheduling/activation message indicates that both selected unified TCI states should be applied to the configured signal, the UE may be configured with a mapping of unified TCI states to transmission repetitions or demodulation reference signal (DMRS) port groups. In some examples, the UE 115 may be configured with a mapping of network identifiers to the configured signal that is persistent or semi-persistent among transmissions. In this case, the DCI scheduling/activation message may either reconfigure the mapping between network identifier and signal or deactivate the persistent or semi-persistent configuration.

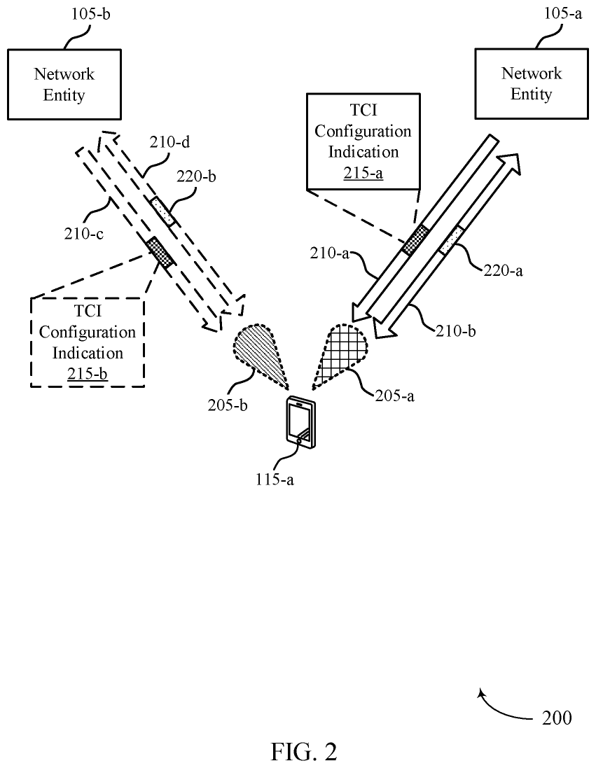

FIG. 2 illustrates an example of a wireless communications system 200 that supports techniques for configuring communications based on unified TCI states in accordance with one or more aspects of the present disclosure. The wireless communications system 200 may illustrate an example for implementing one or more aspects of the wireless communications system 100. For instance, network entity 105-a and network entity 105-b may each be an example of a network entity 105 as described with reference to FIG. 1. Additionally, or alternatively, UE 115-a may be an example of a UE 115 as described with reference to FIG. 1. While examples are discussed herein, any number of devices and device types may be used to accomplish implementations described in the present disclosure.

In some examples, the network entity 105 a and the network entity 105 b (or any number of network entities 105) may be in wireless communication (e.g., simultaneous wireless communication) with the UE 115-a. In order to participate in communications with the network entities 105, the UE 115 a may be configured with TCI states for use in transmitting and/or receiving transmissions between the network entities 105 and the UE 115-a. A TCI state may be indicative of a beam 205, such as a transmit beam, a receive beam, or both. Accordingly, the UE 115 a may receive, from the network entity 105-a, a TCI configuration message, which may include a configuration of one or more TCI states (e.g., TCI codepoints) for use at the UE 115-a. In some examples, the TCI configuration message may be an example of an RRC message that indicates a configuration of a set of TCI states. The network entity 105-a may transmit a TCI activation message (e.g., a MAC-CE message) associated with the configuration of TCI states, where the TCI activation message may activate a subset of the TCI states configured at the UE 115-a.

In some examples, such as in the case of mDCI, the TCI activation message may indicate a mapping of one or more unified TCI states to unified TCI codepoints, where each unified TCI may be associated with the network entity 105 that transmitted the mDCI. In some examples, such as in the case of sDCI, the TCI activation message may indicate a mapping of one or more unified TCI states to unified TCI codepoints, where the TCI states may be associated with different network entities 105, regardless of the network entity 105 that transmitted the sDCI. For example, an activated TCI codepoint may be mapped to one or more unified TCI states with different TCI types. In some cases, the TCI codepoint may be designated as C_{X}, where X may be a number identifying the TCI codepoint. The C_{X} may be set to either a one or a zero (e.g., C₀=1 or C₀=0) to indicate whether the next TCI state mapped to the TCI codepoint X (e.g., stop code), where a 1 may indicate that the next TCI state is associated with codepoint X but a 0 may indicate that the next TCI state is associated with a next codepoint. In some cases, the mapping may be exemplified by a data structure (e.g., a table). For example, Table 1 may be an example of activated unified TCI codepoints.

TABLE 1

| TCI Codepoint | TCI State |
|---|---|
| C₀ = 1 | DL only TCI #5 |
| C₀ = 1 | UL only TCI #10 |
| C₀ = 0 | Joint TCI #15 |
| C₁ = 1 | Joint TCI #7 |
| C₁ = 0 | DL only TCI #29 |
| C₂ = 0 | Joint TCI #35 |
| C₃ = 1 | Joint TCI #2 |
| C₃ = 1 | DL only TCI #43 |
| C₃ = 0 | UL only TCI #48 |

For example, a first TCI codepoint (C₀) may include a downlink-only TCI (e.g., TCI #5), an uplink-only TCI (e.g., TCI #10), and a joint TCI (e.g., TCI #15) in a third row. In some cases, the downlink-only TCI state and the uplink-only TCI state may be associated with a first network entity 105, and the joint TCI state may be associated with a second network entity 105. While the examples discussed are described in reference to a particular data structure, it is understood that many different mappings between various codepoints and TCI states with different TCI types are possible. Additionally, the UE 115-a may be configured with any number of activated TCI codepoints, and each codepoint may include any combination of TCI state identifiers. For example, TCI state #5 and TCI state #10 are merely examples.

A list of TCI state combinations is provided as examples of TCI state combinations that may be matched to each codepoint. In some cases, an order of the combination included in a control message (e.g., a MAC-CE) may be ignored. For example, a first codepoint may map to a downlink-only applicable TCI state, an uplink-only applicable TCI state, and a joint TCI state. A second codepoint may map to a downlink-only applicable TCI state and a joint TCI state. A third codepoint may map to an uplink-only applicable TCI state and a joint TCI state. A fourth codepoint may map to a first joint TCI state and a second joint TCI state. A fifth codepoint may map to a first downlink-only applicable TCI state, a second downlink-only applicable TCI state, and an uplink-only applicable TCI state. A sixth codepoint may map to a downlink-only applicable TCI state, a first uplink-only applicable TCI state, and a second uplink-only applicable TCI state. A seventh codepoint may map to a first downlink-only applicable TCI state, a second downlink-only applicable TCI state, a first uplink-only applicable TCI state, and a second uplink-only applicable TCI state. It is understood that different combinations of TCI state types may be possible, and may include any number of TCI state types. If a codepoint is activated (e.g., via higher level signaling), each unified TCI state of the codepoint may be mapped to a network identifier corresponding to either the network entity 105-a or the network entity 105-b.

The UE 115-a may communicate with the network entity 105-a over a first set of one or more beams 205-a and, in some cases, may communicate with a second network entity 105-b over a second set of one or more beams 205-b. The beams 205-a may be applied to a communication link 210-b associated with the network entity 105-a and the beams 205-b may be applied to a communication link 210-d associated with network entity 105-b. A beam 205-a may be used to transmit and/or receive a signal (e.g., a configured channel and/or reference signal) over a communication link 210-a (e.g., a downlink communications link) as indicated in the TCI configuration indication 215-a. Similarly, a beam 205-b may be used to transmit and/or receive a signal over a communication link 210-c (e.g., a downlink communications link) as indicated in the TCI configuration indication 215-b. The TCI configuration indication 215 may select one TCI codepoint from a set of activated TCI codepoints for use in scheduled communications with the one or more network entities 105. For example, in the case of single DCI (sDCI), a TCI codepoint may include TCI states for both network entities 105. In the case of multiple DCI (mDCI), the UE 115-a may receive two separate TCI codepoint indications, each indicative of a TCI state for one network entity 105. In accordance with the unified TCI, two unified TCI states may be selected for both network entities 105, respectively, and each selected unified TCI state should be mapped to an intended network identifier. For example, a first selected downlink applicable TCI state may be mapped to TRP ID 1 while a second downlink applicable TCI state may be mapped to TRP ID 2 where TRP ID 1 is the network identifier corresponding to network entity 105-a, TRP ID 2 is the network identifier corresponding to network entity 105-b, and the TCI state order index may be pre-determined.

A RRC message, a DCI message, or a MAC-CE, or a combination thereof may be used to transmit the TCI configuration indication 215. In some implementations, the TCI configuration indication 215 may be configured for each CORESET, search space, PUCCH, sounding reference signal, CSI-RS, physical uplink shared channel (PUSCH), or PDSCH), etc.

To improve mTRP communications using unified TCI states, a scheduled signal may be associated with an intended network entity identifier. Accordingly, as each unified TCI state is associated with a network entity identifier, the UE 115 may determine a corresponding unified TCI state to apply to the scheduled signal. In some implementations, the signal may be configured (e.g., scheduled) via RRC signaling. In such cases, an indicator may be included in the RRC signal to inform the UE 115 whether the configured signal is to share a selected unified TCI state and, if so, which one or more of the network entities 105 associated with the unified TCI state should be used for the signal. For example, a selected unified TCI codepoint may include unified TCI states associated with two network entities 105. The indicator may indicate whether the UE 115 is to use the unified TCI states of one or both network entities 105 for the signal. Alternatively, the indicator may indicate that neither selected unified TCI state of either network entity 105 should be shared. The indicator may be configured per signal, per a set of resources, per configured grant, etc. Whether the UE 115 is configured to use one, both, or none of the selected unified TCI states for the scheduled signal may be based on a set of resources, a signal type of the signal, etc.

In other implementations, the signal may be configured (e.g., scheduled) through a DCI scheduling message that includes an implicit or explicit indication of a unified TCI state associated with the scheduled signal. For example, the DCI message may indicate which one or more of the selected unified TCI states are to be applied to the signal. Additionally, or alternatively, the DCI message may indicate which one or more of the network entities 105 are associated with the signal. As each unified TCI is associated with a particular network entity 105, the UE 115 may identify the one or more TCI states to apply to the signal based on the one or more corresponding network entities 105. For example, a selected TCI codepoint may include one or more downlink applicable unified TCI states, one or more uplink applicable unified TCI states, a joint unified TCI state, or a combination thereof, where each TCI state may be associated with a particular network entity 105. As such, the UE 115 may receive a scheduling DCI indicative of a scheduled uplink signal, for example, and the DCI message may indicate that the UE 115 is to use the unified uplink TCI state associated with a first network entity 105, the second network entity 105, or both to perform the scheduled uplink signal.

In some implementations, the DCI signal may not include an explicit indication of a unified TCI codepoint and/or network entity 105 associated with the scheduled signal. Instead the UE may implicitly determine the network entity 105 and/or the unified TCI state associated with the scheduled signal, where the implicit determination may be based on a defined rule. In some cases, the unified TCI state and/or network entity 105 associated with a scheduled signal may be implicitly determined based on a set of resources associated with the scheduled signal, such as a sounding reference signal resource set. In some cases, the DCI message may indicate how the UE is to apply TCI states across repetitions (e.g., individual repetitions) and/or DMRS port groups of a scheduled signal. In some implementations, the signal may be a periodic or semi-persistent signal. In some cases, the unified TCI codepoint may be updated over time, where the updated TCI codepoint may include multiple applicable TCI states. Accordingly, the UE 115 may be configured with methods for determining which one or more of the multiple applicable unified TCI states to use for the periodic or semi-persistent signal, if any.

In accordance with the techniques described herein, UE 115-a may communicate (e.g., transmit, receive) a signal 220 with one or more network entities 105 based on one or more configure TCI sates. For example, UE 115-a may communicate signal 220-a with network entity 105-a and/or communicate signal 220-b with network entity 105-b.

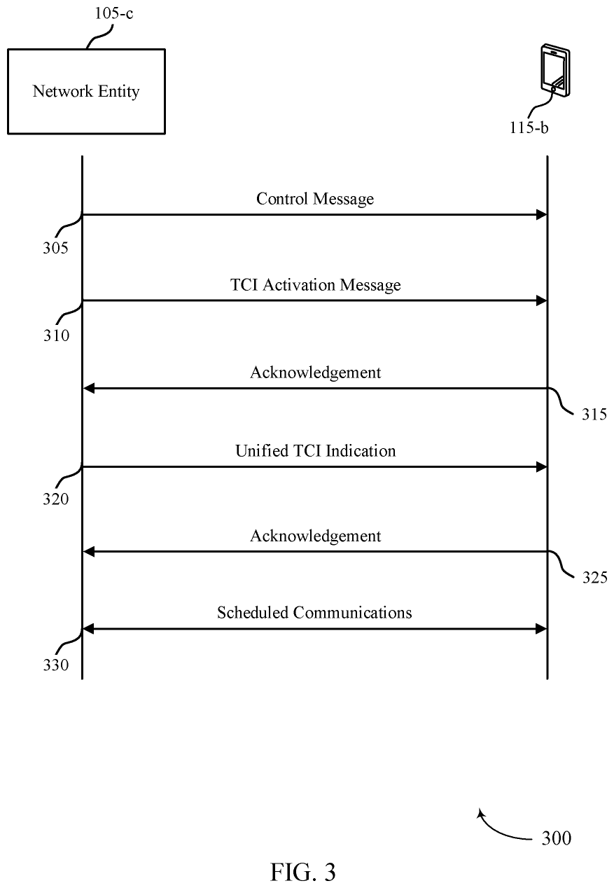

FIG. 3 illustrates an example of a process flow 300 that supports techniques for configuring communications based on unified TCI states in accordance with one or more aspects of the present disclosure. In some examples, the process flow 300 may implement or be implemented by aspects of the wireless communications system 100 and 200 as described with reference to FIGS. 1 and 2, respectively. For example, the process flow 300 may be implemented by a network entity 105-c and a UE 115-b, which may be an example of a network entity 105 and a UE 115 as described with reference to FIGS. 1 and 2, respectively. The process flow 300 may be implemented by the network entity 105-c and the UE 115-b to exchange signaling to provide reliable communications between the network entity 105-c and the UE 115-b. In the following description of the process flow 300, the operations between the network entity 105-c and the UE 115-b may be transmitted in a different order than the example order shown, or the operations performed by the network entity 105-c and the UE 115-b may be performed in different orders or at different times. Some operations may also be omitted from the process flow 300, and other operations may be added to the process flow 300.

As described herein, a UE 115 may be configured via RRC signaling with one or more configured channels and/or reference signals. In case of unified TCI for mTRP, two unified TCIs may be selected for two network entities 105, respectively, and each selected unified TCI should be mapped to an intended network entity identifier (e.g., TRP ID). However, the UE 115 may not have an association of the RRCI configure channel and/or reference signal with the intended TRP ID. In such cases, the UE 115 may be unable to identity a corresponding selected unified TCI to apply to those RRC configured channels and/or reference signals. In order for a UE to determine a TCI state to apply to the configured channel and/or reference signals, an RRC configured channel and/or reference signal may be associated with an intended TRP ID or IDs to allow the UE 115 to determine which selected unified TCI(s) to be applied to the RRC configured channel and/or reference signal. Accordingly, the UE 115 may receive an indication (e.g., a share indication) of whether the configured channels and/or reference signals are to share a selected unified TCI state. If so, the UE 115 may identify or receive an indication of which selected unified TCI state to use.

For example, at 305, the network entity 105-c may transmit a control message (e.g., RRC) to the UE 115-b. In some cases, the control message may be indicative of scheduling information of a channel and/or reference signal (e.g., an RRC configured channel and/or reference signal). The control message may include RRC configurations including a TCI states list, mTRP operations, and a share indication, etc. For example, the control message may include list of TCIs that may be used for communications between the UE 115-b and the network entity 105-c. The TCI list may include a set of unified TCIs, where each TCI may be associated with a certain type. For example, the types of unified TCIs may include downlink-only, uplink-only, or both downlink and uplink (e.g., joint). In some cases, the message may indicate the one or more TCI states (e.g., TCI types, TCI identifiers) associated with each TCI. The share indication may indicate whether the channel and/or reference signal are to share a selected unified TCI state of a selected codepoint (e.g., a future selected unified TCI state, such from the selected unified TCI at 310 and/or at 320). In some cases, the share indication be configured (e.g., indicated) via RRC, MAC-CE, DCI and may be configured per RRC configured signal, including per CORESET, per search space, per PUCCH, per sounding reference signal (SRS) or SRS resource set, per CSI-RS resource or CSI-RS resource set, per type-1 & type-2 CG PUSCH, or per SPS configuration, etc., which may be periodic, semi-persistent, and/or periodically transmitted.

At 310, the network entity 105-c may transmit a TCI activation message to the UE 115-b. The TCI activation message may activate a subset of one or more unified TCIs (e.g., as one or more unified TCI codepoints) of the TCI list configured at the UE 115-b. In some examples, the TCI activation message may indicate a mapping between unified TCI codepoints and one or more unified TCI states with different TCI types, as described herein with reference to FIG. 2. For example, the TCI activation message may indicate Table 1, as described with reference to FIG. 2. Accordingly, each activated codepoint may include one or more unified TCI states each of which may be associated with a network identifier that corresponds to a network entity 105. In some cases, the TCI activation message may be a MAC-CE, an RRC, or another type of control signaling. At 315, the UE 115-b may transmit an acknowledgment message, which may be a positive acknowledge (ACK) or negative acknowledge (NACK), indicating whether the TCI activation was successful. For example, the acknowledgment may be indicative of whether the UE 115-b received the TCI activation message from the network entity 105-c.

At 320, the network entity 105-c may transmit a unified TCI indication, which may be an example of TCI configuration indication 215, that selects one TCI codepoint from the set of activated TCI codepoints for use in scheduled communications with the one or more network entities 105. In some cases, the unified TCI indication may be included as part of a DCI message. The UE 115-b may then determine whether to use one or more unified TCI codepoints included in the selected unified TCI codepoint for the configured channel and/or reference signal based on the previously received share indication. If only a single TCI codepoint is activated in the TCI activation message at 310, the DCI message at 320 may be skipped, and the selected unified TCI codepoint is the single activated TCI codepoint in the TCI activation message.

In some implementations, the share indication may configure the UE 115-b not to share the selected unified TCI states for the configured channel and/or reference signal because the TCI state associated with the configured channel and/or reference signal may be configured individually (e.g., a first behavior). For example, some downlink channels (e.g., PDCCH or PDSCH) scheduled by a common search space (CSS) (e.g., CSS Type 0/0A/0B/1/1A/2/2A/3), downlink and/or uplink reference signal resources (e.g., CSI-RS resources such as for aperiodic CSI-RS, SRSs resources or SRS resource sets such as for periodic, semi-persistent, and/or aperiodic transmissions) may each be configured with a TCI state via signaling (e.g., RRC, MAC-CE, DCI TCI signaling) dedicated to the configured channel and/or reference signal. For example, the UE 115-b may receive an indication of a TCI state dedicated for the configured channel and/or reference signal, which may be a separate indication from the selected unified TCI at 310 and/or 320.

If however the share indication configures the UE 115-b to share the selected unified TCI states for the configured channel and/or reference signal, the UE 115 may receive an indication (e.g., in the same or separate message as the share indication) to share the selected unified TCI state associated with a particular network entities 105 (e.g., a first network entity 105, or a second network entity 105). For example, the share indication or some other indication may provide a network entity identifier corresponding to a selected unified TCI state to be applied to the configured channel and/or reference signal. For example, the UE 115 may be configured to use a first selected unified TCI state in the TCI codepoint associated with a first network entity 105 (e.g., a second behavior) or be configured to use a second selected unified TCI state in the TCI codepoint associated with a second network entity 105 (e.g., a third behavior).

Additionally, or alternatively, if the share indication configures the UE 115-b to share the selected unified TCI states in the TCI codepoint for the configured channel and/or reference signal, the share indication or some other indication may configure the UE 115-b to share the selected unified TCI states associated with both network entities 105 (e.g., a first and a second network entity 105) for the configured channel and/or reference signal (e.g., a fourth behavior). In some cases, the share indication or some other indication may provide an order of the network entities 105 (e.g., network entity 105-a followed by network entity 105-b or network entity 105-b followed by network entity 105-a) to determine the mapping between network identifier and repetition or antenna port associated with the configured channel and/or reference signal. The order may be used for determining a downlink reception or an uplink transmission associated with the network entities 105. For example, if a single frequency network based CORESET with two TCI states is enabled (e.g., sfnSchemePdcch is configured), the CORESET and/or SS may be applied with the two unified TCI states corresponding to both network identifiers. In another example, two unified TCI states corresponding to both network identifiers may be applied during transmission of PUCCH repetitions (e.g., individual repetitions of the PUCCH). The mapping between repetition and network identifier may be determined based on the order index per repetition and RRC configured pattern. For example, the UE 115-b may be configured with a parameter (e.g., cyclicMapping) such that when there are four repetitions the order of network identifiers applied to the repetitions is TRP 1, TRP 2, TRP 1, TRP 1, TRP 2 where TRP 1 corresponds to network entity 105-a, TRP 2 corresponds to network entity 105-b, and the associated TCI state and parameters corresponding to the identifier may be used for the mapped repetition. If the UE 115-b is not configured with a parameter, the order of network identifiers applied to repetitions may be TRP 1, TRP 1, TRP 2, TRP 2.

The application of each behavior (e.g., the first behavior, the second behavior, the third behavior, and the fourth behavior) to each RRC configured channel and/or reference signal may be determined per CORESET/SS, per PUCCH resource and/or resource set, per RRC configured PUCCH resource group sharing a same spatial relation, per reference signal resource and/or resource set, per configured grant configuration, or a combination thereof.

For example, if the application of each behavior is configured per CORESET or per SS, the selected behavior may be based on a classification of the CORESET and/or the SS. For an SS classified as CSS, behavior 1, 2, 3, or 4 may be signaled. For an SS classified as USS, behavior 2, 3, or 4 may be signaled (e.g., a PDCCH in USS must share at least one selected unified TCI). If behavior 2 or 3 is signaled, the CORESET and/or SS may be applied with a single selected unified TCI corresponding to the TRP ID provided by the indicator (e.g., the share indicator, some other indication). In some cases, behavior 4 may be signaled only if an SFN based CORESET with 2 TCIs is enabled (e.g., sfnSchemePdcch is configured). If behavior 4 is signaled, the CORESET and/or SS may be applied with the two unified TCIs corresponding to both TRP IDs, at least when SFN based CORESET is enabled.

In another example, in the case that the application of each behavior is configured per PUCCH resource or per PUCCH resource set, behavior 2, 3, or 4 may be signaled (e.g., the PUCCH must share at least one selected unified TCI). If the behavior is configured per PUCCH resource set and/or PUCCH resources group, every PUCCH resource in the set or group will apply the behavior. If behavior 2 or 3 is signaled, the PUCCH resource may be applied with a single selected unified TCI corresponding to the TRP ID provided by the indicator (e.g., share indication, or some other indication). If behavior 4 is signaled. the PUCCH resource may be applied with the two unified TCIs corresponding to both TRP IDs. In case of PUCCH repetition, the mapping between repetition and TRP ID may be determined based on the order index per repetition and RRC configured pattern. For example, when a repetition number is four and cyclic mapping is configured, the mapping of two TRP IDs (e.g., a first TRP with an ID of TRP1 and a second TRP with an ID of TRP2) to four repetition may follow: TRP1, TRP2, TRP1, TRP2. If cyclic mapping is not configured, the mapping may follow: TRP1, TRP1, TRP2, TRP2. The selected TCI state, as well as associated power control parameters corresponding to this TRP ID may be used for the mapped repetition.

In another example, in the case that the application of each behavior is configured per reference signal resource and/or reference signal resource set, where the reference signal is a periodic, semi-persistent, or aperiodic CSI-RS/SRS, etc., behavior 1, 2, or 3 can be signaled (e.g., each reference signal resource may share one selected unified TCI). If the behavior is configured per resource set, every reference signal resource in the set will apply the behavior. If behavior 1 is signaled, the TCI used by the reference signal resource will be signaled individually via signaling dedicated to this reference signal. If behavior 2 or 3 is signaled, the reference signal resource may be applied with a single selected unified TCI corresponding to the TRP ID provided by the indicator (e.g., share indication, or some other indication).

In another example, in the case that the application of each behavior is configured per configured grant configuration (e.g., including type-1 and type-2 configured grants for PUSCH), the application may be based on a number of SRS resource sets configured as codebook-based on non-codebook based. If a single SRS resource set is configured with usage as a codebook or non-codebook, the PUSCH of each configured grant may apply the shared selected unified TCI state as indicated in the unified TCI indication in accordance with behavior 2 or 3. The PUSCH transmission may be applied with a single selected unified TCI corresponding to the TRP ID provided by the indicator (e.g., the share indication, some other indication).

Additionally, or alternatively, if there are two SRS resource sets configured with usage as a codebook or non-codebook, the unified TCI indication may provide a network identifier corresponding to a shared unified TCI state that may be applied to each SRS resource set for the configured grant transmission whose parameters may be determined by the indicated SRS resource indicator corresponding to the SRS resources of the SRS resource set. For example, behavior 2 or 3 can be indicated per SRS resource set for the configured grant PUSCH transmission. The PUSCH transmission parameters may include parameters related to the beam, transmit precoding matrix index, rank indicator, and power control. The PUSCH transmission be associated with a subset of repetitions in TDM or FDM repetitions or a subset of spatial layers or antenna ports in SDM. Additionally, or alternatively, the UE 115-b may be configured to apply a shared unified TCI state (e.g., in accordance with behavior 2 or 3) to a particular SRS source set. As such, the PUSCH transmission indicated by the SRI corresponding to the SRS resources of the SRS resource set may be applied with the single selected unified TCI state corresponding to the network identifier provided by the indicator (e.g., share indication, some other indication) associated with the SRS resource set.

For example, if SRS resource set 1 and SRS resource set 2 are mapped to network entity 105-a and network entity 105-b, respectively (e.g., based on behavior 2 or 3), then when the configured grant is configured with PUSCH TDM repetition with two repetitions mapped to SRS set 1 and SRS set 2, respectively, the two repetitions should use the selected unified TCI states mapped to network entity 105-a and network entity 105-b, respectively. Additionally, or alternatively, if the configured grant is configured with two DMRS CDM groups mapped to SRS set 1 and SRS set 2, respectively, then the two CDM groups may use the selected unified TCI states mapped to network entity 105-a and network entity 105-b, respectively.

In either cases in which application of each behavior is per configured grant configuration, if the applied unified TCI state is associated with power control parameters, the power control parameters may be used for the PUSCH transmission. Otherwise, the power control parameters associated with the selected sounding resource indicator may be used.

At 325, the UE 115-b may transmit an acknowledgment message, which may be an ACK or NACK, indicating whether the unified TCI indication was successful received.

At 330, the network entity 105-c and the UE 115-b may perform scheduled communications. For example, the UE 115-b and the network entity 105-c may communicate the configured channels and/or reference signals (e.g., the RRC configured channels and/or reference signals) via one or more TCI states (e.g., unified TCI states, a dedicated TCI state) in accordance with the share indication.

In some implementations, to reduce RRC reconfiguration latency, the RRC configured association between TRP ID and configured channel and/or reference signal may be dynamically updated by MAC-CE or DCI. Accordingly, the UE 115 may receive a share indication in RRC signaling, ion DCI signaling, in MAC-CE signaling, or a combination thereof, where the most recent received share indication may trump a previously received share indication.

The dynamic update may be applied to the case in which the application of to each RRC configured channel and/or reference signal may be determined per CORESET/SS, per PUCCH resource and/or resource set, per RRC configured PUCCH resource group sharing a same spatial relation, per reference signal resource and/or resource set, per configured grant configuration. The dynamic update may be applied to a subset of channels and/or reference signal per case. In some cases, if the application of each behavior is per reference signal resource and/or resource set, the dynamic update may only be applied for semi-persistent or aperiodic SRS resource sets or semipersistent CSI-RS resource sets.

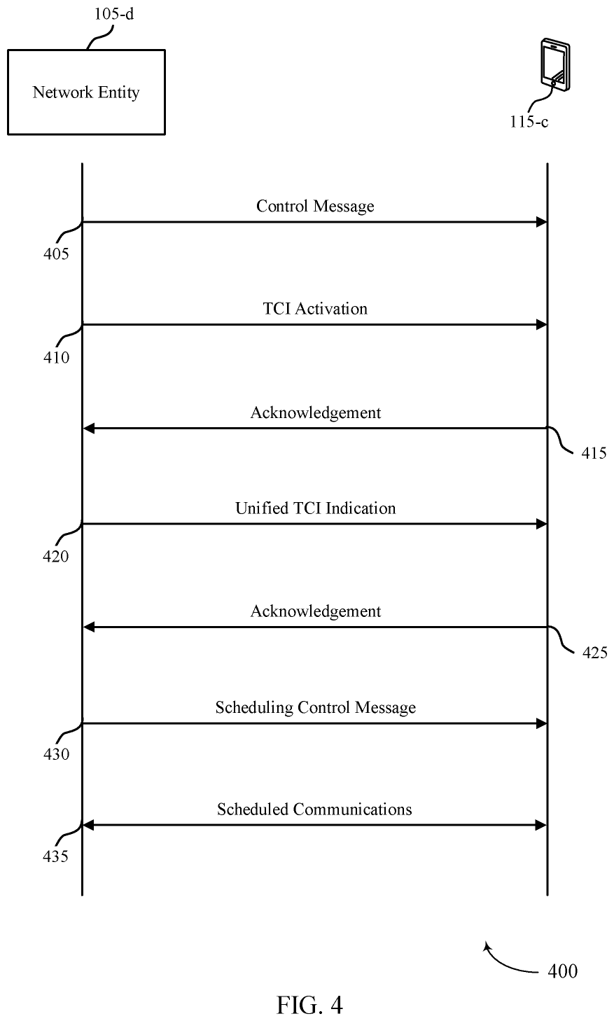

FIG. 4 illustrates an example of a process flow 400 that supports techniques for configuring communications based on unified TCI states in accordance with one or more aspects of the present disclosure. In some examples, the process flow 400 may implement or be implemented by aspects of the wireless communications system 100 and 200 as described with reference to FIGS. 1 and 2, respectively. For example, the process flow 400 may be implemented by a network entity 105-d and a UE 115-c, which may be an example of a network entity 105 and a UE 115 as described with reference to FIGS. 1 and 2, respectively. The process flow 400 may be implemented by the network entity 105-d and the UE 115-c to exchange signaling to provide reliable communications between the network entity 105-d and the UE 115-c. In the following description of the process flow 400, the operations between the network entity 105-d and the UE 115-c may be transmitted in a different order than the example order shown, or the operations performed by the network entity 105-d and the UE 115-c may be performed in different orders or at different times. Some operations may also be omitted from the process flow 400, and other operations may be added to the process flow 400.

As described herein, a UE 115 may be configured via DCI signaling with one or more configured channels and/or reference signals. In case of unified TCI for mTRP, two unified TCIs may be selected for two network entities 105, respectively, and each selected unified TCI should be mapped to an intended network entity identifier (e.g., TRP ID). For example, two downlink applicable unified TCIs and/or two uplink applicable unified TCIs may be selected by MAC-CE or DCI (e.g., mTRP in downlink or uplink). The multiple TCI states can be mapped to the same TCI codepoint, in accordance with one of the following combinations: {DL-only TCI+Joint TCI}, {UL-only TCI+Joint TCI}, {Joint TCI+Joint TCI}, {DL-only TCI+UL-only TCI+Joint TCI}, {DL-only TCI+UL-only TCI+DL-only TCI+UL-only TCI}, etc.

However, the UE 115 may not have an association of the DCI configured channel and/or reference signal with the intended TRP ID. In such cases, the UE 115 may be unable to identity a corresponding selected unified TCI to apply to those DCI configured channels and/or reference signals. In order for a UE to determine a TCI state to apply to the configured channel and/or reference signals, a DCI configured channel and/or reference signal may be associated with an intended TRP ID or IDs to allow the UE 115 to determine which selected unified TCI(s) to be applied to that channel and/or reference signal.

At 405, the network entity 105-d may transmit a control message (e.g., RRC) to the UE 115-c. The control message may include a TCI states list and, in some cases, an indication of mTRP operations. For example, the control message may include list of TCIs that may be used for communications between the UE 115-b and the network entity 105-c. The TCI list may include a set of unified TCIs, where each TCI may be associated with a certain type. For example, the types of unified TCIs may include downlink-only, uplink-only, or both downlink and uplink (e.g., joint). In some cases, the message may indicate the one or more TCI states (e.g., TCI types, TCI identifiers) associated with each TCI.

At 410, the network entity 105-d may transmit a TCI activation message to the UE 115-c that activates one or more TCI codepoints from the TCI states list. The TCI activation message may activate a subset of one or more unified TCIs (e.g., as one or more unified TCI codepoints) of the TCI list configured at the UE 115-c. In some examples, the TCI activation message may indicate a mapping between unified TCI codepoints and one or more unified TCI states with different TCI types, as described herein with reference to FIG. 2. For example, the TCI activation message may indicate Table 1, as described with reference to FIG. 2. Accordingly, each activated codepoint may include one or more unified TCI states each of which may be associated with a network identifier that corresponds to a network entity 105. In some cases, the TCI activation message may be a MAC-CE, an RRC, or another type of control signaling. At 415, the UE 115-c may transmit an acknowledgment message, which may be a ACK or NACK, indicating whether the TCI activation was successful. For example, the acknowledgment may be indicative of whether the UE 115-c received the TCI activation message from the network entity 105-d.

At 420, the network entity 105-d may transmit a unified TCI indication, which may be an example of TCI configuration indication 215, that selects one TCI codepoint from the set of activated TCI codepoints for use in scheduled communications with the one or more network entities 105. In some cases, the unified TCI indication may be included as part of a DCI message. At 425, the UE 115-c may transmit an acknowledgment message, which may be an ACK or NACK, indicating whether the unified TCI indication was successfully received. If only a single TCI codepoint is activated in the TCI activation message at 410, the DCI message at 420 and 425 may be skipped, and the selected unified TCI codepoint may be the single activated TCI codepoint in the TCI activation message.

At 430, the network entity 105-d may transmit a scheduling control message that may be indicative of scheduling information of a channel and/or reference signal (e.g., a DCI configured channel and/or reference signal). In some cases, the scheduling control message may indicate a unified TCI state to be applied to the scheduled channel and/or reference signal. In some cases, the scheduling control message may be included as part of a DCI message.

In some implementations, the control message scheduling (e.g., activating) the channel and/or RS may dynamically indicate only one of the two selected unified TCIs may be applied to the scheduled transmission. In some cases, the control message may include a filed (e.g., an indicator) of which unified TCI states in the selected TCI codepoint to be applied, which unified TCI state to be applied or a combination thereof. In some cases, a new field (e.g., a new DCI field) may be included in the control message that indicates for the UE 115 to use the one selected TCI mapped to a first network entity 105 (e.g., TRP ID 1) or a second network entity 105 (e.g., TRP ID 2), or for the UE 115 to use both selected TCIs (e.g., the TCI associated with the first network entity 105 and the second network entity 105).

In some cases, the control message may reserve a subset of TCI codepoints in the DCI that indicate a unified TCI state. For example, TCI codepoint ‘110’ may be reserved to indicate that the unified TCI state mapped to the first network entity 105 should be used while the TCI codepoint 111 may be reserved to indicate that the unified TCI state mapped to the second network entity 105 should be used. Additionally, or alternatively, a field of the DCI (e.g., a new 1-bit filed) may be reserved to indicate whether one or two unified TCI states should be applied. If it is indicated that one unified TCI state should be used, the one unified TCI state may be determined by a rule (e.g., a defined rule) or configured in the control message (e.g., RRC message). For example, the rule and/or control message may configure the UE 115 to use the TCI state associated with a first network entity 105, or a second network entity 105. In some cases, the one unified TCI state may be the unified TCI state mapped to the network entity identifier configured for the scheduling CORESET and/or search space of the DCI. For example, if the CORESET is configured to use the two TCIs mapped to both network entities 105 (e.g., network entity IDs), the used network identifier may be determined by a rule (e.g., a defined rule) or control message (e.g., RRC message).

In some cases, if the control message (e.g., DCI message) scheduling (e.g., activating) the channel and/or RS does not include a TCI field or any new field (e.g., DCI of a DCI format 1_0 or 0_0), the UE 115 may be configured to use only one unified TCI state of the two selected TCI states of a selected codepoint for the scheduled transmission. Accordingly, the control message may implicitly indicate to the UE 115 to use one unified TCI state (e.g., based on the control information message refraining to include a TCI indication state field). The UE 15 may be configured to map the single TCI state to either a first network entity 105 (e.g., TRP ID 1) or a second network entity 105 (e.g., TRP ID 2) based on a rule (e.g., defined rule) or indication (e.g., RRC indication). Additionally, or alternatively, the UE 115 may be configured to map the TCI state to the network identifier configured for the scheduling CORESET and/or search space of the DCI message. In the case that the CORESET is configured with two unified TCI states mapped to both network identifiers, the network identifier mapped to the single TCI state may be determined by a rule or indicated by a control message.

In some cases, the scheduling control message (e.g., a DCI scheduling a PUSCH) may be configured with a SRS resource set indicator field. In such cases, the mapped network entity per SRS resource set can be configured for the DCI scheduled/activated PUSCH (e.g., in a PUSCH configuration message). If the SRS resource set indicator indicates only a single SRS resource set for the scheduled PUSCH (e.g., 00 or 01), the PUSCH transmission may be applied with a single selected unified TCI state corresponding to the network identifier mapped to the single SRS resource set. Otherwise, if the SRS resource set indicator indicates both resource sets for the scheduled PUSCH (e.g., 10 or 11), each of the two selected unified TCI states may be applied to a subset of PUSH repetitions or DMRS port groups mapped to the SRS resource set that share the same network identifier as the applied TCI state.

In some cases, the scheduling control message at 430 may indicate that both selected TCI states should be applied to the scheduled transmissions. As such, the UE 115-c may be configured with a method for mapping the selected TCI states to the network identifiers across repetitions (or DMRs ports) of the scheduled channel and/or reference signal. In some implementations, the UE 115-c may be configured to apply the first downlink or uplink applicable unified TCI state of the codepoint to a first transmission repetition and a second downlink or uplink applicable unified TCI state of the codepoint to a second transmission repetition (and so on). For example, if the scheduled channel is an uplink channel, the UE 115 may apply the first uplink TCI state in the selected codepoint to a first repetition of the scheduled uplink channel and apply the second uplink applicable TCI state of the selected codepoint to a second repetition of the schedule uplink channel. Alternatively, the UE 115-c may be configured to apply the unified TCI states in accordance with a network entity order. For example, the UE 115 may be configured to use the unified TCI state associated with a first network entity for a first transmission repetition and use the unified TCI state associated with a second network entity for a second repetition. For example, when a PDSCH is configured with a spatial division multiplexing scheme based DCI, such as an sDCI (e.g., two DMRS CDM groups are indicated in scheduling DCI), a downlink applicable TCI state mapped to TRP ID 1 may be applied to the DMRS CDM group of the first antenna port indicated by the antenna port indication table and a downlink applicable TCI state mapped to TRP ID 2 may be applied to the other DMRS CDM group.

In some cases, a PDSCH may be configured with FDM based DCI mTRP (e.g., fdmSchemeA of a single redundancy version (RV), or fdmSchemeB of two RVs), and one DMRS CDM group is indicated in the control message (e.g., DCI). If the physical resource block bundling size is wide band, the downlink applicable TCI states mapped to TRP ID 1 and TRP ID 2 may be applied to the first half and second half of physical resource blocks, respectively. If the physical resource block bundling size is two or four, the downlink applicable TCI states mapped to TRP ID 1 and TRP ID 2 may be applied to the even and odd physical resource blocks, respectively.

In some cases, a PDSCH may be configured with TDM based DCI mTRP (e.g., tdmSchemeA which is for intra-slot repetition, or repetitionNumber which is for inter-slot repetition), and the UE 115 may be configured with one DMRS CDM group indicated in the scheduling control message (e.g., DCI). If tdmSchemeA is configured, the downlink applicable TCI state mapped to TRP ID 1 and TRP ID 2 may be applied to the first and second PDSCH transmission occasions respectively. If repetitionNumber is configured and cyclicMapping is enabled, the downlink applicable TCI state mapped to TRP ID 1 and TRP ID 2 may be applied to the first and second PDSCH transmission occasions, respectively, and the same TCI state mapping pattern may continue to the remaining occasions. If repetitionNumber is configured and sequentialMapping is enabled, the downlink applicable TCI state mapped to TRP ID 1 may be applied to the first and second PDSCH transmission occasions and the downlink applicable TCI state mapped to TRP ID 2 may be applied to the third and fourth occasions with the same TCI mapping pattern continuing to the remaining occasions.

In some cases, the scheduling control message may not indicate a unified TCI state to be applied to the scheduled transmission. Alternatively, the unified TCI state associated with the dynamically scheduled transmission may be determined by a mapping indicated in the control message as described at 405.

At 435, the network entity 105-d and the UE 115-c may perform scheduled communications using the configured channel associated with the selected unified TCI state that was activated by the scheduling control message.

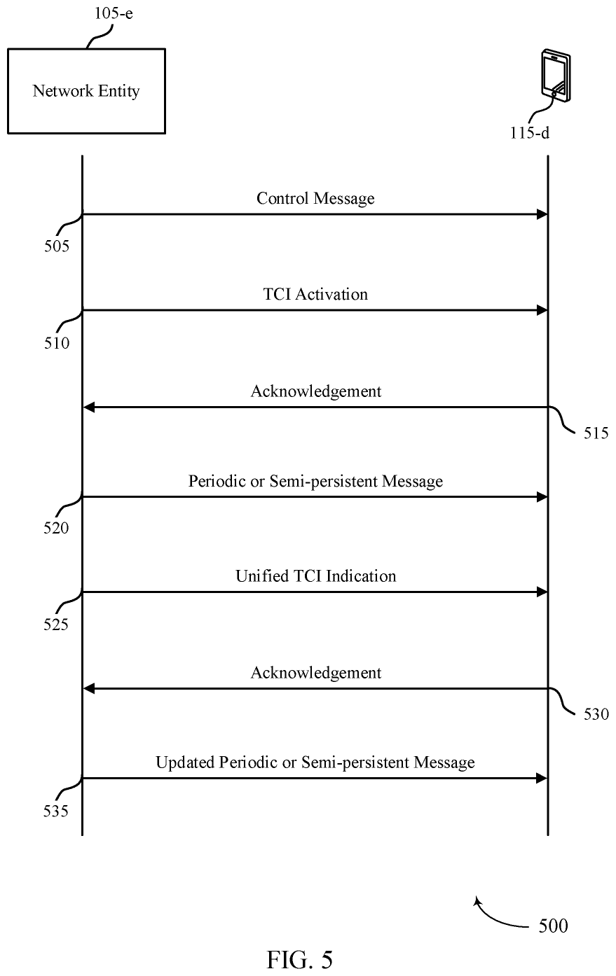

FIG. 5 illustrates an example of a process flow 500 that supports techniques for configuring communications based on unified TCI states in accordance with one or more aspects of the present disclosure. In some examples, the process flow 500 may implement or be implemented by aspects of the wireless communications system 100 and 200 as described with reference to FIGS. 1 and 2, respectively. For example, the process flow 400 may be implemented by a network entity 105-e and a UE 115-d, which may be an example of a network entity 105 and a UE 115 as described with reference to FIGS. 1 and 2, respectively. The process flow 500 may be implemented by the network entity 105-e and the UE 115-d to exchange signaling to provide reliable communications between the network entity 105-e and the UE 115-d. In the following description of the process flow 500, the operations between the network entity 105-e and the UE 115-d may be transmitted in a different order than the example order shown, or the operations performed by the network entity 105-e and the UE 115-d may be performed in different orders or at different times. Some operations may also be omitted from the process flow 500, and other operations may be added to the process flow 500.

As described herein, a UE 115 may be configured with one or more scheduled with a communication (e.g., a channel, reference signal). In some cases, the UE 115 may be configured to perform the scheduled communication periodically or semi-persistently in accordance with a first TCI state, such as TCI state dedicated to the scheduled communication. However, the UE 115 may receive a unified TCI indication at a later time indicative of one or more unified TCI states the UE 115 is to use for scheduled communications. Accordingly, the techniques described with reference to FIG. 5 describe methods for a UE 115 to determine a TCI state to use for periodic or semi-persistent scheduled communications.

At 505, the network entity 105-e may transmit a control message (e.g., RRC) to the UE 115-d. The control message may indicate a TCI states list (e.g., as described with reference at 305 and 405 with reference to FIGS. 3 and 4) and mTRP operations. In some cases, the control message may indicate scheduling information for a semi-persistent or periodic communication to be performed by UE 115-d (e.g., a downlink communication, an uplink communication).

At 510, the network entity 105-e may transmit a TCI activation message to the UE 115-d that indicates a TCI state for the scheduled communications. In some cases, the TCI activation message may indicate a unified TCI state or a dedicated TCI for the scheduled communication. In some cases, the TCI activation message may be a MAC-CE message or included in a MAC-CE, or some other control message. For example, a semi-persistent scheduling configuration message or a configured grant may indicate the first or second downlink or uplink applicable TCI state for the scheduling. At 515, the UE 115-d may transmit an acknowledgment message, which may be an ACK or NACK, indicating whether the TCI activation was successful.

In the case that the scheduled communication is a downlink message, at 520, the network entity 105-e may transmit the periodic or semi-persistent scheduled message. The UE 115 may use the TCI state configured at 515 to receive the message. At 525, the network entity 105-e may transmit a unified TCI indication, which may be an example of TCI configuration indication as described with reference to FIGS. 2 through 4, that selects one TCI codepoint from the set of activated TCI codepoints for use in scheduled communications with the one or more network entities 105. In some cases, the unified TCI indication may be included as part of a DCI message. The TCI codepoint may be associated with multiple unified TCI states (e.g., such as two downlink applicable unified TCI states) for the UE 115 to use for mTRP communications with a first network entity 105 and a second network entity 105, such as network entity 105-e. At 530, the UE 115-d may transmit an acknowledgment message, which may be an ACK or NACK, indicating whether the unified TCI indication was successfully received.

At 535, the network entity 105-e may again transmit the periodic or semi-persistent message. In some cases, the UE 115 may be configured to use one of the two selected unified TCI states to receive the message (e.g., rather than the TCI state configured at 515). In some cases, the UE 115 may use the unified TCI state that has the same TRP ID as the original selected TCI state (at 515). For example, in SPS, the UE 115 may select the unified TCI state associated with the network identifier configured for the activation CORESET and/or SS. In some examples, for a configured grant, the UE 115 may select the unified TCI state associated with the network identifier for the SRS resource set corresponding to the SRI associated with the PUSCH transmission. In another example, such as a persistent or semi-persistent PUCCH, the UE 115 may select the unified TCI state associated with the network identifier configured for the PUCCH resource. The UE 115 may be configured to select the unified TCI based on a rule (e.g., defined rule) and/or RRC configuration (e.g., in SPS-Config for SPS, ConfiguredGrantConfig for CG). For example, the UE 115 may be configured to select a first or second downlink applicable TCI state of the selected unified TCI codepoint for SPS configured message, and select the first or second uplink applicable TCI state of the selected unified TCI codepoint for a configure grant, PUCCH, etc.

In some cases, upon receiving the unified TCI indication at 525, the periodic or semi-persistent transmission may be implicitly reconfigured with two selected TCI states instead of the original one selected TCI state (at 515). Additionally or alternately, the periodic or semi-persistent transmission may be implicitly deactivated by the unified TCI indication at 525 (e.g., a DCI) that indicates two selected unified TCI states. Accordingly, the unified TCI indication may serve as a deactivation DCI, in some cases.

It should be understood that while the techniques described with reference to FIG. 5 are associated with downlink aperiodic or semi-persistent communications, the described techniques may be used or adapted to support uplink periodic or semi-persistent communications.

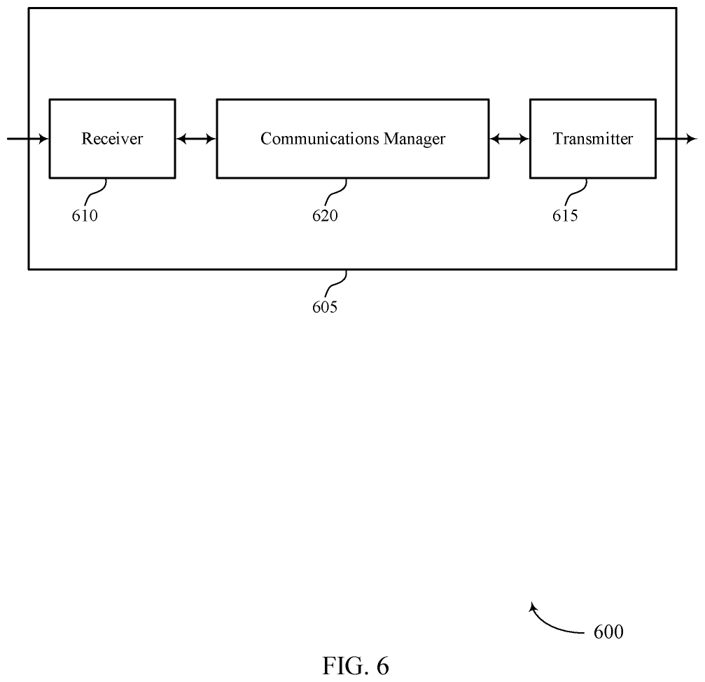

FIG. 6 shows a block diagram 600 of a device 605 that supports techniques for configuring communications based on unified TCI states in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for configuring communications based on unified TCI states). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for configuring communications based on unified TCI states). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for configuring communications based on unified TCI states as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving a control message indicating a configuration for a signal, where the configuration indicates whether the signal is associated with one or more unified TCI states of a selected unified TCI codepoint. The communications manager 620 may be configured as or otherwise support a means for receiving a first DCI message indicating a set of one or more activated TCI codepoints that are each associated with one or more TCI states. The communications manager 620 may be configured as or otherwise support a means for receiving a second DCI message indicating the selected unified TCI codepoint from the set of one or more activated TCI codepoints. The communications manager 620 may be configured as or otherwise support a means for applying a TCI state for communication of the signal in accordance with the configuration.

Additionally, or alternatively, the communications manager 620 may support wireless communications at a UE in accordance with examples as disclosed herein. For example, the communications manager 620 may be configured as or otherwise support a means for receiving a first DCI message indicating a selected unified TCI codepoint from a set of one or more activated TCI codepoints that are each associated with one or more TCI states. The communications manager 620 may be configured as or otherwise support a means for receiving a second DCI message scheduling a signal and indicating a TCI state of the selected unified TCI codepoint is associated with the signal. The communications manager 620 may be configured as or otherwise support a means for applying the TCI state for communication of the signal in accordance with the second DCI message.

Additionally, or alternatively, the communications manager 620 may support wireless communications at a UE in accordance with examples as disclosed herein. For example, the communications manager 620 may be configured as or otherwise support a means for receiving a first DCI message indicating a selected unified TCI codepoint from a set of one or more activated TCI codepoints that are each associated with one or more TCI states. The communications manager 620 may be configured as or otherwise support a means for receiving a second DCI message scheduling a signal and indicating multiple TCI states of the selected unified TCI codepoint are associated with the signal. The communications manager 620 may be configured as or otherwise support a means for applying the multiple TCI states across repetitions of the signal in accordance with a configuration.

Additionally, or alternatively, the communications manager 620 may support wireless communication at a UE in accordance with examples as disclosed herein. For example, the communications manager 620 may be configured as or otherwise support a means for receiving a first DCI message indicating a selected unified TCI codepoint from a set of one or more activated TCI codepoints that are each associated with one or more TCI states. The communications manager 620 may be configured as or otherwise support a means for receiving a second DCI message indicating a first TCI state to use for a signal, the signal being a periodic or semi-persistent signal. The communications manager 620 may be configured as or otherwise support a means for receiving a third DCI message indicating multiple TCI states of the selected unified TCI codepoint. The communications manager 620 may be configured as or otherwise support a means for determining to apply the first TCI state or the multiple TCI states to the signal in accordance with a configuration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

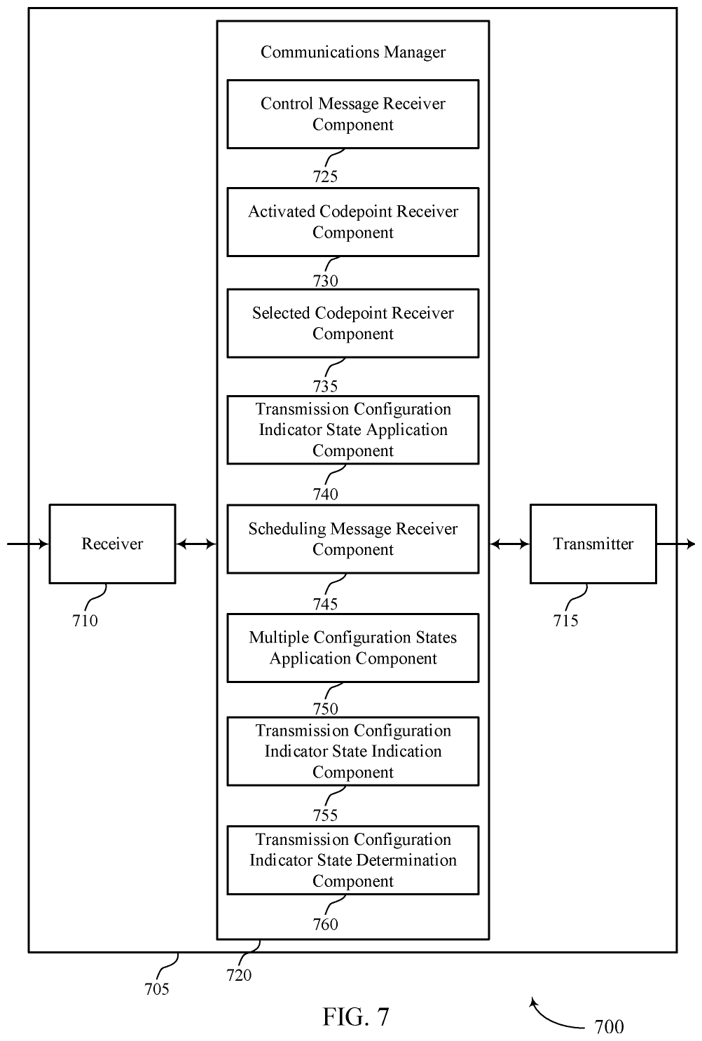

FIG. 7 shows a block diagram 700 of a device 705 that supports techniques for configuring communications based on unified TCI states in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for configuring communications based on unified TCI states). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for configuring communications based on unified TCI states). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for configuring communications based on unified TCI states as described herein. For example, the communications manager 720 may include a control message receiver component 725, an activated codepoint receiver component 730, a selected codepoint receiver component 735, a TCI state application component 740, a scheduling message receiver component 745, a multiple configuration states application component 750, a TCI state indication component 755, a TCI state determination component 760, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The control message receiver component 725 may be configured as or otherwise support a means for receiving a control message indicating a configuration for a signal, where the configuration indicates whether the signal is associated with one or more unified TCI states of a selected unified TCI codepoint. The activated codepoint receiver component 730 may be configured as or otherwise support a means for receiving a first DCI message indicating a set of one or more activated TCI codepoints that are each associated with one or more TCI states. The selected codepoint receiver component 735 may be configured as or otherwise support a means for receiving a second DCI message indicating the selected unified TCI codepoint from the set of one or more activated TCI codepoints. The TCI state application component 740 may be configured as or otherwise support a means for applying a TCI state for communication of the signal in accordance with the configuration.

Additionally, or alternatively, the communications manager 720 may support wireless communications at a UE in accordance with examples as disclosed herein. The selected codepoint receiver component 735 may be configured as or otherwise support a means for receiving a first DCI message indicating a selected unified TCI codepoint from a set of one or more activated TCI codepoints that are each associated with one or more TCI states. The scheduling message receiver component 745 may be configured as or otherwise support a means for receiving a second DCI message scheduling a signal and indicating a TCI state of the selected unified TCI codepoint is associated with the signal. The TCI state application component 740 may be configured as or otherwise support a means for applying the TCI state for communication of the signal in accordance with the second DCI message.

Additionally, or alternatively, the communications manager 720 may support wireless communications at a UE in accordance with examples as disclosed herein. The selected codepoint receiver component 735 may be configured as or otherwise support a means for receiving a first DCI message indicating a selected unified TCI codepoint from a set of one or more activated TCI codepoints that are each associated with one or more TCI states. The scheduling message receiver component 745 may be configured as or otherwise support a means for receiving a second DCI message scheduling a signal and indicating multiple TCI states of the selected unified TCI codepoint are associated with the signal. The multiple configuration states application component 750 may be configured as or otherwise support a means for applying the multiple TCI states across repetitions of the signal in accordance with a configuration.

Additionally, or alternatively, the communications manager 720 may support wireless communication at a UE in accordance with examples as disclosed herein. The selected codepoint receiver component 735 may be configured as or otherwise support a means for receiving a first DCI message indicating a selected unified TCI codepoint from a set of one or more activated TCI codepoints that are each associated with one or more TCI states. The scheduling message receiver component 745 may be configured as or otherwise support a means for receiving a second DCI message indicating a first TCI state to use for a signal, the signal being a periodic or semi-persistent signal. The TCI state indication component 755 may be configured as or otherwise support a means for receiving a third DCI message indicating multiple TCI states of the selected unified TCI codepoint. The TCI state determination component 760 may be configured as or otherwise support a means for determining to apply the first TCI state or the multiple TCI states to the signal in accordance with a configuration.

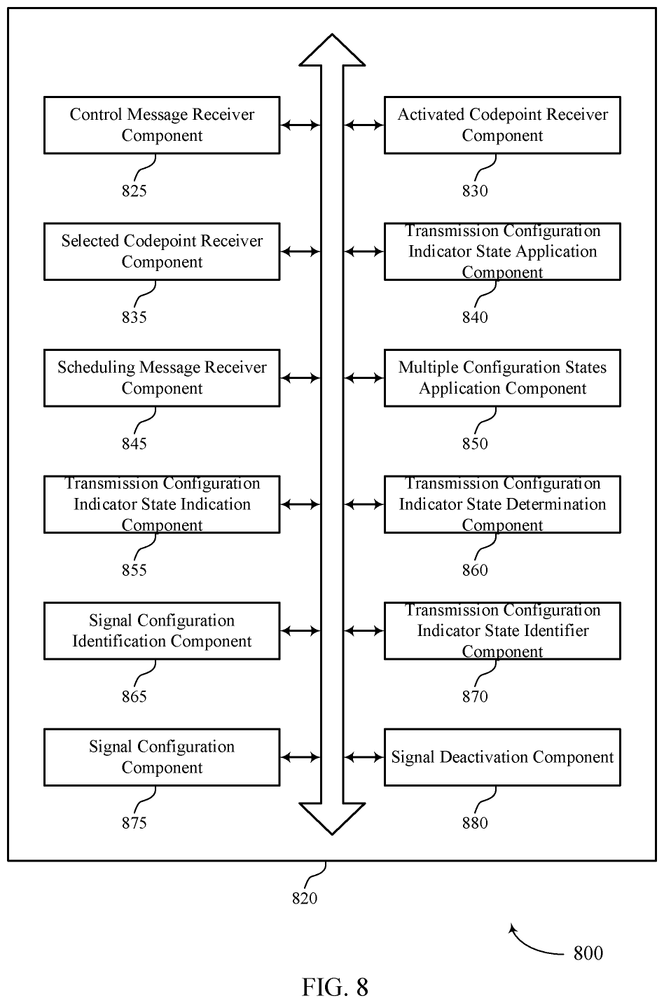

FIG. 8 shows a block diagram 800 of a communications manager 820 that supports techniques for configuring communications based on unified TCI states in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for configuring communications based on unified TCI states as described herein. For example, the communications manager 820 may include a control message receiver component 825, an activated codepoint receiver component 830, a selected codepoint receiver component 835, a TCI state application component 840, a scheduling message receiver component 845, a multiple configuration states application component 850, a TCI state indication component 855, a TCI state determination component 860, a signal configuration identification component 865, a TCI state identifier component 870, a signal configuration component 875, a signal deactivation component 880, or any combination thereof. Each of these components may communicate, directly or indirectly, with one another (e.g., via one or more buses).

The communications manager 820 may support wireless communications at a UE in accordance with examples as disclosed herein. The control message receiver component 825 may be configured as or otherwise support a means for receiving a control message indicating a configuration for a signal, where the configuration indicates whether the signal is associated with one or more unified TCI states of a selected unified TCI codepoint. The activated codepoint receiver component 830 may be configured as or otherwise support a means for receiving a first DCI message indicating a set of one or more activated TCI codepoints that are each associated with one or more TCI states. The selected codepoint receiver component 835 may be configured as or otherwise support a means for receiving a second DCI message indicating the selected unified TCI codepoint from the set of one or more activated TCI codepoints. The TCI state application component 840 may be configured as or otherwise support a means for applying a TCI state for communication of the signal in accordance with the configuration.

In some examples, to support receiving the control message, the control message receiver component 825 may be configured as or otherwise support a means for identifying that an association between the signal and the one or more unified TCI states is per a control resource set or per a search space of the control resource set.

In some examples, the signal configuration identification component 865 may be configured as or otherwise support a means for identifying that the control resource set or the search space is common to multiple UEs, where the configuration includes an indication that indicates one of a first option, a second option, a third option, or a fourth option based on the control resource set or the search space being common to multiple UEs, where the first option is that the signal is to be associated with none of the one or more unified TCI states, the second option is that the signal is to be associated with a first one of the one or more unified TCI states used for communications with a first transmission and reception point of a network entity, the third option is that the signal is to be associated with a second one of the one or more unified TCI states used for communications with a second transmission and reception point of the network entity, and the fourth option is that the signal is to be associated with both the first one and the second one of the one or more unified TCI states used for communications with both the first transmission and reception point and the second transmission and reception point of the network entity.

In some examples, the signal configuration identification component 865 may be configured as or otherwise support a means for identifying that the control resource set or the search space is specific to the UE, where the configuration includes an indication that indicates one of a first option, a second option, or a third option based on the control resource set or the search space being specific to the UE, where the first option is that the signal is to be associated with a first one of the one or more unified TCI states used for communications with a first transmission and reception point of a network entity, the second option is that the signal is to be associated with a second one of the one or more unified TCI states used for communications with a second transmission and reception point of the network entity, and the third option is that the signal is to be associated with both the first one and the second one of the one or more unified TCI states used for communications with both the first transmission and reception point and the second transmission and reception point of the network entity.

In some examples, the signal configuration identification component 865 may be configured as or otherwise support a means for identifying that the configuration indicates that the signal is to be associated with both a first one of the one or more unified TCI states used for communications with a first transmission and reception point of a network entity and a second one of the one or more unified TCI states used for communications with a second transmission and reception point of the network entity, where the configuration is based on a single frequency network based control resource set being enabled to include multiple TCIs.

In some examples, an order of the first one and the second one of the one or more unified TCI states indicated in the configuration is indicative of a corresponding order of transmission and reception point identifiers to be applied to the one or more unified TCI states.

In some examples, to support receiving the control message, the control message receiver component 825 may be configured as or otherwise support a means for identifying that an association between the signal and the one or more unified TCI states is per a physical uplink control channel resource, a physical uplink control channel resource set, a physical uplink control channel resource group, or a combination thereof, and that the signal is associated with a physical uplink control channel.

In some examples, the signal configuration identification component 865 may be configured as or otherwise support a means for identifying that the configuration includes an indication that indicates one of a first option, a second option, or a third option based on the signal being associated with the physical uplink control channel, where the first option is that the signal is to be associated with a first one of the one or more unified TCI states used for communications with a first transmission and reception point of a network entity, the second option is that the signal is to be associated with a second one of the one or more unified TCI states used for communications with a second transmission and reception point of the network entity, and the third option is that the signal is to be associated with both the first one and the second one of the one or more unified TCI states used for communications with both the first transmission and reception point and the second transmission and reception point of the network entity.

In some examples, the signal configuration identification component 865 may be configured as or otherwise support a means for identifying that the association between the signal and the one or more unified TCI states is per the physical uplink control channel resource set or per the physical uplink control channel resource group, where the configuration is applicable to each physical uplink channel resource in the physical uplink control channel resource set or the physical uplink control channel resource group.

In some examples, the signal configuration identification component 865 may be configured as or otherwise support a means for identifying that the configuration indicates that the signal is to be associated with both a first one of the one or more unified TCI states used for communications with a first transmission and reception point of a network entity and a second one of the one or more unified TCI states used for communications with a second transmission and reception point of the network entity, where individual repetitions of the physical uplink control channel are mapped to either the first transmission and reception point or the second transmission and reception point based on a configured pattern.

In some examples, to support receiving the control message, the control message receiver component 825 may be configured as or otherwise support a means for identifying that an association between the signal and the one or more unified TCI states is per a reference signal resource, a reference signal resource set, or a combination thereof, and that the signal is a reference signal.

In some examples, the signal configuration identification component 865 may be configured as or otherwise support a means for identifying that the configuration includes an indication that indicates one of a first option, a second option, or a third option based on the signal being the reference signal, where the first option is that the signal is to be associated with none of the one or more unified TCI states, the second option is that the signal is to be associated with a first one of the one or more unified TCI states used for communications with a first transmission and reception point of a network entity, and the third option is that the signal is to be associated with a second one of the one or more unified TCI states used for communications with a second transmission and reception point of the network entity.

In some examples, the signal configuration identification component 865 may be configured as or otherwise support a means for identifying that the configuration indicates that the signal is to be associated with none of the one or more unified TCI states. In some examples, the control message receiver component 825 may be configured as or otherwise support a means for receiving a dedicated control message for the signal, the dedicated control message including a dedicated TCI state assigned to the signal based on the configuration indicating that the signal is associated with none of the one or more unified TCI states.

In some examples, the signal configuration identification component 865 may be configured as or otherwise support a means for identifying that the configuration indicates that the signal is to be associated with either a first one of the one or more unified TCI states used for communications with a first transmission and reception point of a network entity or a second one of the one or more unified TCI states used for communications with a second transmission and reception point of the network entity, where a single selected unified TCI state is applied to the reference signal in accordance with the configuration.

In some examples, the reference signal is one of a periodic, semi-persistent, or aperiodic channel state information reference signal or a sounding reference signal.

In some examples, to support receiving the control message, the signal configuration identification component 865 may be configured as or otherwise support a means for identifying that an association between the signal and the one or more unified TCI states is per configured grant, where the configured grant is a type 1 configured grant or a type 2 configured grant.

In some examples, the signal configuration identification component 865 may be configured as or otherwise support a means for identifying that the configuration includes an indication that indicates one of a first option or a second option based on only a single sounding reference signal resource set being associated with the configured grant, where the first option is that the signal is to be associated with a first one of the one or more unified TCI states used for communications with a first transmission and reception point of a network entity, and the second option is that the signal is to be associated with a second one of the one or more unified TCI states used for communications with a second transmission and reception point of the network entity.

In some examples, the signal configuration identification component 865 may be configured as or otherwise support a means for identifying that the configuration includes an indication that indicates one of a first option or a second option based on at least two sounding reference signal resource sets being associated with the configured grant, the indication indicating either the first option or the second option on a per sounding reference signal resource set basis for a physical uplink shared channel transmission associated with the configured grant, where the first option is that the signal is to be associated with a first one of the one or more unified TCI states used for communications with a first transmission and reception point of a network entity, and the second option is that the signal is to be associated with a second one of the one or more unified TCI states used for communications with a second transmission and reception point of the network entity.

In some examples, one or more parameters of the physical uplink shared channel transmission are determined by a sounding reference signal resource indicator corresponding to sounding reference signal resources in a respective sounding reference signal resource set.

In some examples, the one or more parameters of the physical uplink shared channel transmission include one or more beam parameters, a transmitted precoding matrix indicator, a rank indicator, one or more power control parameters, or a combination thereof.

In some examples, the physical uplink shared channel transmission is configured for a subset of repetitions in time division multiplexing or frequency division multiplexing repetitions, or for a subset of spatial layers or antenna ports in spatial division multiplexing.

In some examples, the physical uplink shared channel transmission is indicated by a scheduling request indicator corresponding to sounding reference signal resources in a sounding reference signal resource set and is applied with a single selected unified TCI state in accordance with the single TCI order index provided by the configuration associated with the sounding reference signal resource set.

In some examples, to support receiving the control message, the control message receiver component 825 may be configured as or otherwise support a means for receiving a RRC message, a MAC-CE message, a DCI message, or a combination thereof indicating the configuration for the signal.

In some examples, the control message receiver component 825 may be configured as or otherwise support a means for receiving a second control message including an updated configuration for the signal, where the second control message is a MAC-CE message, a DCI message, or both.

Additionally, or alternatively, the communications manager 820 may support wireless communications at a UE in accordance with examples as disclosed herein. In some examples, the selected codepoint receiver component 835 may be configured as or otherwise support a means for receiving a first DCI message indicating a selected unified TCI codepoint from a set of one or more activated TCI codepoints that are each associated with one or more TCI states. The scheduling message receiver component 845 may be configured as or otherwise support a means for receiving a second DCI message scheduling a signal and indicating a TCI state of the selected unified TCI codepoint is associated with the signal. In some examples, the TCI state application component 840 may be configured as or otherwise support a means for applying the TCI state for communication of the signal in accordance with the second DCI message.

In some examples, to support receiving the second DCI message, the selected codepoint receiver component 835 may be configured as or otherwise support a means for receiving the second DCI message including a transmission configuration indication codepoint from a set of transmission configuration indication codepoints, the transmission configuration indication codepoint indicative of the TCI state associated with a first network entity.

In some examples, the set of transmission configuration indication codepoints are reserved for indicating the TCI state of the signal via RRC signaling.

In some examples, to support receiving the second DCI message, the scheduling message receiver component 845 may be configured as or otherwise support a means for receiving the second DCI message including an indication of whether one or multiple transmission configuration indication states are to be applied to the signal. In some examples, to support receiving the second DCI message, the TCI state identifier component 870 may be configured as or otherwise support a means for identifying the TCI state in accordance with a rule based on the indication.

In some examples, the indication is included in a 1-bit DCI field.

In some examples, the rule is configured via RRC signaling.

In some examples, the second DCI message implicitly indicates the TCI state, the UE identifies the TCI state based on the second DCI message refraining to include a TCI state field.

In some examples, to support receiving the second DCI message, the scheduling message receiver component 845 may be configured as or otherwise support a means for receiving the second DCI message including a sounding reference signal resource set indicator field indicative of at least one sounding reference signal resource set, the TCI state indicated by the at least one sounding reference signal resource set.

In some examples, the second DCI message indicates two sounding reference signal resource sets, and the TCI state identifier component 870 may be configured as or otherwise support a means for identifying a first TCI state from the selected unified TCI codepoint associated with a first network entity, and a second TCI state from the selected unified TCI codepoint associated with a second network entity. In some examples, the second DCI message indicates two sounding reference signal resource sets, and the TCI state application component 840 may be configured as or otherwise support a means for applying the first TCI state and the second TCI state to uplink shared channel repetitions or demodulation reference signal port groups based on a network entity associated with each repetition or each port group.

In some examples, the second DCI message indicates one sounding reference signal resource set, and the TCI state identifier component 870 may be configured as or otherwise support a means for identifying the TCI state from the selected unified TCI codepoint that is associated with the network entity.

In some examples, the signal is associated with an uplink shared channel.

Additionally, or alternatively, the communications manager 820 may support wireless communications at a UE in accordance with examples as disclosed herein. In some examples, the selected codepoint receiver component 835 may be configured as or otherwise support a means for receiving a first DCI message indicating a selected unified TCI codepoint from a set of one or more activated TCI codepoints that are each associated with one or more TCI states. In some examples, the scheduling message receiver component 845 may be configured as or otherwise support a means for receiving a second DCI message scheduling a signal and indicating multiple TCI states of the selected unified TCI codepoint are associated with the signal. The multiple configuration states application component 850 may be configured as or otherwise support a means for applying the multiple TCI states across repetitions of the signal in accordance with a configuration.

In some examples, an order of TCI states applied to the repetitions corresponds to an order of the TCI states in the selected unified TCI codepoint in accordance with the configuration.

In some examples, an order of TCI states applied to the repetitions corresponds to an order of network entities associated with each of the multiple TCI states of the selected unified TCI codepoint in accordance with the configuration.

In some examples, the multiple TCI states are applied across the repetitions based on a communication type associated with the repetitions in accordance with the configuration, the communication type including one of frequency division multiplexing, time division multiplexing, or spatial division multiplexing.

In some examples, the multiple TCI states are applied across the repetitions in accordance with the configuration based on a number of code division-multiplexing groups indicated in the second DCI message.

In some examples, the multiple TCI states are applied across the repetitions in accordance with the configuration based on a physical resource block bundling size associated with the repetitions.

In some examples, the multiple TCI states are applied across the repetitions in accordance with the configuration based on cyclic mapping being enabled or sequential mapping being enabled for the repetitions.

In some examples, the signal is associated with an uplink shared channel.

Additionally, or alternatively, the communications manager 820 may support wireless communication at a UE in accordance with examples as disclosed herein. In some examples, the selected codepoint receiver component 835 may be configured as or otherwise support a means for receiving a first DCI message indicating a selected unified TCI codepoint from a set of one or more activated TCI codepoints that are each associated with one or more TCI states. In some examples, the scheduling message receiver component 845 may be configured as or otherwise support a means for receiving a second DCI message indicating a first TCI state to use for a signal, the signal being a periodic or semi-persistent signal. The TCI state indication component 855 may be configured as or otherwise support a means for receiving a third DCI message indicating multiple TCI states of the selected unified TCI codepoint. The TCI state determination component 860 may be configured as or otherwise support a means for determining to apply the first TCI state or the multiple TCI states to the signal in accordance with a configuration.

In some examples, to support determining to apply the first TCI state or the multiple TCI states, the TCI state determination component 860 may be configured as or otherwise support a means for determining to apply one of the multiple TCI states to the signal in accordance with the configuration.

In some examples, the TCI state determination component 860 may be configured as or otherwise support a means for selecting a second TCI state from the multiple TCI states based on the second TCI state being associated with a same network entity as the first TCI state.

In some examples, selecting the second TCI state is based on the signal being a semi-persistent scheduling signal, a configured grant, or an uplink shared channel signal.

In some examples, selecting the second TCI state is based on a control resource set, a sounding reference signal resource set corresponding to a scheduling request indicator, or an uplink control channel resource associated with the signal.

In some examples, determining to apply the first TCI state or the multiple TCI states based on a rule.

In some examples, to support determining to apply the first TCI state or the multiple TCI states, the signal configuration component 875 may be configured as or otherwise support a means for configuring the signal to be associated with the multiple TCI states rather than the first TCI state based on the third DCI message indicating the multiple TCI states.

In some examples, to support determining to apply the first TCI state or the multiple TCI states, the signal deactivation component 880 may be configured as or otherwise support a means for determining that the signal is deactivated based on receiving the third DCI message indicating the multiple TCI states.

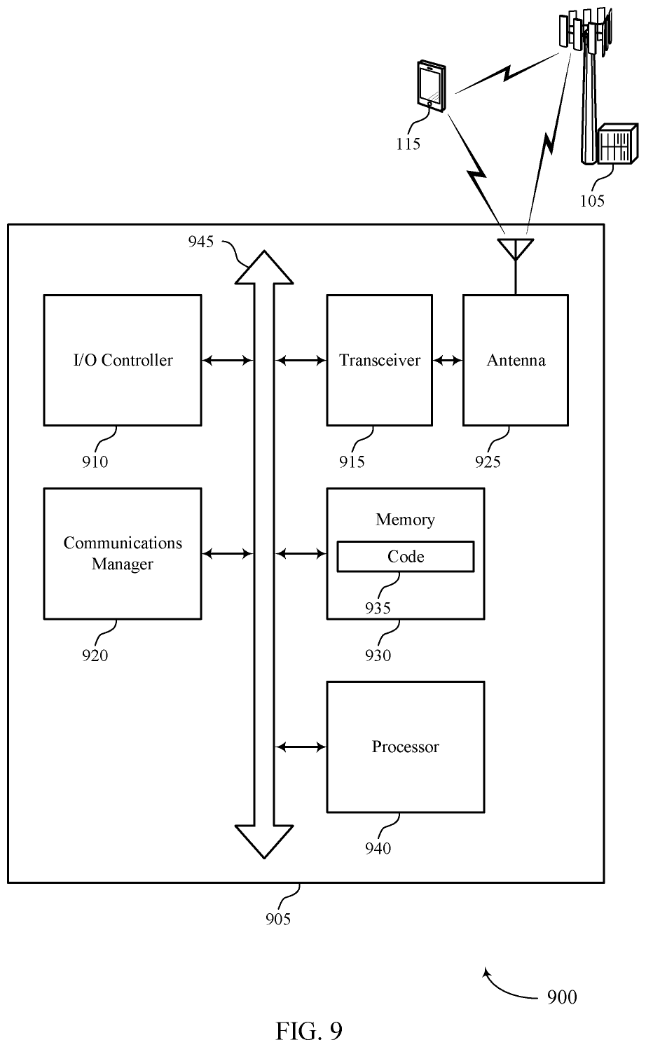

FIG. 9 shows a diagram of a system 900 including a device 905 that supports techniques for configuring communications based on unified TCI states in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for configuring communications based on unified TCI states). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a control message indicating a configuration for a signal, where the configuration indicates whether the signal is associated with one or more unified TCI states of a selected unified TCI codepoint. The communications manager 920 may be configured as or otherwise support a means for receiving a first DCI message indicating a set of one or more activated TCI codepoints that are each associated with one or more TCI states. The communications manager 920 may be configured as or otherwise support a means for receiving a second DCI message indicating the selected unified TCI codepoint from the set of one or more activated TCI codepoints. The communications manager 920 may be configured as or otherwise support a means for applying a TCI state for communication of the signal in accordance with the configuration.

Additionally, or alternatively, the communications manager 920 may support wireless communications at a UE in accordance with examples as disclosed herein. For example, the communications manager 920 may be configured as or otherwise support a means for receiving a first DCI message indicating a selected unified TCI codepoint from a set of one or more activated TCI codepoints that are each associated with one or more TCI states. The communications manager 920 may be configured as or otherwise support a means for receiving a second DCI message scheduling a signal and indicating a TCI state of the selected unified TCI codepoint is associated with the signal. The communications manager 920 may be configured as or otherwise support a means for applying the TCI state for communication of the signal in accordance with the second DCI message.

Additionally, or alternatively, the communications manager 920 may support wireless communications at a UE in accordance with examples as disclosed herein. For example, the communications manager 920 may be configured as or otherwise support a means for receiving a first DCI message indicating a selected unified TCI codepoint from a set of one or more activated TCI codepoints that are each associated with one or more TCI states. The communications manager 920 may be configured as or otherwise support a means for receiving a second DCI message scheduling a signal and indicating multiple TCI states of the selected unified TCI codepoint are associated with the signal. The communications manager 920 may be configured as or otherwise support a means for applying the multiple TCI states across repetitions of the signal in accordance with a configuration.

Additionally, or alternatively, the communications manager 920 may support wireless communication at a UE in accordance with examples as disclosed herein. For example, the communications manager 920 may be configured as or otherwise support a means for receiving a first DCI message indicating a selected unified TCI codepoint from a set of one or more activated TCI codepoints that are each associated with one or more TCI states. The communications manager 920 may be configured as or otherwise support a means for receiving a second DCI message indicating a first TCI state to use for a signal, the signal being a periodic or semi-persistent signal. The communications manager 920 may be configured as or otherwise support a means for receiving a third DCI message indicating multiple TCI states of the selected unified TCI codepoint. The communications manager 920 may be configured as or otherwise support a means for determining to apply the first TCI state or the multiple TCI states to the signal in accordance with a configuration.

By including or configuring the communications manager 920 in accordance with examples as described herein, the device 905 may support techniques for improved communication reliability, reduced latency, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for configuring communications based on unified TCI states as described herein, or the processor 940 and the memory 930 may be otherwise configured to perform or support such operations.

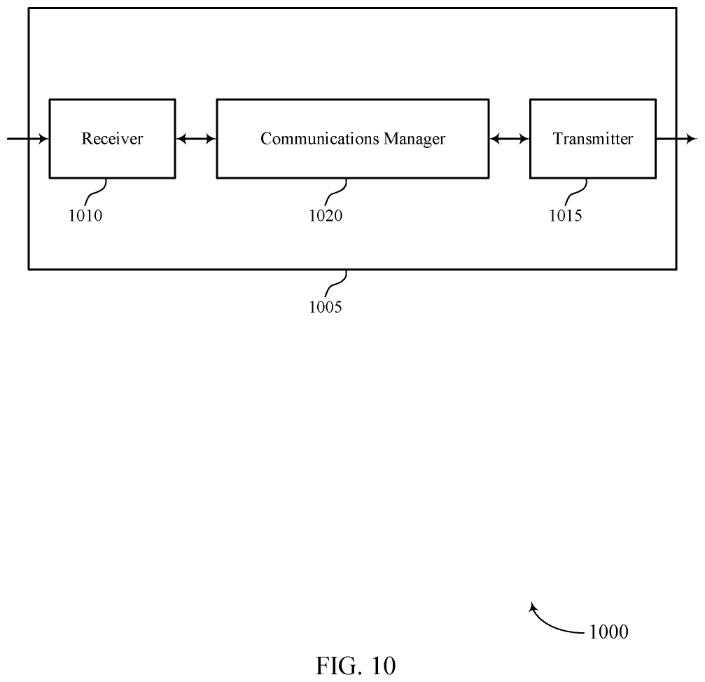

FIG. 10 shows a block diagram 1000 of a device 1005 that supports techniques for configuring communications based on unified TCI states in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for configuring communications based on unified TCI states as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting a control message indicating a configuration for a signal, where the configuration indicates whether the signal is associated with one or more unified TCI states of a selected unified TCI codepoint. The communications manager 1020 may be configured as or otherwise support a means for transmitting a first DCI message indicating a set of one or more activated TCI codepoints that are each associated with one or more TCI states. The communications manager 1020 may be configured as or otherwise support a means for transmitting a second DCI message indicating the selected unified TCI codepoint from the set of one or more activated TCI codepoints.

Additionally, or alternatively, the communications manager 1020 may support wireless communications at a network entity in accordance with examples as disclosed herein. For example, the communications manager 1020 may be configured as or otherwise support a means for transmitting a first DCI message indicating a selected unified TCI codepoint from a set of one or more activated TCI codepoints that are each associated with one or more TCI states. The communications manager 1020 may be configured as or otherwise support a means for transmitting a second DCI message scheduling a signal and indicating a TCI state of the selected unified TCI codepoint is associated with the signal.

Additionally, or alternatively, the communications manager 1020 may support wireless communications at a network entity in accordance with examples as disclosed herein. For example, the communications manager 1020 may be configured as or otherwise support a means for transmitting a first DCI message indicating a selected unified TCI codepoint from a set of one or more activated TCI codepoints that are each associated with one or more TCI states. The communications manager 1020 may be configured as or otherwise support a means for transmitting a second DCI message scheduling a signal and indicating multiple TCI states of the selected unified TCI codepoint are associated with the signal, the multiple TCI states to be applied across repetitions of the signal in accordance with a configuration.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

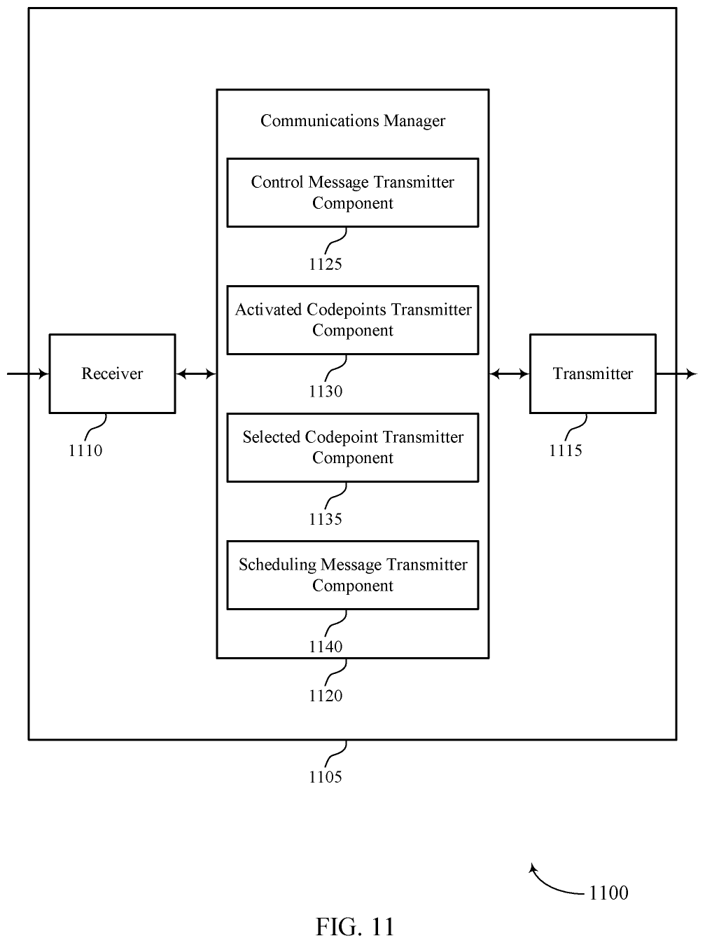

FIG. 11 shows a block diagram 1100 of a device 1105 that supports techniques for configuring communications based on unified TCI states in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for configuring communications based on unified TCI states as described herein. For example, the communications manager 1120 may include a control message transmitter component 1125, an activated codepoints transmitter component 1130, a selected codepoint transmitter component 1135, a scheduling message transmitter component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The control message transmitter component 1125 may be configured as or otherwise support a means for transmitting a control message indicating a configuration for a signal, where the configuration indicates whether the signal is associated with one or more unified TCI states of a selected unified TCI codepoint. The activated codepoints transmitter component 1130 may be configured as or otherwise support a means for transmitting a first DCI message indicating a set of one or more activated TCI codepoints that are each associated with one or more TCI states. The selected codepoint transmitter component 1135 may be configured as or otherwise support a means for transmitting a second DCI message indicating the selected unified TCI codepoint from the set of one or more activated TCI codepoints.

Additionally, or alternatively, the communications manager 1120 may support wireless communications at a network entity in accordance with examples as disclosed herein. The selected codepoint transmitter component 1135 may be configured as or otherwise support a means for transmitting a first DCI message indicating a selected unified TCI codepoint from a set of one or more activated TCI codepoints that are each associated with one or more TCI states. The scheduling message transmitter component 1140 may be configured as or otherwise support a means for transmitting a second DCI message scheduling a signal and indicating a TCI state of the selected unified TCI codepoint is associated with the signal.

Additionally, or alternatively, the communications manager 1120 may support wireless communications at a network entity in accordance with examples as disclosed herein. The selected codepoint transmitter component 1135 may be configured as or otherwise support a means for transmitting a first DCI message indicating a selected unified TCI codepoint from a set of one or more activated TCI codepoints that are each associated with one or more TCI states. The scheduling message transmitter component 1140 may be configured as or otherwise support a means for transmitting a second DCI message scheduling a signal and indicating multiple TCI states of the selected unified TCI codepoint are associated with the signal, the multiple TCI states to be applied across repetitions of the signal in accordance with a configuration.

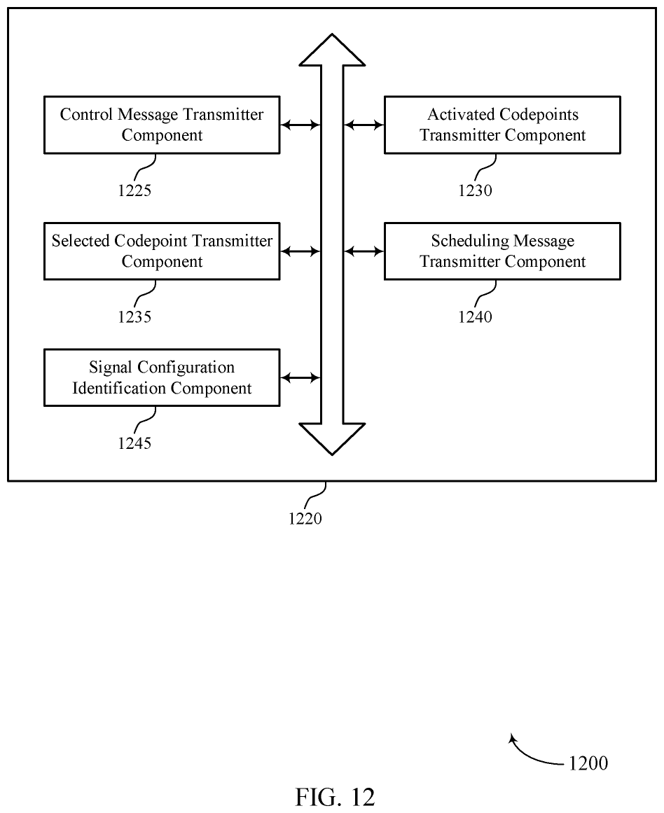

FIG. 12 shows a block diagram 1200 of a communications manager 1220 that supports techniques for configuring communications based on unified TCI states in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for configuring communications based on unified TCI states as described herein. For example, the communications manager 1220 may include a control message transmitter component 1225, an activated codepoints transmitter component 1230, a selected codepoint transmitter component 1235, a scheduling message transmitter component 1240, a signal configuration identification component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The control message transmitter component 1225 may be configured as or otherwise support a means for transmitting a control message indicating a configuration for a signal, where the configuration indicates whether the signal is associated with one or more unified TCI states of a selected unified TCI codepoint. The activated codepoints transmitter component 1230 may be configured as or otherwise support a means for transmitting a first DCI message indicating a set of one or more activated TCI codepoints that are each associated with one or more TCI states. The selected codepoint transmitter component 1235 may be configured as or otherwise support a means for transmitting a second DCI message indicating the selected unified TCI codepoint from the set of one or more activated TCI codepoints.

In some examples, to support transmitting the control message, the control message transmitter component 1225 may be configured as or otherwise support a means for identifying that an association between the signal and the one or more unified TCI states is per a control resource set or per a search space of the control resource set.

In some examples, the signal configuration identification component 1245 may be configured as or otherwise support a means for identifying that the control resource set or the search space is common to multiple UEs, where the configuration includes an indication that indicates one of a first option, a second option, a third option, or a fourth option based on the control resource set or the search space being common to multiple UEs, where the first option is that the signal is to be associated with none of the one or more unified TCI states, the second option is that the signal is to be associated with a first one of the one or more unified TCI states used for communications with a first transmission and reception point of a network entity, the third option is that the signal is to be associated with a second one of the one or more unified TCI states used for communications with a second transmission and reception point of the network entity, and the fourth option is that the signal is to be associated with both the first one and the second one of the one or more unified TCI states used for communications with both the first transmission and reception point and the second transmission and reception point of the network entity.

In some examples, the signal configuration identification component 1245 may be configured as or otherwise support a means for identifying that the control resource set or the search space is specific to the UE, where the configuration includes an indication that indicates one of a first option, a second option, or a third option based on the control resource set or the search space being specific to the UE, where the first option is that the signal is to be associated with a first one of the one or more unified TCI states used for communications with a first transmission and reception point of a network entity, the second option is that the signal is to be associated with a second one of the one or more unified TCI states used for communications with a second transmission and reception point of the network entity, and the third option is that the signal is to be associated with both the first one and the second one of the one or more unified TCI states used for communications with both the first transmission and reception point and the second transmission and reception point of the network entity.

In some examples, the signal configuration identification component 1245 may be configured as or otherwise support a means for identifying that the configuration indicates that the signal is to be associated with both a first one of the one or more unified TCI states used for communications with a first transmission and reception point of a network entity and a second one of the one or more unified TCI states used for communications with a second transmission and reception point of the network entity, where the configuration is based on a single frequency network based control resource set being enabled to include multiple TCIs.

In some examples, an order of the first one and the second one of the one or more unified TCI states indicated in the configuration is indicative of a corresponding order of transmission and reception point identifiers to be applied to the one or more unified TCI states.

In some examples, to support transmitting the control message, the control message transmitter component 1225 may be configured as or otherwise support a means for identifying that an association between the signal and the one or more unified TCI states is per a physical uplink control channel resource, a physical uplink control channel resource set, a physical uplink control channel resource group, or a combination thereof, and that the signal is associated with a physical uplink control channel.

In some examples, the signal configuration identification component 1245 may be configured as or otherwise support a means for identifying that the configuration includes an indication that indicates one of a first option, a second option, or a third option based on the signal being associated with the physical uplink control channel, where the first option is that the signal is to be associated with a first one of the one or more unified TCI states used for communications with a first transmission and reception point of a network entity, the second option is that the signal is to be associated with a second one of the one or more unified TCI states used for communications with a second transmission and reception point of the network entity, and the third option is that the signal is to be associated with both the first one and the second one of the one or more unified TCI states used for communications with both the first transmission and reception point and the second transmission and reception point of the network entity.

In some examples, the signal configuration identification component 1245 may be configured as or otherwise support a means for identifying that the association between the signal and the one or more unified TCI states is per the physical uplink control channel resource set or per the physical uplink control channel resource group, where the configuration is applicable to each physical uplink channel resource in the physical uplink control channel resource set or the physical uplink control channel resource group.

In some examples, the signal configuration identification component 1245 may be configured as or otherwise support a means for identifying that the configuration indicates that the signal is to be associated with both a first one of the one or more unified TCI states used for communications with a first transmission and reception point of a network entity and a second one of the one or more unified TCI states used for communications with a second transmission and reception point of the network entity, where individual repetitions of the physical uplink control channel are mapped to either the first transmission and reception point or the second transmission and reception point based on a configured pattern.

In some examples, to support transmitting the control message, the control message transmitter component 1225 may be configured as or otherwise support a means for identifying that an association between the signal and the one or more unified TCI states is per a reference signal resource, a reference signal resource set, or a combination thereof, and that the signal is a reference signal.

In some examples, the signal configuration identification component 1245 may be configured as or otherwise support a means for identifying that the configuration includes an indication that indicates one of a first option, a second option, or a third option based on the signal being the reference signal, where the first option is that the signal is to be associated with none of the one or more unified TCI states, the second option is that the signal is to be associated with a first one of the one or more unified TCI states used for communications with a first transmission and reception point of a network entity, and the third option is that the signal is to be associated with a second one of the one or more unified TCI states used for communications with a second transmission and reception point of the network entity.

In some examples, the signal configuration identification component 1245 may be configured as or otherwise support a means for identifying that the configuration indicates that the signal is to be associated with none of the one or more unified TCI states. In some examples, the control message transmitter component 1225 may be configured as or otherwise support a means for transmitting a dedicated control message for the signal, the dedicated control message including a dedicated TCI state assigned to the signal based on the configuration indicating that the signal is associated with none of the one or more unified TCI states.

In some examples, the signal configuration identification component 1245 may be configured as or otherwise support a means for identifying that the configuration indicates that the signal is to be associated with either a first one of the one or more unified TCI states used for communications with a first transmission and reception point of a network entity or a second one of the one or more unified TCI states used for communications with a second transmission and reception point of the network entity, where a single selected unified TCI state is applied to the reference signal in accordance with the configuration.

In some examples, the reference signal is one of a periodic, semi-persistent, or aperiodic channel state information reference signal or a sounding reference signal.

In some examples, to support transmitting the control message, the control message transmitter component 1225 may be configured as or otherwise support a means for identifying that an association between the signal and the one or more unified TCI states is per configured grant, where the configured grant is a type 1 configured grant or a type 2 configured grant.

In some examples, the signal configuration identification component 1245 may be configured as or otherwise support a means for identifying that the configuration includes an indication that indicates one of a first option or a second option based on only a single sounding reference signal resource set being associated with the configured grant, where the first option is that the signal is to be associated with a first one of the one or more unified TCI states used for communications with a first transmission and reception point of a network entity, and the second option is that the signal is to be associated with a second one of the one or more unified TCI states used for communications with a second transmission and reception point of the network entity.

In some examples, the signal configuration identification component 1245 may be configured as or otherwise support a means for identifying that the configuration includes an indication that indicates one of a first option or a second option based on at least two sounding reference signal resource sets being associated with the configured grant, the indication indicating either the first option or the second option on a per sounding reference signal resource set basis for a physical uplink shared channel transmission associated with the configured grant, where the first option is that the signal is to be associated with a first one of the one or more unified TCI states used for communications with a first transmission and reception point of a network entity, and the second option is that the signal is to be associated with a second one of the one or more unified TCI states used for communications with a second transmission and reception point of the network entity.

In some examples, one or more parameters of the physical uplink shared channel transmission are determined by a sounding reference signal resource indicator corresponding to sounding reference signal resources in a respective sounding reference signal resource set.

In some examples, the one or more parameters of the physical uplink shared channel transmission include one or more beam parameters, a transmitted precoding matrix indicator, a rank indicator, one or more power control parameters, or a combination thereof.

In some examples, the physical uplink shared channel transmission is configured for a subset of repetitions in time division multiplexing or frequency division multiplexing repetitions, or for a subset of spatial layers or antenna ports in spatial division multiplexing.

In some examples, the physical uplink shared channel transmission is indicated by a scheduling request indicator corresponding to sounding reference signal resources in a sounding reference signal resource set and is applied with a single selected unified TCI state in accordance with the single TCI order index provided by the configuration associated with the sounding reference signal resource set.

In some examples, to support transmitting the control message, the control message transmitter component 1225 may be configured as or otherwise support a means for transmitting a RRC message, a MAC-CE message, a DCI message, or a combination thereof indicating the configuration for the signal.

In some examples, the control message transmitter component 1225 may be configured as or otherwise support a means for transmitting a second control message including an updated configuration for the signal, where the second control message is a MAC-CE message, a DCI message, or both.

Additionally, or alternatively, the communications manager 1220 may support wireless communications at a network entity in accordance with examples as disclosed herein. In some examples, the selected codepoint transmitter component 1235 may be configured as or otherwise support a means for transmitting a first DCI message indicating a selected unified TCI codepoint from a set of one or more activated TCI codepoints that are each associated with one or more TCI states. The scheduling message transmitter component 1240 may be configured as or otherwise support a means for transmitting a second DCI message scheduling a signal and indicating a TCI state of the selected unified TCI codepoint is associated with the signal.

In some examples, to support transmitting the second DCI message, the scheduling message transmitter component 1240 may be configured as or otherwise support a means for transmitting the second DCI message including a transmission configuration indication codepoint from a set of transmission configuration indication codepoints, the transmission configuration indication codepoint indicative of the TCI state associated with a first network entity.

In some examples, the set of transmission configuration indication codepoints are reserved for indicating the TCI state of the signal via RRC signaling.

In some examples, to support transmitting the second DCI message, the scheduling message transmitter component 1240 may be configured as or otherwise support a means for transmitting the second DCI message including an indication of whether one or multiple transmission configuration indication states are to be applied to the signal, a rule indicative of the TCI state.

In some examples, the indication is included in a 1-bit DCI field.

In some examples, the rule is configured via RRC signaling.

In some examples, the second DCI message implicitly indicates the TCI state based on the network entity refraining to include a TCI state field in the second DCI message.

In some examples, to support transmitting the second DCI message, the scheduling message transmitter component 1240 may be configured as or otherwise support a means for transmitting the second DCI message including a sounding reference signal resource set indicator field indicative of at least one sounding reference signal resource set, the TCI state indicated by the at least one sounding reference signal resource set.

In some examples, the signal is associated with an uplink shared channel.

Additionally, or alternatively, the communications manager 1220 may support wireless communications at a network entity in accordance with examples as disclosed herein. In some examples, the selected codepoint transmitter component 1235 may be configured as or otherwise support a means for transmitting a first DCI message indicating a selected unified TCI codepoint from a set of one or more activated TCI codepoints that are each associated with one or more TCI states. In some examples, the scheduling message transmitter component 1240 may be configured as or otherwise support a means for transmitting a second DCI message scheduling a signal and indicating multiple TCI states of the selected unified TCI codepoint are associated with the signal, the multiple TCI states to be applied across repetitions of the signal in accordance with a configuration.

In some examples, an order of TCI states to be applied to the repetitions corresponds to an order of the TCI states in the selected unified TCI codepoint in accordance with the configuration.

In some examples, an order of TCI states to be applied to the repetitions corresponds to an order of network entities associated with each of the multiple TCI states of the selected unified TCI codepoint in accordance with the configuration.

In some examples, the multiple TCI states are to be applied across the repetitions in accordance with the configuration based on a communication type associated with the repetitions, the communication type including one of frequency division multiplexing, time division multiplexing, or spatial division multiplexing.

In some examples, the multiple TCI states are to be applied across the repetitions in accordance with the configuration based on a number of code division-multiplexing groups indicated in the second DCI message.

In some examples, the multiple TCI states are to be applied across the repetitions in accordance with the configuration based on a physical resource block bundling size associated with the repetitions.

In some examples, the multiple TCI states are to be applied across the repetitions in accordance with the configuration based on cyclic mapping being enabled or sequential mapping being enabled for the repetitions.

In some examples, the signal is associated with an uplink shared channel.

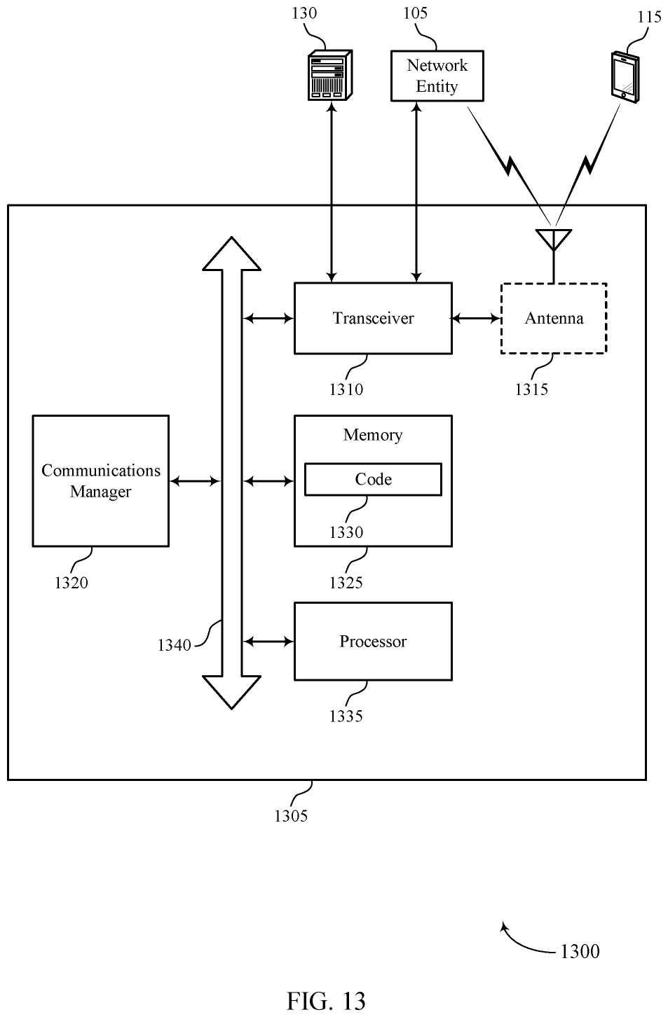

FIG. 13 shows a diagram of a system 1300 including a device 1305 that supports techniques for configuring communications based on unified TCI states in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for configuring communications based on unified TCI states). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting a control message indicating a configuration for a signal, where the configuration indicates whether the signal is associated with one or more unified TCI states of a selected unified TCI codepoint. The communications manager 1320 may be configured as or otherwise support a means for transmitting a first DCI message indicating a set of one or more activated TCI codepoints that are each associated with one or more TCI states. The communications manager 1320 may be configured as or otherwise support a means for transmitting a second DCI message indicating the selected unified TCI codepoint from the set of one or more activated TCI codepoints.

Additionally, or alternatively, the communications manager 1320 may support wireless communications at a network entity in accordance with examples as disclosed herein. For example, the communications manager 1320 may be configured as or otherwise support a means for transmitting a first DCI message indicating a selected unified TCI codepoint from a set of one or more activated TCI codepoints that are each associated with one or more TCI states. The communications manager 1320 may be configured as or otherwise support a means for transmitting a second DCI message scheduling a signal and indicating a TCI state of the selected unified TCI codepoint is associated with the signal.

Additionally, or alternatively, the communications manager 1320 may support wireless communications at a network entity in accordance with examples as disclosed herein. For example, the communications manager 1320 may be configured as or otherwise support a means for transmitting a first DCI message indicating a selected unified TCI codepoint from a set of one or more activated TCI codepoints that are each associated with one or more TCI states. The communications manager 1320 may be configured as or otherwise support a means for transmitting a second DCI message scheduling a signal and indicating multiple TCI states of the selected unified TCI codepoint are associated with the signal, the multiple TCI states to be applied across repetitions of the signal in accordance with a configuration.

By including or configuring the communications manager 1320 in accordance with examples as described herein, the device 1305 may support techniques for improved communication reliability, reduced latency, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for configuring communications based on unified TCI states as described herein, or the processor 1335 and the memory 1325 may be otherwise configured to perform or support such operations.

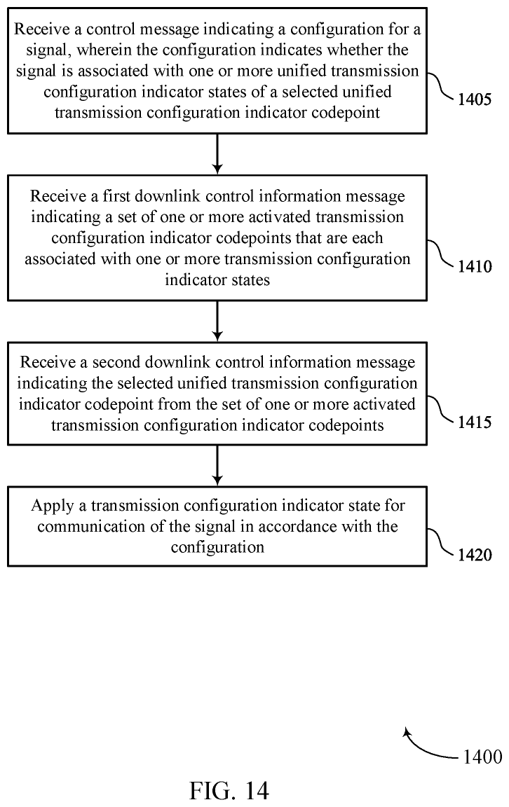

FIG. 14 shows a flowchart illustrating a method 1400 that supports techniques for configuring communications based on unified TCI states in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a configuration for a signal, where the configuration indicates whether the signal is associated with one or more unified TCI states of a selected unified TCI codepoint. The operations of 1405 may be performed in accordance with examples as disclosed herein. In some examples, aspects of the operations of 1405 may be performed by a control message receiver component 825 as described with reference to FIG. 8.

At 1410, the method may include receiving a first DCI message indicating a set of one or more activated TCI codepoints that are each associated with one or more TCI states. The operations of 1410 may be performed in accordance with examples as disclosed herein. In some examples, aspects of the operations of 1410 may be performed by an activated codepoint receiver component 830 as described with reference to FIG. 8.

At 1415, the method may include receiving a second DCI message indicating the selected unified TCI codepoint from the set of one or more activated TCI codepoints. The operations of 1415 may be performed in accordance with examples as disclosed herein. In some examples, aspects of the operations of 1415 may be performed by a selected codepoint receiver component 835 as described with reference to FIG. 8.

At 1420, the method may include applying a TCI state for communication of the signal in accordance with the configuration. The operations of 1420 may be performed in accordance with examples as disclosed herein. In some examples, aspects of the operations of 1420 may be performed by a TCI state application component 840 as described with reference to FIG. 8.

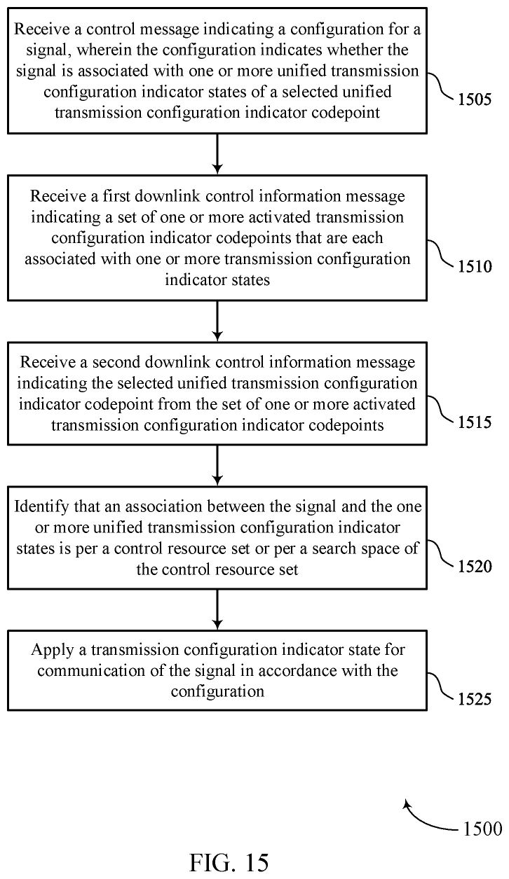

FIG. 15 shows a flowchart illustrating a method 1500 that supports techniques for configuring communications based on unified TCI states in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a configuration for a signal, where the configuration indicates whether the signal is associated with one or more unified TCI states of a selected unified TCI codepoint. The operations of 1505 may be performed in accordance with examples as disclosed herein. In some examples, aspects of the operations of 1505 may be performed by a control message receiver component 825 as described with reference to FIG. 8.

At 1510, the method may include receiving a first DCI message indicating a set of one or more activated TCI codepoints that are each associated with one or more TCI states. The operations of 1510 may be performed in accordance with examples as disclosed herein. In some examples, aspects of the operations of 1510 may be performed by an activated codepoint receiver component 830 as described with reference to FIG. 8.

At 1515, the method may include receiving a second DCI message indicating the selected unified TCI codepoint from the set of one or more activated TCI codepoints. The operations of 1515 may be performed in accordance with examples as disclosed herein. In some examples, aspects of the operations of 1515 may be performed by a selected codepoint receiver component 835 as described with reference to FIG. 8.

At 1520, the method may include identifying that an association between the signal and the one or more unified TCI states is per a control resource set or per a search space of the control resource set. The operations of 1520 may be performed in accordance with examples as disclosed herein. In some examples, aspects of the operations of 1520 may be performed by a control message receiver component 825 as described with reference to FIG. 8.

At 1525, the method may include applying a TCI state for communication of the signal in accordance with the configuration. The operations of 1525 may be performed in accordance with examples as disclosed herein. In some examples, aspects of the operations of 1525 may be performed by a TCI state application component 840 as described with reference to FIG. 8.

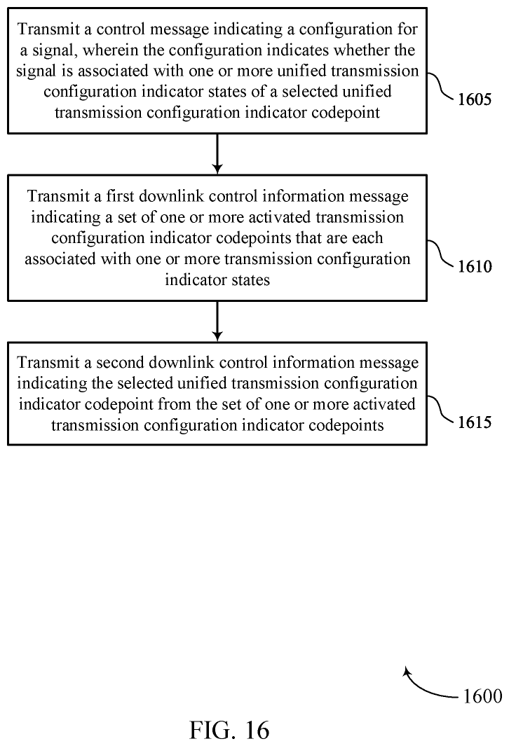

FIG. 16 shows a flowchart illustrating a method 1600 that supports techniques for configuring communications based on unified TCI states in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating a configuration for a signal, where the configuration indicates whether the signal is associated with one or more unified TCI states of a selected unified TCI codepoint. The operations of 1605 may be performed in accordance with examples as disclosed herein. In some examples, aspects of the operations of 1605 may be performed by a control message transmitter component 1225 as described with reference to FIG. 12.

At 1610, the method may include transmitting a first DCI message indicating a set of one or more activated TCI codepoints that are each associated with one or more TCI states. The operations of 1610 may be performed in accordance with examples as disclosed herein. In some examples, aspects of the operations of 1610 may be performed by an activated codepoints transmitter component 1230 as described with reference to FIG. 12.

At 1615, the method may include transmitting a second DCI message indicating the selected unified TCI codepoint from the set of one or more activated TCI codepoints. The operations of 1615 may be performed in accordance with examples as disclosed herein. In some examples, aspects of the operations of 1615 may be performed by a selected codepoint transmitter component 1235 as described with reference to FIG. 12.

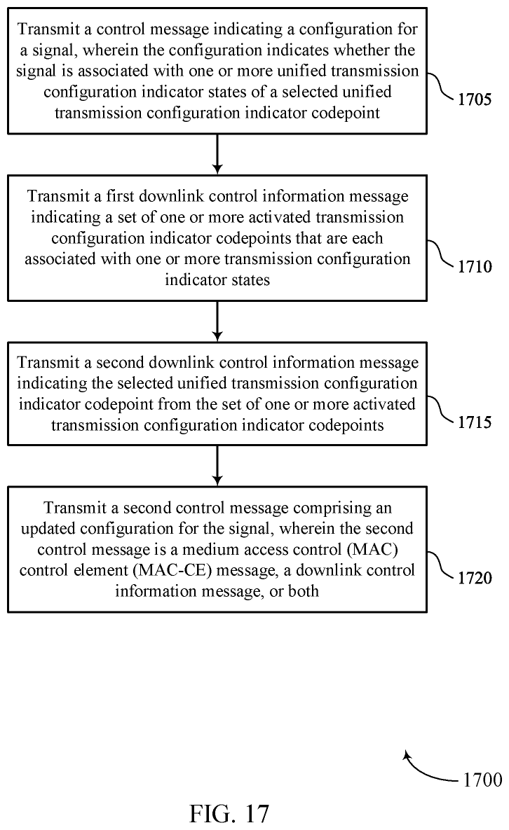

FIG. 17 shows a flowchart illustrating a method 1700 that supports techniques for configuring communications based on unified TCI states in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message indicating a configuration for a signal, where the configuration indicates whether the signal is associated with one or more unified TCI states of a selected unified TCI codepoint. The operations of 1705 may be performed in accordance with examples as disclosed herein. In some examples, aspects of the operations of 1705 may be performed by a control message transmitter component 1225 as described with reference to FIG. 12.

At 1710, the method may include transmitting a first DCI message indicating a set of one or more activated TCI codepoints that are each associated with one or more TCI states. The operations of 1710 may be performed in accordance with examples as disclosed herein. In some examples, aspects of the operations of 1710 may be performed by an activated codepoints transmitter component 1230 as described with reference to FIG. 12.

At 1715, the method may include transmitting a second DCI message indicating the selected unified TCI codepoint from the set of one or more activated TCI codepoints. The operations of 1715 may be performed in accordance with examples as disclosed herein. In some examples, aspects of the operations of 1715 may be performed by a selected codepoint transmitter component 1235 as described with reference to FIG. 12.

At 1720, the method may include transmitting a second control message including an updated configuration for the signal, where the second control message is a MAC-CE message, a DCI message, or both. The operations of 1720 may be performed in accordance with examples as disclosed herein. In some examples, aspects of the operations of 1720 may be performed by a control message transmitter component 1225 as described with reference to FIG. 12.

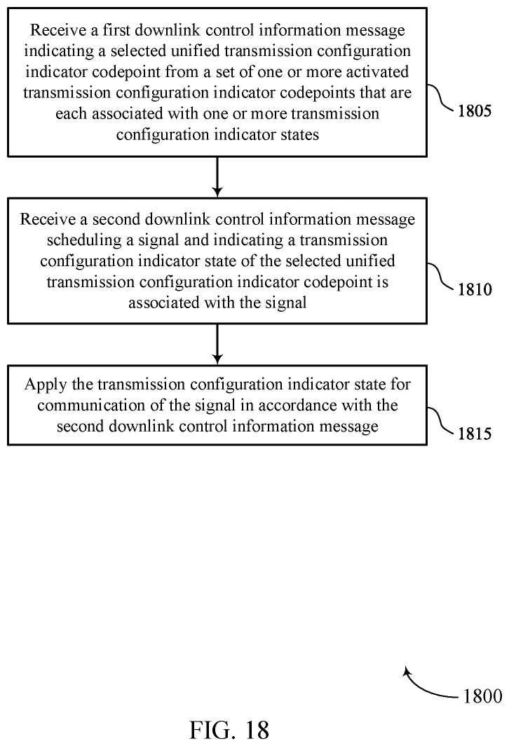

FIG. 18 shows a flowchart illustrating a method 1800 that supports techniques for configuring communications based on unified TCI states in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving a first DCI message indicating a selected unified TCI codepoint from a set of one or more activated TCI codepoints that are each associated with one or more TCI states. The operations of 1805 may be performed in accordance with examples as disclosed herein. In some examples, aspects of the operations of 1805 may be performed by a selected codepoint receiver component 835 as described with reference to FIG. 8.

At 1810, the method may include receiving a second DCI message scheduling a signal and indicating a TCI state of the selected unified TCI codepoint is associated with the signal. The operations of 1810 may be performed in accordance with examples as disclosed herein. In some examples, aspects of the operations of 1810 may be performed by a scheduling message receiver component 845 as described with reference to FIG. 8.

At 1815, the method may include applying the TCI state for communication of the signal in accordance with the second DCI message. The operations of 1815 may be performed in accordance with examples as disclosed herein. In some examples, aspects of the operations of 1815 may be performed by a TCI state application component 840 as described with reference to FIG. 8.

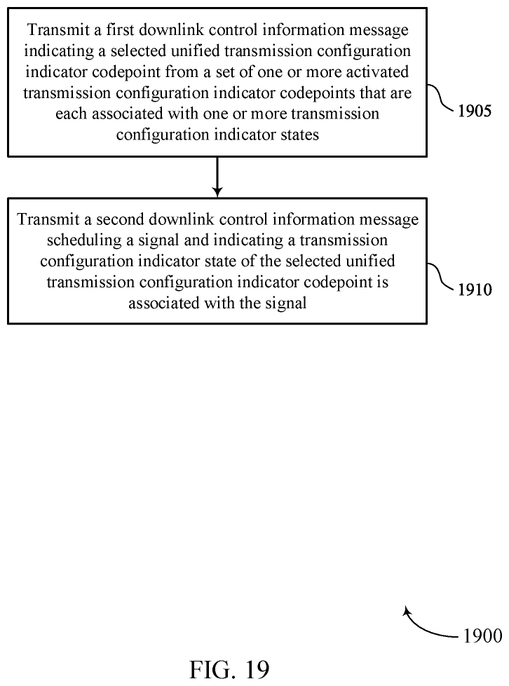

FIG. 19 shows a flowchart illustrating a method 1900 that supports techniques for configuring communications based on unified TCI states in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first DCI message indicating a selected unified TCI codepoint from a set of one or more activated TCI codepoints that are each associated with one or more TCI states. The operations of 1905 may be performed in accordance with examples as disclosed herein. In some examples, aspects of the operations of 1905 may be performed by a selected codepoint transmitter component 1235 as described with reference to FIG. 12.

At 1910, the method may include transmitting a second DCI message scheduling a signal and indicating a TCI state of the selected unified TCI codepoint is associated with the signal. The operations of 1910 may be performed in accordance with examples as disclosed herein. In some examples, aspects of the operations of 1910 may be performed by a scheduling message transmitter component 1240 as described with reference to FIG. 12.

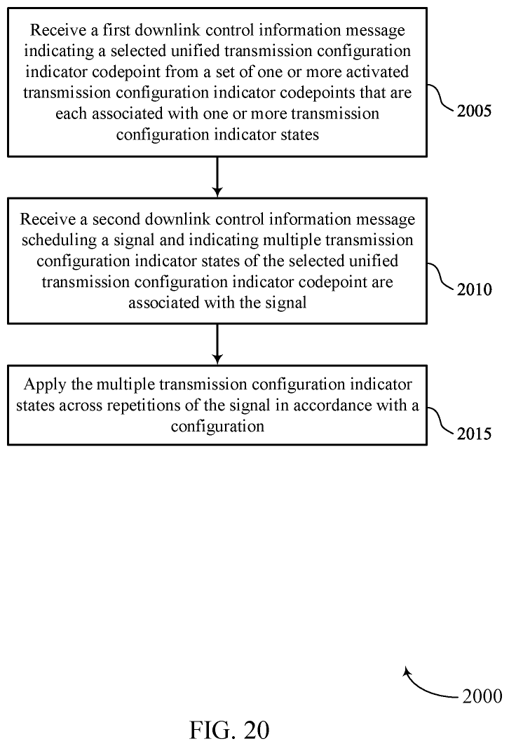

FIG. 20 shows a flowchart illustrating a method 2000 that supports techniques for configuring communications based on unified TCI states in accordance with one or more aspects of the present disclosure. The operations of the method 2000 may be implemented by a UE or its components as described herein. For example, the operations of the method 2000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 2005, the method may include receiving a first DCI message indicating a selected unified TCI codepoint from a set of one or more activated TCI codepoints that are each associated with one or more TCI states. The operations of 2005 may be performed in accordance with examples as disclosed herein. In some examples, aspects of the operations of 2005 may be performed by a selected codepoint receiver component 835 as described with reference to FIG. 8.

At 2010, the method may include receiving a second DCI message scheduling a signal and indicating multiple TCI states of the selected unified TCI codepoint are associated with the signal. The operations of 2010 may be performed in accordance with examples as disclosed herein. In some examples, aspects of the operations of 2010 may be performed by a scheduling message receiver component 845 as described with reference to FIG. 8.

At 2015, the method may include applying the multiple TCI states across repetitions of the signal in accordance with a configuration. The operations of 2015 may be performed in accordance with examples as disclosed herein. In some examples, aspects of the operations of 2015 may be performed by a multiple configuration states application component 850 as described with reference to FIG. 8.

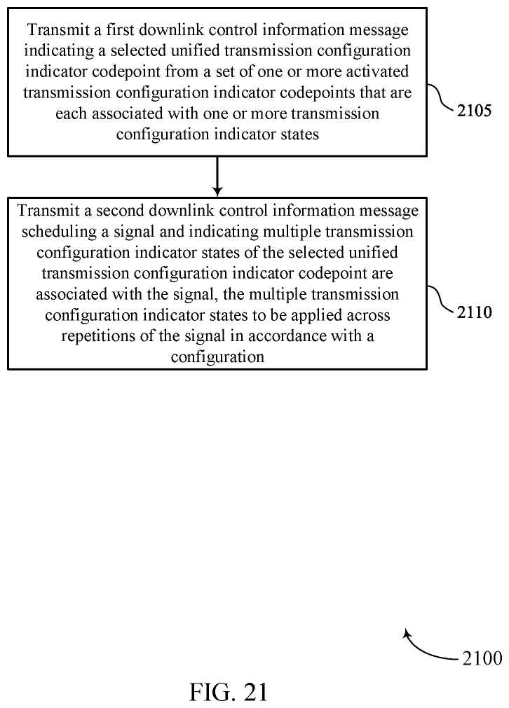

FIG. 21 shows a flowchart illustrating a method 2100 that supports techniques for configuring communications based on unified TCI states in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include transmitting a first DCI message indicating a selected unified TCI codepoint from a set of one or more activated TCI codepoints that are each associated with one or more TCI states. The operations of 2105 may be performed in accordance with examples as disclosed herein. In some examples, aspects of the operations of 2105 may be performed by a selected codepoint transmitter component 1235 as described with reference to FIG. 12.

At 2110, the method may include transmitting a second DCI message scheduling a signal and indicating multiple TCI states of the selected unified TCI codepoint are associated with the signal, the multiple TCI states to be applied across repetitions of the signal in accordance with a configuration. The operations of 2110 may be performed in accordance with examples as disclosed herein. In some examples, aspects of the operations of 2110 may be performed by a scheduling message transmitter component 1240 as described with reference to FIG. 12.

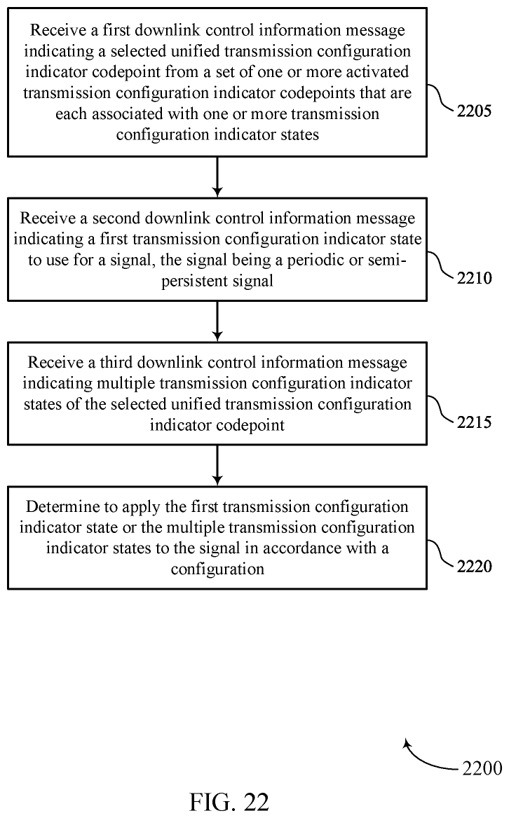

FIG. 22 shows a flowchart illustrating a method 2200 that supports techniques for configuring communications based on unified TCI states in accordance with one or more aspects of the present disclosure. The operations of the method 2200 may be implemented by a UE or its components as described herein. For example, the operations of the method 2200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 2205, the method may include receiving a first DCI message indicating a selected unified TCI codepoint from a set of one or more activated TCI codepoints that are each associated with one or more TCI states. The operations of 2205 may be performed in accordance with examples as disclosed herein. In some examples, aspects of the operations of 2205 may be performed by a selected codepoint receiver component 835 as described with reference to FIG. 8.

At 2210, the method may include receiving a second DCI message indicating a first TCI state to use for a signal, the signal being a periodic or semi-persistent signal. The operations of 2210 may be performed in accordance with examples as disclosed herein. In some examples, aspects of the operations of 2210 may be performed by a scheduling message receiver component 845 as described with reference to FIG. 8.

At 2215, the method may include receiving a third DCI message indicating multiple TCI states of the selected unified TCI codepoint. The operations of 2215 may be performed in accordance with examples as disclosed herein. In some examples, aspects of the operations of 2215 may be performed by a TCI state indication component 855 as described with reference to FIG. 8.

At 2220, the method may include determining to apply the first TCI state or the multiple TCI states to the signal in accordance with a configuration. The operations of 2220 may be performed in accordance with examples as disclosed herein. In some examples, aspects of the operations of 2220 may be performed by a TCI state determination component 860 as described with reference to FIG. 8.

The following provides an overview of aspects of the present disclosure:
Aspect 1: A method for wireless communications at a UE, comprising: receiving a control message indicating a configuration for a signal, wherein the configuration indicates whether the signal is associated with one or more unified transmission configuration indicator states of a selected unified transmission configuration indicator codepoint; receiving a first downlink control information message indicating a set of one or more activated transmission configuration indicator codepoints that are each associated with one or more transmission configuration indicator states; receiving a second downlink control information message indicating the selected unified transmission configuration indicator codepoint from the set of one or more activated transmission configuration indicator codepoints; and applying a transmission configuration indicator state for communication of the signal in accordance with the configuration.
Aspect 2: The method of aspect 1, wherein receiving the control message further comprises: identifying that an association between the signal and the one or more unified transmission configuration indicator states is per a control resource set or per a search space of the control resource set.
Aspect 3: The method of aspect 2, further comprising: identifying that the control resource set or the search space is common to multiple UEs, wherein the configuration includes an indication that indicates one of a first option, a second option, a third option, or a fourth option based at least in part on the control resource set or the search space being common to multiple UEs, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, the third option is that the signal is to be associated with a second one of the one or more unified transmission configuration indicator states used for communications with a second transmission and reception point of the network entity, and the fourth option is that the signal is to be associated with both the first one and the second one of the one or more unified transmission configuration indicator states used for communications with both the first transmission and reception point and the second transmission reception point of the network entity.
Aspect 4: The method of any of aspects 2 through 3, further comprising: identifying that the control resource set or the search space is specific to the UE, wherein the configuration includes an indication that indicates one of a first option, a second option, or a third option based at least in part on the control resource set or the search space being specific to the UE, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission reception point of the network entity.
Aspect 5: The method of any of aspects 2 through 4, further comprising: identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein the configuration is based at least in part on a single frequency network based control resource set being enabled to comprise multiple transmission configuration indicators.
Aspect 6: The method of aspect 5, wherein an order of the first one and the second one of the one or more unified transmission configuration indicator states indicated in the configuration is indicative of a corresponding order of transmission and reception point identifiers to be applied to the one or more unified transmission configuration indicator states.
Aspect 7: The method of any of aspects 1 through 6, wherein receiving the control message further comprises: identifying that an association between the signal and the one or more unified transmission configuration indicator states is per a physical uplink control channel resource, a physical uplink control channel resource set, a physical uplink control channel resource group, or a combination thereof, and that the signal is associated with a physical uplink control channel.
Aspect 8: The method of aspect 7, further comprising: identifying that the configuration includes an indication that indicates one of a first option, a second option, or a third option based at least in part on the signal being associated with the physical uplink control channel, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission reception point of the network entity.
Aspect 9: The method of aspect 8, further comprising: identifying that the association between the signal and the one or more unified transmission configuration indicator states is per the physical uplink control channel resource set or per the physical uplink control channel resource group, wherein the configuration is applicable to each physical uplink channel resource in the physical uplink control channel resource set or the physical uplink control channel resource group.
Aspect 10: The method of any of aspects 7 through 9, further comprising: identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein individual repetitions of the physical uplink control channel are mapped to either the first transmission and reception point or the second transmission and reception point based at least in part on a configured pattern.
Aspect 11: The method of any of aspects 1 through 10, wherein receiving the control message further comprises: identifying that an association between the signal and the one or more unified transmission configuration indicator states is per a reference signal resource, a reference signal resource set, or a combination thereof, and that the signal is a reference signal.
Aspect 12: The method of aspect 11, further comprising: identifying that the configuration includes an indication that indicates one of a first option, a second option, or a third option based at least in part on the signal being the reference signal, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, and the third option is that the signal is to be associated with a second one of the one or more unified transmission configuration indicator states used for communications with a second transmission and reception point of the network entity.
Aspect 13: The method of any of aspects 11 through 12, further comprising: identifying that the configuration indicates that the signal is to be associated with none of the one or more unified transmission configuration indicator states; and receiving a dedicated control message for the signal, the dedicated control message comprising a dedicated transmission configuration indicator state assigned to the signal based at least in part on the configuration indicating that the signal is associated with none of the one or more unified transmission configuration indicator states.
Aspect 14: The method of any of aspects 11 through 13, further comprising: identifying that the configuration indicates that the signal is to be associated with either a first one of the one or more unified transmission configuration indicator states used for communications with a first transmission and reception point of a network entity or a second one of the one or more unified transmission configuration indicator states used for communications with a second transmission and reception point of the network entity, wherein a single selected unified transmission configuration indicator state is applied to the reference signal in accordance with the configuration.
Aspect 15: The method of any of aspects 11 through 14, wherein the reference signal is one of a periodic, semi-persistent, or aperiodic channel state information reference signal or a sounding reference signal.
Aspect 16: The method of any of aspects 1 through 15, wherein receiving the control message further comprises: identifying that an association between the signal and the one or more unified transmission configuration indicator states is per configured grant, wherein the configured grant is a type 1 configured grant or a type 2 configured grant.
Aspect 17: The method of aspect 16, further comprising: identifying that the configuration includes an indication that indicates one of a first option or a second option based at least in part on only a single sounding reference signal resource set being associated with the configured grant, wherein the first option is that the signal is to be associated with a first one of the one or more unified transmission configuration indicator states used for communications with a first transmission and reception point of a network entity, and the second option is that the signal is to be associated with a second one of the one or more unified transmission configuration indicator states used for communications with a second transmission and reception point of the network entity.
Aspect 18: The method of any of aspects 16 through 17, further comprising: identifying that the configuration includes an indication that indicates one of a first option or a second option based at least in part on at least two sounding reference signal resource sets being associated with the configured grant, the indication indicating either the first option or the second option on a per sounding reference signal resource set basis for a physical uplink shared channel transmission associated with the configured grant, wherein the first option is that the signal is to be associated with a first one of the one or more unified transmission configuration indicator states used for communications with a first transmission and reception point of a network entity, and the second option is that the signal is to be associated with a second one of the one or more unified transmission configuration indicator states used for communications with a second transmission and reception point of the network entity.
Aspect 19: The method of aspect 18, wherein one or more parameters of the physical uplink shared channel transmission are determined by a sounding reference signal resource indicator corresponding to sounding reference signal resources in a respective sounding reference signal resource set.
Aspect 20: The method of aspect 19, wherein the one or more parameters of the physical uplink shared channel transmission comprise one or more beam parameters, a transmitted precoding matrix indicator, a rank indicator, one or more power control parameters, or a combination thereof.
Aspect 21: The method of any of aspects 19 through 20, wherein the physical uplink shared channel transmission is configured for a subset of repetitions in time division multiplexing or frequency division multiplexing repetitions, or for a subset of spatial layers or antenna ports in spatial division multiplexing.
Aspect 22: The method of any of aspects 19 through 21, wherein the physical uplink shared channel transmission is indicated by a scheduling request indicator corresponding to sounding reference signal resources in a sounding reference signal resource set and is applied with a single selected unified transmission configuration indicator state in accordance with the single transmission configuration indicator order index provided by the configuration associated with the sounding reference signal resource set.
Aspect 23: The method of any of aspects 1 through 22, wherein receiving the control message further comprises: receiving a radio resource control message, a medium access control (MAC) control element (MAC-CE) message, a downlink control information message, or a combination thereof indicating the configuration for the signal.
Aspect 24: The method of any of aspects 1 through 23, further comprising: receiving a second control message comprising an updated configuration for the signal, wherein the second control message is a medium access control (MAC) control element (MAC-CE) message, a downlink control information message, or both.
Aspect 25: A method for wireless communications at a network entity, comprising: transmitting a control message indicating a configuration for a signal, wherein the configuration indicates whether the signal is associated with one or more unified transmission configuration indicator states of a selected unified transmission configuration indicator codepoint; transmitting a first downlink control information message indicating a set of one or more activated transmission configuration indicator codepoints that are each associated with one or more transmission configuration indicator states; and transmitting a second downlink control information message indicating the selected unified transmission configuration indicator codepoint from the set of one or more activated transmission configuration indicator codepoints.
Aspect 26: The method of aspect 25, wherein transmitting the control message further comprises: identifying that an association between the signal and the one or more unified transmission configuration indicator states is per a control resource set or per a search space of the control resource set.
Aspect 27: The method of aspect 26, further comprising: identifying that the control resource set or the search space is common to multiple UEs, wherein the configuration includes an indication that indicates one of a first option, a second option, a third option, or a fourth option based at least in part on the control resource set or the search space being common to multiple UEs, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, the third option is that the signal is to be associated with a second one of the one or more unified transmission configuration indicator states used for communications with a second transmission and reception point of the network entity, and the fourth option is that the signal is to be associated with both the first one and the second one of the one or more unified transmission configuration indicator states used for communications with both the first transmission and reception point and the second transmission reception point of the network entity.
Aspect 28: The method of any of aspects 26 through 27, further comprising: identifying that the control resource set or the search space is specific to the UE, wherein the configuration includes an indication that indicates one of a first option, a second option, or a third option based at least in part on the control resource set or the search space being specific to the UE, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission reception point of the network entity.
Aspect 29: The method of any of aspects 26 through 28, further comprising: identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein the configuration is based at least in part on a single frequency network based control resource set being enabled to comprise multiple transmission configuration indicators.
Aspect 30: The method of aspect 29, wherein an order of the first one and the second one of the one or more unified transmission configuration indicator states indicated in the configuration is indicative of a corresponding order of transmission and reception point identifiers to be applied to the one or more unified transmission configuration indicator states.
Aspect 31: The method of any of aspects 25 through 30, wherein transmitting the control message further comprises: identifying that an association between the signal and the one or more unified transmission configuration indicator states is per a physical uplink control channel resource, a physical uplink control channel resource set, a physical uplink control channel resource group, or a combination thereof, and that the signal is associated with a physical uplink control channel.
Aspect 32: The method of aspect 31, further comprising: identifying that the configuration includes an indication that indicates one of a first option, a second option, or a third option based at least in part on the signal being associated with the physical uplink control channel, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission reception point of the network entity.
Aspect 33: The method of aspect 32, further comprising: identifying that the association between the signal and the one or more unified transmission configuration indicator states is per the physical uplink control channel resource set or per the physical uplink control channel resource group, wherein the configuration is applicable to each physical uplink channel resource in the physical uplink control channel resource set or the physical uplink control channel resource group.
Aspect 34: The method of any of aspects 31 through 33, further comprising: identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein individual repetitions of the physical uplink control channel are mapped to either the first transmission and reception point or the second transmission and reception point based at least in part on a configured pattern.
Aspect 35: The method of any of aspects 25 through 34, wherein transmitting the control message further comprises: identifying that an association between the signal and the one or more unified transmission configuration indicator states is per a reference signal resource, a reference signal resource set, or a combination thereof, and that the signal is a reference signal.
Aspect 36: The method of aspect 35, further comprising: identifying that the configuration includes an indication that indicates one of a first option, a second option, or a third option based at least in part on the signal being the reference signal, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, and the third option is that the signal is to be associated with a second one of the one or more unified transmission configuration indicator states used for communications with a second transmission and reception point of the network entity.
Aspect 37: The method of any of aspects 35 through 36, further comprising: identifying that the configuration indicates that the signal is to be associated with none of the one or more unified transmission configuration indicator states; and transmitting a dedicated control message for the signal, the dedicated control message comprising a dedicated transmission configuration indicator state assigned to the signal based at least in part on the configuration indicating that the signal is associated with none of the one or more unified transmission configuration indicator states.
Aspect 38: The method of any of aspects 35 through 37, further comprising: identifying that the configuration indicates that the signal is to be associated with either a first one of the one or more unified transmission configuration indicator states used for communications with a first transmission and reception point of a network entity or a second one of the one or more unified transmission configuration indicator states used for communications with a second transmission and reception point of the network entity, wherein a single selected unified transmission configuration indicator state is applied to the reference signal in accordance with the configuration.
Aspect 39: The method of any of aspects 35 through 38, wherein the reference signal is one of a periodic, semi-persistent, or aperiodic channel state information reference signal or a sounding reference signal.
Aspect 40: The method of any of aspects 25 through 39, wherein transmitting the control message further comprises: identifying that an association between the signal and the one or more unified transmission configuration indicator states is per configured grant, wherein the configured grant is a type 1 configured grant or a type 2 configured grant.
Aspect 41: The method of aspect 40, further comprising: identifying that the configuration includes an indication that indicates one of a first option or a second option based at least in part on only a single sounding reference signal resource set being associated with the configured grant, wherein the first option is that the signal is to be associated with a first one of the one or more unified transmission configuration indicator states used for communications with a first transmission and reception point of a network entity, and the second option is that the signal is to be associated with a second one of the one or more unified transmission configuration indicator states used for communications with a second transmission and reception point of the network entity.
Aspect 42: The method of any of aspects 40 through 41, further comprising: identifying that the configuration includes an indication that indicates one of a first option or a second option based at least in part on at least two sounding reference signal resource sets being associated with the configured grant, the indication indicating either the first option or the second option on a per sounding reference signal resource set basis for a physical uplink shared channel transmission associated with the configured grant, wherein the first option is that the signal is to be associated with a first one of the one or more unified transmission configuration indicator states used for communications with a first transmission and reception point of a network entity, and the second option is that the signal is to be associated with a second one of the one or more unified transmission configuration indicator states used for communications with a second transmission and reception point of the network entity.
Aspect 43: The method of aspect 42, wherein one or more parameters of the physical uplink shared channel transmission are determined by a sounding reference signal resource indicator corresponding to sounding reference signal resources in a respective sounding reference signal resource set.
Aspect 44: The method of aspect 43, wherein the one or more parameters of the physical uplink shared channel transmission comprise one or more beam parameters, a transmitted precoding matrix indicator, a rank indicator, one or more power control parameters, or a combination thereof.
Aspect 45: The method of any of aspects 43 through 44, wherein the physical uplink shared channel transmission is configured for a subset of repetitions in time division multiplexing or frequency division multiplexing repetitions, or for a subset of spatial layers or antenna ports in spatial division multiplexing.
Aspect 46: The method of any of aspects 43 through 45, wherein the physical uplink shared channel transmission is indicated by a scheduling request indicator corresponding to sounding reference signal resources in a sounding reference signal resource set and is applied with a single selected unified transmission configuration indicator state in accordance with the single transmission configuration indicator order index provided by the configuration associated with the sounding reference signal resource set.
Aspect 47: The method of any of aspects 25 through 46, wherein transmitting the control message further comprises: transmitting a radio resource control message, a medium access control (MAC) control element (MAC-CE) message, a downlink control information message, or a combination thereof indicating the configuration for the signal.
Aspect 48: The method of any of aspects 25 through 47, further comprising: transmitting a second control message comprising an updated configuration for the signal, wherein the second control message is a medium access control (MAC) control element (MAC-CE) message, a downlink control information message, or both.
Aspect 49: A method for wireless communications at a UE, comprising: receiving a first downlink control information message indicating a selected unified transmission configuration indicator codepoint from a set of one or more activated transmission configuration indicator codepoints that are each associated with one or more transmission configuration indicator states; receiving a second downlink control information message scheduling a signal and indicating a transmission configuration indicator state of the selected unified transmission configuration indicator codepoint is associated with the signal; and applying the transmission configuration indicator state for communication of the signal in accordance with the second downlink control information message.
Aspect 50: The method of aspect 49, wherein receiving the second downlink control information message further comprises: receiving the second downlink control information message comprising a transmission configuration indication codepoint from a set of transmission configuration indication codepoints, the transmission configuration indication codepoint indicative of the transmission configuration indicator state associated with a first network entity.
Aspect 51: The method of aspect 50, wherein the set of transmission configuration indication codepoints are reserved for indicating the transmission configuration indicator state of the signal via radio resource control signaling.
Aspect 52: The method of any of aspects 49 through 51, wherein receiving the second downlink control information message further comprises: receiving the second downlink control information message comprising an indication of whether one or multiple transmission configuration indication states are to be applied to the signal; and identifying the transmission configuration indicator state in accordance with a rule based at least in part on the indication.
Aspect 53: The method of aspect 52, wherein the indication is included in a 1-bit downlink control information field.
Aspect 54: The method of any of aspects 52 through 53, wherein the rule is configured via radio resource control signaling.
Aspect 55: The method of any of aspects 49 through 54, wherein the second downlink control information message implicitly indicates the transmission configuration indicator state, the UE identifies the transmission configuration indicator state based at least in part on the second downlink control information message refraining to include a transmission configuration indicator state field.
Aspect 56: The method of any of aspects 49 through 55, wherein receiving the second downlink control information message further comprises: receiving the second downlink control information message comprising a sounding reference signal resource set indicator field indicative of at least one sounding reference signal resource set, the transmission configuration indicator state indicated by the at least one sounding reference signal resource set.
Aspect 57: The method of aspect 56, wherein the second downlink control information message indicates two sounding reference signal resource sets, each sounding reference signal resource set associated with a network entity, the method further comprising: identifying a first transmission configuration indicator state from the selected unified transmission configuration indicator codepoint associated with a first network entity, and a second transmission configuration indicator state from the selected unified transmission configuration indicator codepoint associated with a second network entity; and applying the first transmission configuration indicator state and the second transmission configuration indicator state to uplink shared channel repetitions or demodulation reference signal port groups based at least in part on a network entity associated with each repetition or each port group.
Aspect 58: The method of any of aspects 56 through 57, wherein the second downlink control information message indicates one sounding reference signal resource set, the one sounding reference signal resource set associated with a network entity, the method further comprising: identifying the transmission configuration indicator state from the selected unified transmission configuration indicator codepoint that is associated with the network entity.
Aspect 59: The method of any of aspects 56 through 58, wherein the signal is associated with an uplink shared channel.
Aspect 60: A method for wireless communications at a network entity, comprising: transmitting a first downlink control information message indicating a selected unified transmission configuration indicator codepoint from a set of one or more activated transmission configuration indicator codepoints that are each associated with one or more transmission configuration indicator states; and transmitting a second downlink control information message scheduling a signal and indicating a transmission configuration indicator state of the selected unified transmission configuration indicator codepoint is associated with the signal.
Aspect 61: The method of aspect 60, wherein transmitting the second downlink control information message further comprises: transmitting the second downlink control information message comprising a transmission configuration indication codepoint from a set of transmission configuration indication codepoints, the transmission configuration indication codepoint indicative of the transmission configuration indicator state associated with a first network entity.
Aspect 62: The method of aspect 61, wherein the set of transmission configuration indication codepoints are reserved for indicating the transmission configuration indicator state of the signal via radio resource control signaling.
Aspect 63: The method of any of aspects 60 through 62, wherein transmitting the second downlink control information message further comprises: transmitting the second downlink control information message comprising an indication of whether one or multiple transmission configuration indication states are to be applied to the signal, a rule indicative of the transmission configuration indicator state.
Aspect 64: The method of aspect 63, wherein the indication is included in a 1-bit downlink control information field.
Aspect 65: The method of any of aspects 63 through 64, wherein the rule is configured via radio resource control signaling.
Aspect 66: The method of any of aspects 60 through 65, wherein the second downlink control information message implicitly indicates the transmission configuration indicator state based at least in part on the network entity refraining to include a transmission configuration indicator state field in the second downlink control information message.
Aspect 67: The method of any of aspects 60 through 66, wherein transmitting the second downlink control information message further comprises: transmitting the second downlink control information message comprising a sounding reference signal resource set indicator field indicative of at least one sounding reference signal resource set, the transmission configuration indicator state indicated by the at least one sounding reference signal resource set.
Aspect 68: The method of aspect 67, wherein the signal is associated with an uplink shared channel.
Aspect 69: A method for wireless communications at a UE, comprising: receiving a first downlink control information message indicating a selected unified transmission configuration indicator codepoint from a set of one or more activated transmission configuration indicator codepoints that are each associated with one or more transmission configuration indicator states; receiving a second downlink control information message scheduling a signal and indicating multiple transmission configuration indicator states of the selected unified transmission configuration indicator codepoint are associated with the signal; and applying the multiple transmission configuration indicator states across repetitions of the signal in accordance with a configuration.
Aspect 70: The method of aspect 69, wherein an order of transmission configuration indicator states applied to the repetitions corresponds to an order of the transmission configuration indicator states in the selected unified transmission configuration indicator codepoint in accordance with the configuration.
Aspect 71: The method of any of aspects 69 through 70, wherein an order of transmission configuration indicator states applied to the repetitions corresponds to an order of network entities associated with each of the multiple transmission configuration indicator states of the selected unified transmission configuration indicator codepoint in accordance with the configuration.
Aspect 72: The method of any of aspects 69 through 71, wherein the multiple transmission configuration indicator states are applied across the repetitions based at least in part on a communication type associated with the repetitions in accordance with the configuration, the communication type comprising one of frequency division multiplexing, time division multiplexing, or spatial division multiplexing.
Aspect 73: The method of any of aspects 69 through 72, wherein the multiple transmission configuration indicator states are applied across the repetitions in accordance with the configuration based at least in part on a number of code division-multiplexing groups indicated in the second downlink control information message.
Aspect 74: The method of any of aspects 69 through 73, wherein the multiple transmission configuration indicator states are applied across the repetitions in accordance with the configuration based at least in part on a physical resource block bundling size associated with the repetitions.
Aspect 75: The method of any of aspects 69 through 74, wherein the multiple transmission configuration indicator states are applied across the repetitions in accordance with the configuration based at least in part on cyclic mapping being enabled or sequential mapping being enabled for the repetitions.
Aspect 76: The method of any of aspects 69 through 75, wherein the signal is associated with an uplink shared channel.
Aspect 77: A method for wireless communications at a network entity, comprising: transmitting a first downlink control information message indicating a selected unified transmission configuration indicator codepoint from a set of one or more activated transmission configuration indicator codepoints that are each associated with one or more transmission configuration indicator states; and transmitting a second downlink control information message scheduling a signal and indicating multiple transmission configuration indicator states of the selected unified transmission configuration indicator codepoint are associated with the signal, the multiple transmission configuration indicator states to be applied across repetitions of the signal in accordance with a configuration.
Aspect 78: The method of aspect 77, wherein an order of transmission configuration indicator states to be applied to the repetitions corresponds to an order of the transmission configuration indicator states in the selected unified transmission configuration indicator codepoint in accordance with the configuration.
Aspect 79: The method of any of aspects 77 through 78, wherein an order of transmission configuration indicator states to be applied to the repetitions corresponds to an order of network entities associated with each of the multiple transmission configuration indicator states of the selected unified transmission configuration indicator codepoint in accordance with the configuration.
Aspect 80: The method of any of aspects 77 through 79, wherein the multiple transmission configuration indicator states are to be applied across the repetitions in accordance with the configuration based at least in part on a communication type associated with the repetitions, the communication type comprising one of frequency division multiplexing, time division multiplexing, or spatial division multiplexing.
Aspect 81: The method of any of aspects 77 through 80, wherein the multiple transmission configuration indicator states are to be applied across the repetitions in accordance with the configuration based at least in part on a number of code division-multiplexing groups indicated in the second downlink control information message.
Aspect 82: The method of any of aspects 77 through 81, wherein the multiple transmission configuration indicator states are to be applied across the repetitions in accordance with the configuration based at least in part on a physical resource block bundling size associated with the repetitions.
Aspect 83: The method of any of aspects 77 through 82, wherein the multiple transmission configuration indicator states are to be applied across the repetitions in accordance with the configuration based at least in part on cyclic mapping being enabled or sequential mapping being enabled for the repetitions.
Aspect 84: The method of any of aspects 77 through 83, wherein the signal is associated with an uplink shared channel.
Aspect 85: A method for wireless communication at a UE, comprising: receiving a first downlink control information message indicating a selected unified transmission configuration indicator codepoint from a set of one or more activated transmission configuration indicator codepoints that are each associated with one or more transmission configuration indicator states; receiving a second downlink control information message indicating a first transmission configuration indicator state to use for a signal, the signal being a periodic or semi-persistent signal; receiving a third downlink control information message indicating multiple transmission configuration indicator states of the selected unified transmission configuration indicator codepoint; and determining to apply the first transmission configuration indicator state or the multiple transmission configuration indicator states to the signal in accordance with a configuration.
Aspect 86: The method of aspect 85, wherein determining to apply the first transmission configuration indicator state or the multiple transmission configuration indicator states further comprises: determining to apply one of the multiple transmission configuration indicator states to the signal in accordance with the configuration.
Aspect 87: The method of aspect 86, further comprising: selecting a second transmission configuration indicator state from the multiple transmission configuration indicator states based at least in part on the second transmission configuration indicator state being associated with a same network entity as the first transmission configuration indicator state.
Aspect 88: The method of aspect 87, wherein selecting the second transmission configuration indicator state is based at least in part on the signal being a semi-persistent scheduling signal, a configured grant, or an uplink shared channel signal.
Aspect 89: The method of any of aspects 87 through 88, wherein selecting the second transmission configuration indicator state is based at least in part on a control resource set, a sounding reference signal resource set corresponding to a scheduling request indicator, or an uplink control channel resource associated with the signal.
Aspect 90: The method of any of aspects 85 through 89, wherein determining to apply the first transmission configuration indicator state or the multiple transmission configuration indicator states based at least in part on a rule.
Aspect 91: The method of any of aspects 85 through 90, wherein determining to apply the first transmission configuration indicator state or the multiple transmission configuration indicator states further comprises: configuring the signal to be associated with the multiple transmission configuration indicator states rather than the first transmission configuration indicator state based at least in part on the third downlink control information message indicating the multiple transmission configuration indicator states.
Aspect 92: The method of any of aspects 85 through 91, wherein determining to apply the first transmission configuration indicator state or the multiple transmission configuration indicator states further comprises: determining that the signal is deactivated based at least in part on receiving the third downlink control information message indicating the multiple transmission configuration indicator states.
Aspect 93: An apparatus for wireless communications at a UE, comprising a processor; memory coupled with the processor; and instructions stored in the memory and executable by the processor to cause the apparatus to perform a method of any of aspects 1 through 24.
Aspect 94: An apparatus for wireless communications at a UE, comprising at least one means for performing a method of any of aspects 1 through 24.
Aspect 95: A non-transitory computer-readable medium storing code for wireless communications at a UE, the code comprising instructions executable by a processor to perform a method of any of aspects 1 through 24.
Aspect 96: An apparatus for wireless communications at a network entity, comprising a processor; memory coupled with the processor; and instructions stored in the memory and executable by the processor to cause the apparatus to perform a method of any of aspects 25 through 48.
Aspect 97: An apparatus for wireless communications at a network entity, comprising at least one means for performing a method of any of aspects 25 through 48.
Aspect 98: A non-transitory computer-readable medium storing code for wireless communications at a network entity, the code comprising instructions executable by a processor to perform a method of any of aspects 25 through 48.
Aspect 99: An apparatus for wireless communications at a UE, comprising a processor; memory coupled with the processor; and instructions stored in the memory and executable by the processor to cause the apparatus to perform a method of any of aspects 49 through 59.
Aspect 100: An apparatus for wireless communications at a UE, comprising at least one means for performing a method of any of aspects 49 through 59.
Aspect 101: A non-transitory computer-readable medium storing code for wireless communications at a UE, the code comprising instructions executable by a processor to perform a method of any of aspects 49 through 59.
Aspect 102: An apparatus for wireless communications at a network entity, comprising a processor; memory coupled with the processor; and instructions stored in the memory and executable by the processor to cause the apparatus to perform a method of any of aspects 60 through 68.
Aspect 103: An apparatus for wireless communications at a network entity, comprising at least one means for performing a method of any of aspects 60 through 68.
Aspect 104: A non-transitory computer-readable medium storing code for wireless communications at a network entity, the code comprising instructions executable by a processor to perform a method of any of aspects 60 through 68.
Aspect 105: An apparatus for wireless communications at a UE, comprising a processor; memory coupled with the processor; and instructions stored in the memory and executable by the processor to cause the apparatus to perform a method of any of aspects 69 through 76.
Aspect 106: An apparatus for wireless communications at a UE, comprising at least one means for performing a method of any of aspects 69 through 76.
Aspect 107: A non-transitory computer-readable medium storing code for wireless communications at a UE, the code comprising instructions executable by a processor to perform a method of any of aspects 69 through 76.
Aspect 108: An apparatus for wireless communications at a network entity, comprising a processor; memory coupled with the processor; and instructions stored in the memory and executable by the processor to cause the apparatus to perform a method of any of aspects 77 through 84.
Aspect 109: An apparatus for wireless communications at a network entity, comprising at least one means for performing a method of any of aspects 77 through 84.
Aspect 110: A non-transitory computer-readable medium storing code for wireless communications at a network entity, the code comprising instructions executable by a processor to perform a method of any of aspects 77 through 84.
Aspect 111: An apparatus for wireless communication at a UE, comprising a processor; memory coupled with the processor; and instructions stored in the memory and executable by the processor to cause the apparatus to perform a method of any of aspects 85 through 92.
Aspect 112: An apparatus for wireless communication at a UE, comprising at least one means for performing a method of any of aspects 85 through 92.
Aspect 113: A non-transitory computer-readable medium storing code for wireless communication at a UE, the code comprising instructions executable by a processor to perform a method of any of aspects 85 through 92.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a control message indicating a configuration for a signal, wherein the configuration indicates whether the signal is associated with one or more unified transmission configuration indicator states of a selected unified transmission configuration indicator codepoint;
receiving a first downlink control information message indicating a set of one or more activated transmission configuration indicator codepoints that are each associated with one or more transmission configuration indicator states;
receiving a second downlink control information message indicating the selected unified transmission configuration indicator codepoint from the set of one or more activated transmission configuration indicator codepoints; and
applying a transmission configuration indicator state for communication of the signal in accordance with the configuration.

2. The method of claim 1, wherein receiving the control message further comprises:
identifying that an association between the signal and the one or more unified transmission configuration indicator states is per a control resource set or per a search space of the control resource set.

3. The method of claim 2, further comprising:
identifying that the control resource set or the search space is common to multiple UEs, wherein the configuration includes an indication that indicates one of a first option, a second option, a third option, or a fourth option based at least in part on the control resource set or the search space being common to multiple UEs, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, the third option is that the signal is to be associated with a second one of the one or more unified transmission configuration indicator states used for communications with a second transmission and reception point of the network entity, and the fourth option is that the signal is to be associated with both the first one and the second one of the one or more unified transmission configuration indicator states used for communications with both the first transmission and reception point and the second transmission and reception point of the network entity.

4. The method of claim 2, further comprising:
identifying that the control resource set or the search space is specific to the UE, wherein the configuration includes an indication that indicates one of a first option, a second option, or a third option based at least in part on the control resource set or the search space being specific to the UE, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission and reception point of the network entity.

5. The method of claim 2, further comprising:
identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein the configuration is based at least in part on a single frequency network based control resource set being enabled to comprise multiple transmission configuration indicators.

6. The method of claim 1, wherein receiving the control message further comprises:
identifying that an association between the signal and the one or more unified transmission configuration indicator states is per a physical uplink control channel resource, a physical uplink control channel resource set, a physical uplink control channel resource group, or a combination thereof, and that the signal is associated with a physical uplink control channel.

7. The method of claim 6, further comprising:
identifying that the configuration includes an indication that indicates one of a first option, a second option, or a third option based at least in part on the signal being associated with the physical uplink control channel, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission and reception point of the network entity.

8. The method of claim 6, further comprising:
identifying that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein individual repetitions of the physical uplink control channel are mapped to either the first transmission and reception point or the second transmission and reception point based at least in part on a configured pattern.

9. The method of claim 1, wherein receiving the control message further comprises:
identifying that an association between the signal and the one or more unified transmission configuration indicator states is per a reference signal resource, a reference signal resource set, or a combination thereof, and that the signal is a reference signal.

10. The method of claim 1, wherein receiving the control message further comprises:
identifying that an association between the signal and the one or more unified transmission configuration indicator states is per configured grant, wherein the configured grant is a type 1 configured grant or a type 2 configured grant.

11. A method for wireless communications at a user equipment (UE), comprising:
receiving a first downlink control information message indicating a selected unified transmission configuration indicator codepoint from a set of one or more activated transmission configuration indicator codepoints that are each associated with one or more transmission configuration indicator states;
receiving a second downlink control information message scheduling a signal and indicating a transmission configuration indicator state of the selected unified transmission configuration indicator codepoint is associated with the signal; and
applying the transmission configuration indicator state for communication of the signal in accordance with the second downlink control information message.

12. The method of claim 11, wherein receiving the second downlink control information message further comprises:
receiving the second downlink control information message comprising a transmission configuration indication codepoint from a set of transmission configuration indication codepoints, the transmission configuration indication codepoint indicative of the transmission configuration indicator state associated with a first network entity.

13. The method of claim 11, wherein receiving the second downlink control information message further comprises:
receiving the second downlink control information message comprising an indication of whether one or multiple transmission configuration indication states are to be applied to the signal; and
identifying the transmission configuration indicator state in accordance with a rule based at least in part on the indication.

14. The method of claim 11, wherein the second downlink control information message implicitly indicates the transmission configuration indicator state, the UE identifies the transmission configuration indicator state based at least in part on the second downlink control information message refraining to include a transmission configuration indicator state field.

15. The method of claim 11, wherein receiving the second downlink control information message further comprises:
receiving the second downlink control information message comprising a sounding reference signal resource set indicator field indicative of at least one sounding reference signal resource set, the transmission configuration indicator state indicated by the at least one sounding reference signal resource set.

16. An apparatus for wireless communications at a user equipment (UE), comprising:
a processor;
memory in electronic communication with the processor; and
instructions stored in the memory, wherein the instructions are executable by the processor to:
receive a control message indicating a configuration for a signal, wherein the configuration indicates whether the signal is associated with one or more unified transmission configuration indicator states of a selected unified transmission configuration indicator codepoint;
receive a first downlink control information message indicating a set of one or more activated transmission configuration indicator codepoints that are each associated with one or more transmission configuration indicator states;
receive a second downlink control information message indicating the selected unified transmission configuration indicator codepoint from the set of one or more activated transmission configuration indicator codepoints; and
apply a transmission configuration indicator state for communication of the signal in accordance with the configuration.

17. The apparatus of claim 16, wherein the instructions executable by the processor to receive the control message comprise instructions executable by the processor to:
identify that an association between the signal and the one or more unified transmission configuration indicator states is per a control resource set or per a search space of the control resource set.

18. The apparatus of claim 17, wherein the instructions are further executable by the processor to cause the apparatus to:
identify that the control resource set or the search space is common to multiple UEs, wherein the configuration includes an indication that indicates one of a first option, a second option, a third option, or a fourth option based at least in part on the control resource set or the search space being common to multiple UEs, wherein the first option is that the signal is to be associated with none of the one or more unified transmission configuration indicator states, the second option is that the signal is to be associated with a first one of the one or more unified transmission configuration indicator states used for communications with a first transmission and reception point of a network entity, the third option is that the signal is to be associated with a second one of the one or more unified transmission configuration indicator states used for communications with a second transmission and reception point of the network entity, and the fourth option is that the signal is to be associated with both the first one and the second one of the one or more unified transmission configuration indicator states used for communications with both the first transmission and reception point and the second transmission and reception point of the network entity.

19. The apparatus of claim 17, wherein the instructions are further executable by the processor to cause the apparatus to:
identify that the control resource set or the search space is specific to the UE, wherein the configuration includes an indication that indicates one of a first option, a second option, or a third option based at least in part on the control resource set or the search space being specific to the UE, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission and reception point of the network entity.

20. The apparatus of claim 17, wherein the instructions are further executable by the processor to cause the apparatus to:
identify that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein the configuration is based at least in part on a single frequency network based control resource set being enabled to comprise multiple transmission configuration indicators.

21. The apparatus of claim 16, wherein the instructions executable by the processor to receive the control message comprise instructions executable by the processor to:
identify that an association between the signal and the one or more unified transmission configuration indicator states is per a physical uplink control channel resource, a physical uplink control channel resource set, a physical uplink control channel resource group, or a combination thereof, and that the signal is associated with a physical uplink control channel.

22. The apparatus of claim 21, wherein the instructions are further executable by the processor to cause the apparatus to:
identify that the configuration includes an indication that indicates one of a first option, a second option, or a third option based at least in part on the signal being associated with the physical uplink control channel, wherein the first option is that the signal is to be associated with a first one of the one or more unified transmission configuration indicator states used for communications with a first transmission and reception point of a network entity, the second option is that the signal is to be associated with a second one of the one or more unified transmission configuration indicator states used for communications with a second transmission and reception point of the network entity, and the third option is that the signal is to be associated with both the first one and the second one of the one or more unified transmission configuration indicator states used for communications with both the first transmission and reception point and the second transmission and reception point of the network entity.

23. The apparatus of claim 21, wherein the instructions are further executable by the processor to cause the apparatus to:
identify that the configuration indicates that the signal is to be associated with both a first one of the one or more unified transmission configuration indicator states used for communications with a first transmission and reception point of a network entity and a second one of the one or more unified transmission configuration indicator states used for communications with a second transmission and reception point of the network entity, wherein individual repetitions of the physical uplink control channel are mapped to either the first transmission and reception point or the second transmission and reception point based at least in part on a configured pattern.

24. The apparatus of claim 16, wherein the instructions executable by the processor to receive the control message comprise instructions executable by the processor to:
identify that an association between the signal and the one or more unified transmission configuration indicator states is per a reference signal resource, a reference signal resource set, or a combination thereof, and that the signal is a reference signal.

25. The apparatus of claim 16, wherein the instructions executable by the processor to receive the control message comprise instructions executable by the processor to:
identify that an association between the signal and the one or more unified transmission configuration indicator states is per configured grant, wherein the configured grant is a type 1 configured grant or a type 2 configured grant.

26. An apparatus for wireless communications at a user equipment (UE), comprising:
a processor;
memory in electronic communication with the processor; and
instructions stored in the memory, wherein the instructions are executable by the processor to:
receive a first downlink control information message indicating a selected unified transmission configuration indicator codepoint from a set of one or more activated transmission configuration indicator codepoints that are each associated with one or more transmission configuration indicator states;
receive a second downlink control information message scheduling a signal and indicating a transmission configuration indicator state of the selected unified transmission configuration indicator codepoint is associated with the signal; and
apply the transmission configuration indicator state for communication of the signal in accordance with the second downlink control information message.

27. The apparatus of claim 26, wherein the instructions executable by the processor to receive the second downlink control information message comprise instructions executable by the processor to:
receive the second downlink control information message comprising a transmission configuration indication codepoint from a set of transmission configuration indication codepoints, the transmission configuration indication codepoint indicative of the transmission configuration indicator state associated with a first network entity.

28. The apparatus of claim 26, wherein the instructions executable by the processor to receive the second downlink control information message comprise instructions executable by the processor to:
receive the second downlink control information message comprising an indication of whether one or multiple transmission configuration indication states are to be applied to the signal; and
identify the transmission configuration indicator state in accordance with a rule based at least in part on the indication.

29. The apparatus of claim 26, wherein the second downlink control information message implicitly indicates the transmission configuration indicator state, the UE identifies the transmission configuration indicator state based at least in part on the second downlink control information message refraining to include a transmission configuration indicator state field.

30. The apparatus of claim 26, wherein the instructions executable by the processor to receive the second downlink control information message comprise instructions executable by the processor to:
receive the second downlink control information message comprising a sounding reference signal resource set indicator field indicative of at least one sounding reference signal resource set, the transmission configuration indicator state indicated by the at least one sounding reference signal resource set.
